(19) United States
(12) Patent Application Publication
(10) Pub. No.: US 2025/0040547 A1
(43) Pub. Date: Feb. 6, 2025

(54) COMPOSITION CONTAINING A MACROLIDE INSECTICIDAL COMPOUND AND POLYCATIONIC RHEOLOGY MODIFIER

(71) Applicant: ADAMA MAKHTESHIM LTD., Beer Sheva (IL)

(72) Inventors: Yogev DAHAN, Tene Omarim (IL); Jacob FRIEDMAN, Beer Sheva (IL)

(73) Assignee: ADAMA MAKHTESHIM LTD., Beer Sheva (IL)

(21) Appl. No.: 18/717,827

(22) PCT Filed: Dec. 6, 2022
(86) PCT No.: PCT/IL2022/051294

§ 371 Date: Jun. 7, 2024

Related U.S. Application Data
(60) Provisional application No. 63/286,590, filed on Dec. 7, 2021.

(51) Int. Cl. A01N 43/22; A01N 25/04; A01N 43/56; A01P 7/04

(52) U.S. Cl. CPC A01N 43/22; A01N 25/04; A01N 43/56; A01P 7/04

(57) ABSTRACT

An aqueous pesticidal suspension composition comprising a macrolide insecticidal compound or salt thereof; at least one polycationic rheology modifier; optionally additives and optionally additional active ingredient.

### TECHNICAL FIELD OF THE INVENTION

The present invention relates to novel stable compositions and methods comprising a macrolide insecticidal compound and at least one polycationic rheology modifier for controlling plant diseases.

### BACKGROUND OF THE INVENTION

Emamectin benzoate, a macrocyclic lactone insecticide, is a semisynthetic derivative of the avermectins (Crop Protection, Volume 30, Issue 10, October 2011, Pages 1356-1362; Cheng X, Liu X, Wang H, Ji X, Wang K, Wei M, et al. (2015) Effect of Emamectin Benzoate on Root-Knot Nematodes and Tomato Yield). It shows a broad spectrum, high efficiency, and low toxicity, which is further improved with thermal stability than avermectin. Because its water solubility is extremely low (24 mg/L-1), the dominant formulation of emamectin benzoate is EC with low pesticide content and large amount of organic solvent (C. H. Zheng, “Development of a 1.0% emamectin benzoate microemulsion,” Anhui Chemical Industry, vol. 38, no. 3, pp. 49-51, 2012).

Suspension concentrate (SC) formulations have grown in popularity since they are water based and therefore provide good safety and due to benefits, such as absence of dust, ease of use and effectiveness compared to emulsifiable concentrate (EC) and wettable powder (WP) formulations. In order to formulate a stable SC, it is necessary to add thickeners which prevent the precipitation and separation (particularly under storage conditions) of the active ingredient which must remain insoluble under all temperature conditions. Developing SC formulations is about balancing between the need to keep the viscosity high enough that particles will not sink rapidly, but low enough that the material pours out or pumps easily.

### SUMMARY

The invention is directed to an aqueous pesticidal suspension composition comprising a macrolide insecticidal compound or salt thereof; at least one polycationic rheology modifier; optionally additives and optionally additional active ingredient.

This invention also relates to a method for stabilizing an aqueous pesticidal suspension composition comprising a macrolide insecticidal compound or salt thereof; optionally additives and optionally additional active ingredient by the addition of at least one polycationic type rheology modifier.

The invention further relates to a method of controlling or preventing infestation of plants with plant pests by applying an aqueous pesticidal suspension composition to the plants, plant parts or locus thereof, comprising a) a macrolide insecticidal compound or salt thereof; b) at least one polycationic type rheology modifier; c) optionally additives and d) optionally additional active ingredient

### DETAILED DESCRIPTION OF THE PREFERRED EMBODIMENTS

### Definitions

Prior to setting forth the present subject matter in detail, it may be helpful to provide definitions of certain terms to be used herein. Unless defined otherwise, all technical and scientific terms used herein have the same meaning as is commonly understood by one of skill in the art to which this subject matter pertains. The following definitions are provided for clarity.

The term “a” or “an” as used herein includes the singular and the plural, unless specifically stated otherwise. Therefore, the terms “a,” “an,” or “at least one” can be used interchangeably in this application.

As used herein, the verb “comprise” as is used in this description and in the claims and its conjugations are used in its non-limiting sense to mean that items following the word are included, but items not specifically mentioned are not excluded.

As used herein, the term “about” when used in connection with a numerical value includes ±10% from the indicated value. In addition, all ranges directed to the same component or property herein are inclusive of the endpoints, are independently combinable, and include all intermediate points and ranges. It is understood that where a parameter range is provided, all integers within that range, and tenths thereof, are also provided by the invention.

As used herein, the term “effective amount” refers to an amount of the active component that is commercially recommended for use to control and/or prevent pest. The commercially recommended amount for each active component, often specified as application rates of the commercial formulation, may be found on the label accompanying the commercial formulation. The commercially recommended application rates of the commercial formulation may vary depending on factors such as the plant species and the pest to be controlled.

As used herein, the term “pest” includes, but is not limited to, unwanted phytopathogenic harmful fungi, unwanted insect, unwanted nematode, and weed.

As used herein, the term “pesticide” broadly refers to an agent that can be used to prevent, control and/or kill a pest. The term is understood to include but is not limited to fungicides, insecticides, nematicides, herbicides, acaricides, parasiticides or other control agents. For chemical classes and applications, as well as specific compounds of each class, see “The Pesticide Manual Thirteenth Edition” (British Crop Protection Council, Hampshire, UK, 2003), as well as “The e-Pesticide Manual, Version 3” (British Crop Protection Council, Hampshire, UK, 2003-04), the contents of each of which are incorporated herein by reference in their entirety.

As used herein, the term “locus” includes not only areas where the pest may already be developed, but also areas where pests have yet to emerge, and also to areas under cultivation. Locus includes the plant or crop and propagation material of the plant or crop. Locus also includes the area surrounding the plant or crop and the growing media of the plant or crop, such as soil and crop field.

As used herein the term “plant” or “crop” includes reference to whole plants, plant organs (e.g. leaves, stems, twigs, roots, trunks, limbs, shoots, fruits etc.), plant cells, or plant seeds. This term also encompasses plant crops such as fruits. spores, corms, bulbs, rhizomes, sprouts basal shoots, stolons, and buds and other parts of plants, including seedlings and young plants, which are to be transplanted after germination or after emergence from soil.

According to the invention, all plants and parts of plants can be treated. Plants are understood here to mean all plants and plant populations, such as desired and undesired wild plants or crop plants (including naturally occurring crop plants). Crop plants can be plants which can be obtained by conventional breeding and optimization methods or by biotechnological and genetic engineering methods or combinations of these methods, including the transgenic plants and including the plant cultivars which can or cannot be protected by plant breeders' rights.

As used herein the term “ha” refers to hectare.

As used herein the term salts of compounds in the compositions and methods of the present invention include acid-addition salts with inorganic or organic acids such as hydrobromic, hydrochloric, nitric, phosphoric, sulfuric, acetic, butyric, fumaric, lactic, maleic, malonic, oxalic, propionic, salicylic, tartaric, 4-toluenesulfonic, valeric, benzoic, salicyclic, gallic, benzenesulfonic and citric acids. Salts of the compounds of the invention also include those formed with organic bases (e.g., pyridine or triethylamine) or inorganic bases (e.g., hydrides, hydroxides, or carbonates of sodium, potassium, lithium, calcium, magnesium or barium) when the compound contains an acidic group such as a carboxylic acid or phenol.

It has surprisingly been found that cationic polycarboxylate type thickeners improve the stability of water based pesticidal suspension comprising a macrolide insecticidal compound or salt thereof.

The present invention provides an aqueous pesticidal suspension composition comprising a) a macrolide insecticidal compound or salt thereof; b) at least one polycationic rheology modifier; c) optionally additives and d) optionally additional active ingredient.

In some embodiments, the macrolide insecticidal compound is selected from emamectin, abamectin, spinosad, spinetoram or salt thereof.

In some embodiments, the macrolide insecticidal compound is emamectin or salt thereof.

In some embodiments, the macrolide insecticidal compound is emamectin benzoate.

In some embodiments, the amount of the macrolide insecticidal compound is of about 1% to of about 20% by weight, based on the total weight of the composition.

In some embodiments, the amount of the macrolide insecticidal compound is of about 3% to of about 10% by weight, based on the total weight of the composition.

In some embodiments, the amount of the macrolide insecticidal compound is of about 5% to of about 8% by weight, based on the total weight of the composition.

In some embodiments, the amount of the macrolide insecticidal compound is of about 7.5% by weight, based on the total weight of the composition.

In some embodiments, the at least one polycationic type rheology modifier comprises monomers with ammonium, sulfonium or phosphonium moiety.

In some embodiments, the at least one polycationic type rheology modifier comprises monomers with ammonium moiety.

In some embodiments, the at least one polycationic type rheology modifier comprises monomers with ammonium moiety is selected from polyquaterniums or polyquaternium esters polymers and combinations thereof.

In some embodiments, the at least one polycationic type rheology modifier comprises monomers with ammonium moiety is poly(2-methacryloxyethyltrimethylammonium chloride).

Non limiting examples of polyquaterniums or polyquaternium esters polymers are ChromoHance™ 113 polymer, Conditioneze™ 22, Conditioneze 37, Conditioneze™ NT-20, Gafquat™ 440, Gafquat™ HS-100 and Styleze™ W-10.

In some embodiments, the amount of the at least one polycationic type rheology modifier is of about 1% to of about 3% by weight, based on the total weight of the composition.

In some embodiments, the amount of the at least one polycationic type rheology modifier comprises monomers with ammonium moiety selected from polyquaterniums or polyquaternium esters polymers and combinations thereof is of about 1% to of about 3% by weight, based on the total weight of the composition.

In some embodiments, the amount of poly(2-methacryloxyethyltrimethylammonium chloride) is of about 1% to of about 3% by weight, based on the total weight of the composition.

In some embodiments, the amount of the at least one polycationic type rheology modifier is of about 1% to of about 2% by weight, based on the total weight of the composition.

In some embodiments, the amount of the at least one polycationic type rheology modifier comprises monomers with ammonium moiety selected from polyquaterniums or polyquaternium esters polymers and combinations thereof is of about 1% to of about 2% by weight, based on the total weight of the composition.

In some embodiments, the amount of poly(2-methacryloxyethyltrimethylammonium chloride) is of about 1% to of about 2% by weight, based on the total weight of the composition.

In some embodiments, the amount of the at least one polycationic type rheology modifier is of about 1.1% to of about 1.7% by weight, based on the total weight of the composition.

In some embodiments, the amount of the at least one polycationic type rheology modifier comprises monomers with ammonium moiety selected from polyquaterniums or polyquaternium esters polymers and combinations thereof is of about 1.1% to of about 1.7% by weight, based on the total weight of the composition.

In some embodiments, the amount of poly(2-methacryloxyethyltrimethylammonium chloride) is of about 1.1% to of about 1.7% by weight, based on the total weight of the composition.

In some embodiments, the amount of the at least one polycationic type rheology modifier is of about 1.2% by weight, based on the total weight of the composition.

In some embodiments, the amount of the at least one polycationic type rheology modifier comprises monomers with ammonium moiety selected from polyquaterniums or polyquaternium esters polymers and combinations thereof is of about 1.2% by weight, based on the total weight of the composition.

In some embodiments, the amount of poly(2-methacryloxyethyltrimethylammonium chloride) is of about 1.2% by weight, based on the total weight of the composition.

In some embodiments, the additives are selected from the group comprising of dispersants, wetting agents, antifreezing agents, antifoaming agents, surfactants, pH modifiers and stabilizers.

In some embodiments, the additional active ingredient is a diamide insecticide.

In some embodiments, the diamide insecticide is selected from chlorantraniliprole, cyantraniliprole, cyclaniliprole, fluchlordiniliprole, tetrachlorantraniliprole and tetraniliprole.

In some embodiments, the diamide insecticide is selected from chlorantraniliprole or cyantraniliprole.

In some embodiments, the diamide insecticide is chlorantraniliprole.

In some embodiments, the diamide insecticide is cyantraniliprole.

In some embodiments, the additional active ingredient is of about 1% to of about 60% by weight, based on the total weight of the composition.

In some embodiments, the additional active ingredient is of about 1% to of about 40% by weight, based on the total weight of the composition.

In some embodiments, the additional active ingredient is of about 1% to of about 30% by weight, based on the total weight of the composition.

In some embodiments, the additional active ingredient is of about 1% to of about 20% by weight, based on the total weight of the composition.

In some embodiments, the additional active ingredient is of about 15% by weight, based on the total weight of the composition.

In some embodiments, chlorantraniliprole is of about 1% to of about 30% by weight, based on the total weight of the composition.

In some embodiments, cyantraniliprole is of about 1% to of about 30% by weight, based on the total weight of the composition.

In some embodiments, the aqueous pesticidal suspension composition is used for controlling or preventing infestation of plants with plant pest.

The compositions and methods of this invention display activity against plant pests, non-limiting examples are Lepidoptera (e.g., Alabama argillacea Húbner (cotton leaf worm), Archips argyrospïla Walker (fruit tree leaf roller), A. rosana Linnaeus (European leaf roller) and other Archips species, Chilo suppressalis Walker (rice stem borer), Cnaphalocrosis medinalis Guenee (rice leaf roller), Crambus caliginosellus Clemens (corn root webworm), Crambus teterrellus Zincken (bluegrass webworm), Cydia pomonella Linnaeus (codling moth), Earias insulana Boisduval (spiny bollworm), Earias vittella Fabricius (spotted bollworm), Helicoverpa armigera Húbner (American bollworm), Helicoverpa zea Boddie (corn earworm), Heliothis virescens Fabricius (tobacco budworm), Herpetogramma licarsisalis Walker (sod webworm), Lobesia botrana Denis & Schiffermúller (grape berry moth), Pectinophora gossypiella Saunders (pink bollworm), Phyllocnistis citrella Stainton (citrus leafininer), Pieris brassicae Linnaeus (large white butterfly), Pieris rapae Linnaeus (small white butterfly), Plutella xylostella Linnaeus (diamondback moth), Spodoptera exigua Húbner (beet armyworm), Spodoptera litura Fabricius (tobacco cutworm, cluster caterpillar), Spodoptera frugiperda J. E. Smith (fall armyworm), Trichoplusia ni Húbner (cabbage looper) and Tuta absoluta Meyrick (tomato leafininer)). Compounds of the invention also have commercially significant activity on members from the order Homoptera including: Acyrthisiphon pisum Harris (pea aphid), Aphis craccivora Koch (cowpea aphid), Aphis fabae Scopoli (black bean aphid), Aphis gossypii Glover (cotton aphid, melon aphid), Aphis pomi De Geer (apple aphid), Aphis spiraecola Patch (spirea aphid), Aulacorthum solani Kaltenbach (foxglove aphid), Chaetosiphon fragaefolii Cockerell (strawberry aphid), Diuraphis noxia Kurdjumov/Mordvilko (Russian wheat aphid), Dysaphis plantaginea Paaserini (rosy apple aphid), Eriosoma lanigerum Hausmann (woolly apple aphid), Hyalopterus pruni Geoffrey (mealy plum aphid), Lipaphis erysimi Kaltenbach (turnip aphid), Metopolophium dirrhodum Walker (cereal aphid), Macrosipum euphorbiae Thomas (potato aphid), Myzus persicae Sulzer (peach-potato aphid, green peach aphid), Nasonovia ribisnigri Mosley (lettuce aphid), Pemphigus spp. (root aphids and gall aphids), Rhopalosiphum maidis Fitch (corn leaf aphid), Rhopalosiphum padi Linnaeus (bird cherry—oat aphid), Schizaphis graminum Rondani (greenbug), Sitobion avenae Fabricius (English grain aphid), Therioaphis maculata Buckton (spotted alfalfa aphid), Toxoptera aurantii Boyer de Fonscolombe (black citrus aphid), and Toxoptera citricida Kirkaldy (brown citrus aphid); Adelges spp. (adelgids); Phylloxera devastatrix Pergande (pecan phylloxera); Bemisia tabaci Gennadius (tobacco whitefly, sweetpotato whitefly), Bemisia argentifolii Bellows & Perring (silverleaf whitefly), Dialeurodes citri Ashmead (citrus whitefly) and Trialeurodes vaporariorum Westwood (greenhouse whitefly); Empoasca fabae Harris (potato leafhopper), Laodelphax striatellus Fallen (smaller brown planthopper), Macrolestes quadrilineatus Forbes (aster leafhopper), Nephotettix cinticeps Uhler (green leafhopper), Nephotettix nigropictus Stal (rice leafhopper), Nilaparvata lugens Stal (brown planthopper), Peregrinus maidis Ashmead (corn planthopper), Sogatella furcifera Horvath (white-backed planthopper), Sogatodes orizicola Muir (rice delphacid), Typhlocyba pomaria McAtee white apple leafhopper, Erythroneoura spp. (grape leafhoppers); Magicidada septendecim Linnaeus (periodical cicada); Icerya purchasi Maskell (cottony cushion scale), Quadraspidiotus perniciosus Comstock (San Jose scale); Planococcus citri Risso (citrus mealybug); Pseudococcus spp. (other mealybug complex); Cacopsylla pyricola Foerster (pear psylla), Trioza diospyri Ashmead (persimmon psylla). These compounds also have activity on members from the order Hemiptera including: Acrosternum Mare Say (green stink bug), Anasa tristis De Geer (squash bug), Blissus leucopterus leucopterus Say (chinch bug), Corythuca gossypii Fabricius (cotton lace bug), Cyrtopeltis modesta Distant (tomato bug), Dysdercus suturellus Herrich-Schaffer (cotton stainer), Euchistus servus Say (brown stink bug), Euchistus variolarius Palisot de Beauvois (one-spotted stink bug), Graptosthetus spp. (complex of seed bugs), Leptoglossus corculus Say (leaf-footed pine seed bug), Lygus lineolaris Palisot de Beauvois (tarnished plant bug), Nezara viridula Linnaeus (southern green stink bug), Oebalus pugnax Fabricius (rice stink bug), Oncopeltus fasciatus Dallas (large milkweed bug), Pseudatomoscelis seriatus Reuter (cotton fleahopper). Other insect orders controlled by compounds of the invention include Thysanoptera (e.g., Frankliniella occidentalis Pergande (western flower thrip), Scirthothrips citri Moulton (citrus thrip), Sericothrips variabilis Beach (soybean thrip), and Thrips tabaci Lindeman (onion thrip); and the order Coleoptera (e.g., Leptinotarsa decemlineata Say (Colorado potato beetle), Epilachna varivestis Mulsant (Mexican bean beetle) and wireworms of the genera Agriotes, Athous or Limonius).

Non limiting examples of crops or plants which the compositions and methods of the invention can be used on are cereal crops (e.g., wheat, oats, barley, rye, rice, maize), soybeans, vegetable crops (e.g., lettuce, cabbage, tomatoes, beans), potatoes, sweet potatoes, grapes, cotton, and tree fruits (e.g., pome fruits, stone fruits and citrus fruits).

All compositions can contain additives to reduce foam, sedimentation, caking, microbiological growth and the like, or thickeners to increase viscosity. Surfactants include, for example, polyethoxylated alcohols, polyethoxylated alkylphenols, polyethoxylated sorbitan fatty acid esters, dialkyl sulfosuccinates, alkyl sulfates, alkylbenzene sulfonates, organosilicones, N,N-dialkyltaurates, lignin sulfonates, naphthalene sulfonate formaldehyde condensates, polycarboxylates, glycerol esters, poly-oxyethylene/polyoxypropylene block copolymers, and alkylpolyglycosides where the number of glucose units, referred to as degree of polymerization (D.P.), can range from 1 to 3 and the alkyl units can range from Cg-C\hat{ } (see Pure and Applied Chemistry 72, 1255-1264). Solid diluents include, for example silica, talc, diatomaceous earth, urea, calcium carbonate, sodium carbonate and bicarbonate, and sodium sulfate. Liquid diluents include, for example, water, N,N-dimethylformamide, dimethyl sulfoxide, N-alkylpyrrolidone, ethylene glycol, polypropylene glycol, paraffins, alkylbenzenes, alkylnaphthalenes, glycerine, triacetine, oils of olive, castor, linseed, tung, sesame, corn, peanut, cotton-seed, soybean, rape-seed and coconut, fatty acid esters, ketones such as cyclohexanone, 2-heptanone, isophorone and 4-hydroxy-4-methyl-2-pentanone, acetates and alcohols such as methanol, cyclohexanol, decanol and tetrahydrofurfuryl alcohol.

Useful formulations of this invention can also contain materials known as formulation aids including antifoams, film formers and dyes and are well known to those skilled in the art.

Antifoams can include water dispersible liquids comprising polyorganosiloxanes such as Silcolapse® 432. The film formers can include polyvinyl acetates, polyvinyl acetate copolymers, polyvinylpyrrolidone-vinyl acetate copolymer, polyvinyl alcohols, polyvinyl 19 alcohol copolymers and waxes. Dyes can include water dispersible liquid colorant compositions such as Pro-Ized® Colorant Red. One skilled in the art will appreciate that this is a non-exhaustive list of formulation aids. Suitable examples of formulation aids include those listed herein and those listed in McCutcheon's 2001, Volume 2: Functional Materials, published by MC Publishing Company and PCT Publication WO 03/024222.

Although the aqueous pesticidal suspension composition of the present invention can be applied directly to the pest or its environment, the aqueous pesticidal suspension composition is ordinarily first diluted with water to form a diluted composition, and then the pest or its environment is contacted with an effective amount of the diluted composition to control the pest. This diluted composition can be applied to a pest or its environment by a variety of means including spraying. The present aqueous pesticidal suspension composition after dilution with water, spraying and then drying have been discovered to provide effective control of pests (e.g., killing the pests, interfering with their growth development of reproduction, interfering with their nervous and muscle system, and/or inhibiting their feeding).

In some embodiments, the aqueous pesticidal suspension composition comprising a) emamectin or salt thereof; b) at least one polycationic rheology modifier; c) optionally additives and d) optionally additional active ingredient.

In some embodiments, the aqueous pesticidal suspension composition comprising a) emamectin or salt thereof; b) at least one polycationic type rheology modifier comprises monomers with ammonium, sulfonium or phosphonium moiety; c) optionally additives and d) optionally additional active ingredient.

In some embodiments, the aqueous pesticidal suspension composition comprising a) emamectin or salt thereof; b) at least one polycationic type rheology modifier comprises monomers with ammonium moiety; c) optionally additives and d) optionally additional active ingredient.

In some embodiments, the aqueous pesticidal suspension composition comprising a) emamectin or salt thereof; b) at least one polycationic type rheology modifier comprises monomers with ammonium moiety is selected from polyquaterniums or polyquaternium esters polymers and combinations thereof; c) optionally additives and d) optionally additional active ingredient.

In some embodiments, the aqueous pesticidal suspension composition comprising a) emamectin or salt thereof; b) at least one polycationic type rheology modifier comprises monomers with ammonium moiety is poly(2-methacryloxyethyltrimethylammonium chloride); c) optionally additives and d) optionally additional active ingredient.

In some embodiments, the aqueous pesticidal suspension composition comprising a) emamectin or salt thereof; b) at least one polycationic rheology modifier at about 1% to of about 3% by weight, based on the total weight of the composition; c) optionally additives and d) optionally additional active ingredient.

In some embodiments, the aqueous pesticidal suspension composition comprising a) emamectin or salt thereof; b) at least one polycationic rheology modifier at about 1% to of about 2% by weight, based on the total weight of the composition; c) optionally additives and d) optionally additional active ingredient.

In some embodiments, the aqueous pesticidal suspension composition comprising a) emamectin or salt thereof; b) at least one polycationic rheology modifier at about 1.1% to of about 1.7% by weight, based on the total weight of the composition; c) optionally additives and d) optionally additional active ingredient.

In some embodiments, the aqueous pesticidal suspension composition comprising a) emamectin or salt thereof; b) at least one polycationic rheology modifier at about 1.2% by weight, based on the total weight of the composition; c) optionally additives and d) optionally additional active ingredient.

In some embodiments, the aqueous pesticidal suspension composition comprising a) emamectin or salt thereof; b) at least one polycationic type rheology modifier comprises monomers with ammonium, sulfonium or phosphonium moiety at about 1% to of about 3% by weight, based on the total weight of the composition; c) optionally additives and d) optionally additional active ingredient.

In some embodiments, the aqueous pesticidal suspension composition comprising a) emamectin or salt thereof; b) at least one polycationic type rheology modifier comprises monomers with ammonium, sulfonium or phosphonium moiety at about 1% to of about 2% by weight, based on the total weight of the composition; c) optionally additives and d) optionally additional active ingredient.

In some embodiments, the aqueous pesticidal suspension composition comprising a) emamectin or salt thereof; b) at least one polycationic type rheology modifier comprises monomers with ammonium, sulfonium or phosphonium moiety at about 1.1% to of about 1.7% by weight, based on the total weight of the composition; c) optionally additives and d) optionally additional active ingredient.

In some embodiments, the aqueous pesticidal suspension composition comprising a) emamectin or salt thereof; b) at least one polycationic type rheology modifier comprises monomers with ammonium, sulfonium or phosphonium moiety at about 1.2% by weight, based on the total weight of the composition; c) optionally additives and d) optionally additional active ingredient.

In some embodiments, the aqueous pesticidal suspension composition comprising a) emamectin or salt thereof; b) at least one polycationic type rheology modifier comprises monomers with ammonium moiety at about 1% to of about 3% by weight, based on the total weight of the composition; c) optionally additives and d) optionally additional active ingredient.

In some embodiments, the aqueous pesticidal suspension composition comprising a) emamectin or salt thereof; b) at least one polycationic type rheology modifier comprises monomers with ammonium moiety at about 1% to of about 2% by weight, based on the total weight of the composition; c) optionally additives and d) optionally additional active ingredient.

In some embodiments, the aqueous pesticidal suspension composition comprising a) emamectin or salt thereof; b) at least one polycationic type rheology modifier comprises monomers with ammonium moiety at about 1.1% to of about 1.7% by weight, based on the total weight of the composition; c) optionally additives and d) optionally additional active ingredient.

In some embodiments, the aqueous pesticidal suspension composition comprising a) emamectin or salt thereof; b) at least one polycationic type rheology modifier comprises monomers with ammonium moiety at about 1.2% by weight, based on the total weight of the composition; c) optionally additives and d) optionally additional active ingredient.

In some embodiments, the aqueous pesticidal suspension composition comprising a) emamectin or salt thereof; b) at least one polycationic type rheology modifier comprises monomers with ammonium moiety is selected from polyquaterniums or polyquaternium esters polymers and combinations thereof at about 1% to of about 3% by weight, based on the total weight of the composition; c) optionally additives and d) optionally additional active ingredient.

In some embodiments, the aqueous pesticidal suspension composition comprising a) emamectin or salt thereof; b) at least one polycationic type rheology modifier comprises monomers with ammonium moiety is selected from polyquaterniums or polyquaternium esters polymers and combinations thereof at about 1% to of about 2% by weight, based on the total weight of the composition; c) optionally additives and d) optionally additional active ingredient.

In some embodiments, the aqueous pesticidal suspension composition comprising a) emamectin or salt thereof; b) at least one polycationic type rheology modifier comprises monomers with ammonium moiety is selected from polyquaterniums or polyquaternium esters polymers and combinations thereof at about 1.1% to of about 1.7% by weight, based on the total weight of the composition; c) optionally additives and d) optionally additional active ingredient.

In some embodiments, the aqueous pesticidal suspension composition comprising a) emamectin or salt thereof; b) at least one polycationic type rheology modifier comprises monomers with ammonium moiety is selected from polyquaterniums or polyquaternium esters polymers and combinations thereof at about 1.2% by weight, based on the total weight of the composition; c) optionally additives and d) optionally additional active ingredient.

In some embodiments, the aqueous pesticidal suspension composition comprising a) emamectin or salt thereof; b) at least one polycationic type rheology modifier comprises monomers with ammonium moiety is poly(2-methacryloxyethyltrimethylammonium chloride) at about 1% to of about 3% by weight, based on the total weight of the composition; c) optionally additives and d) optionally additional active ingredient.

In some embodiments, the aqueous pesticidal suspension composition comprising a) emamectin or salt thereof; b) at least one polycationic type rheology modifier comprises monomers with ammonium moiety is poly(2-methacryloxyethyltrimethylammonium chloride) at about 1% to of about 2% by weight, based on the total weight of the composition; c) optionally additives and d) optionally additional active ingredient.

In some embodiments, the aqueous pesticidal suspension composition comprising a) emamectin or salt thereof; b) at least one polycationic type rheology modifier comprises monomers with ammonium moiety is poly(2-methacryloxyethyltrimethylammonium chloride) at about 1.1% to of about 1.7% by weight, based on the total weight of the composition; c) optionally additives and d) optionally additional active ingredient.

In some embodiments, the aqueous pesticidal suspension composition comprising a) emamectin or salt thereof; b) at least one polycationic type rheology modifier comprises monomers with ammonium moiety is poly(2-methacryloxyethyltrimethylammonium chloride) at about 1.2% by weight, based on the total weight of the composition; c) optionally additives and d) optionally additional active ingredient.

In some embodiments, the aqueous pesticidal suspension composition comprising a) emamectin or salt thereof at about 1% to of about 20% by weight, based on the total weight of the composition; b) at least one polycationic rheology modifier at about 1% to of about 3% by weight, based on the total weight of the composition; c) optionally additives and d) optionally additional active ingredient.

In some embodiments, the aqueous pesticidal suspension composition comprising a) emamectin or salt thereof at about 3% to of about 10% by weight, based on the total weight of the composition; b) at least one polycationic rheology modifier at about 1% to of about 3% by weight, based on the total weight of the composition; c) optionally additives and d) optionally additional active ingredient.

In some embodiments, the aqueous pesticidal suspension composition comprising a) emamectin or salt thereof at about 5% to of about 8% by weight, based on the total weight of the composition; b) at least one polycationic rheology modifier at about 1% to of about 3% by weight, based on the total weight of the composition; c) optionally additives and d) optionally additional active ingredient.

In some embodiments, the aqueous pesticidal suspension composition comprising a) emamectin or salt thereof at about 7.5% by weight, based on the total weight of the composition; b) at least one polycationic rheology modifier at about 1% to of about 3% by weight, based on the total weight of the composition; c) optionally additives and d) optionally additional active ingredient.

In some embodiments, the aqueous pesticidal suspension composition comprising a) emamectin or salt thereof at about 1% to of about 20% by weight, based on the total weight of the composition; b) at least one polycationic rheology modifier at about 1% to of about 2% by weight, based on the total weight of the composition; c) optionally additives and d) optionally additional active ingredient.

In some embodiments, the aqueous pesticidal suspension composition comprising a) emamectin or salt thereof at about 3% to of about 10% by weight, based on the total weight of the composition; b) at least one polycationic rheology modifier at about 1% to of about 2% by weight, based on the total weight of the composition; c) optionally additives and d) optionally additional active ingredient.

In some embodiments, the aqueous pesticidal suspension composition comprising a) emamectin or salt thereof at about 5% to of about 8% by weight, based on the total weight of the composition; b) at least one polycationic rheology modifier at about 1% to of about 2% by weight, based on the total weight of the composition; c) optionally additives and d) optionally additional active ingredient.

In some embodiments, the aqueous pesticidal suspension composition comprising a) emamectin or salt thereof at about 7.5% by weight, based on the total weight of the composition; b) at least one polycationic rheology modifier at about 1% to of about 2% by weight, based on the total weight of the composition; c) optionally additives and d) optionally additional active ingredient.

In some embodiments, the aqueous pesticidal suspension composition comprising a) emamectin or salt thereof at about 1% to of about 20% by weight, based on the total weight of the composition; b) at least one polycationic rheology modifier at about 1.1% to of about 1.7% by weight, based on the total weight of the composition; c) optionally additives and d) optionally additional active ingredient.

In some embodiments, the aqueous pesticidal suspension composition comprising a) emamectin or salt thereof at about 3% to of about 10% by weight, based on the total weight of the composition; b) at least one polycationic rheology modifier at about 1.1% to of about 1.7% by weight, based on the total weight of the composition; c) optionally additives and d) optionally additional active ingredient.

In some embodiments, the aqueous pesticidal suspension composition comprising a) emamectin or salt thereof at about 5% to of about 8% by weight, based on the total weight of the composition; b) at least one polycationic rheology modifier at about 1.1% to of about 1.7% by weight, based on the total weight of the composition; c) optionally additives and d) optionally additional active ingredient.

In some embodiments, the aqueous pesticidal suspension composition comprising a) emamectin or salt thereof at about 7.5% by weight, based on the total weight of the composition; b) at least one polycationic rheology modifier at about 1.1% to of about 1.7% by weight, based on the total weight of the composition; c) optionally additives and d) optionally additional active ingredient.

In some embodiments, the aqueous pesticidal suspension composition comprising a) emamectin or salt thereof at about 1% to of about 20% by weight, based on the total weight of the composition; b) at least one polycationic rheology modifier at about 1.2% by weight, based on the total weight of the composition; c) optionally additives and d) optionally additional active ingredient.

In some embodiments, the aqueous pesticidal suspension composition comprising a) emamectin or salt thereof at about 3% to of about 10% by weight, based on the total weight of the composition; b) at least one polycationic rheology modifier at about 1.2% by weight, based on the total weight of the composition; c) optionally additives and d) optionally additional active ingredient.

In some embodiments, the aqueous pesticidal suspension composition comprising a) emamectin or salt thereof at about 5% to of about 8% by weight, based on the total weight of the composition; b) at least one polycationic rheology modifier at about 1.2% by weight, based on the total weight of the composition; c) optionally additives and d) optionally additional active ingredient.

In some embodiments, the aqueous pesticidal suspension composition comprising a) emamectin or salt thereof at about 7.5% by weight, based on the total weight of the composition; b) at least one polycationic rheology modifier at about 1.2% by weight, based on the total weight of the composition; c) optionally additives and d) optionally additional active ingredient.

In some embodiments, the aqueous pesticidal suspension composition comprising a) emamectin or salt thereof at about 1% to of about 20% by weight, based on the total weight of the composition; b) at least one polycationic type rheology modifier comprises monomers with ammonium, sulfonium or phosphonium moiety at about 1% to of about 3% by weight, based on the total weight of the composition; c) optionally additives and d) optionally additional active ingredient.

In some embodiments, the aqueous pesticidal suspension composition comprising a) emamectin or salt thereof at about 3% to of about 10% by weight, based on the total weight of the composition; b) at least one polycationic type rheology modifier comprises monomers with ammonium, sulfonium or phosphonium moiety at about 1% to of about 3% by weight, based on the total weight of the composition; c) optionally additives and d) optionally additional active ingredient.

In some embodiments, the aqueous pesticidal suspension composition comprising a) emamectin or salt thereof at about 5% to of about 8% by weight, based on the total weight of the composition; b) at least one polycationic type rheology modifier comprises monomers with ammonium, sulfonium or phosphonium moiety at about 1% to of about 3% by weight, based on the total weight of the composition; c) optionally additives and d) optionally additional active ingredient.

In some embodiments, the aqueous pesticidal suspension composition comprising a) emamectin or salt thereof at about 7.5% by weight, based on the total weight of the composition; b) at least one polycationic type rheology modifier comprises monomers with ammonium, sulfonium or phosphonium moiety at about 1% to of about 3% by weight, based on the total weight of the composition; c) optionally additives and d) optionally additional active ingredient.

In some embodiments, the aqueous pesticidal suspension composition comprising a) emamectin or salt thereof at about 1% to of about 20% by weight, based on the total weight of the composition; b) at least one polycationic type rheology modifier comprises monomers with ammonium, sulfonium or phosphonium moiety at about 1% to of about 2% by weight, based on the total weight of the composition; c) optionally additives and d) optionally additional active ingredient.

In some embodiments, the aqueous pesticidal suspension composition comprising a) emamectin or salt thereof at about 3% to of about 10% by weight, based on the total weight of the composition; b) at least one polycationic type rheology modifier comprises monomers with ammonium, sulfonium or phosphonium moiety at about 1% to of about 2% by weight, based on the total weight of the composition; c) optionally additives and d) optionally additional active ingredient.

In some embodiments, the aqueous pesticidal suspension composition comprising a) emamectin or salt thereof at about 5% to of about 8% by weight, based on the total weight of the composition; b) at least one polycationic type rheology modifier comprises monomers with ammonium, sulfonium or phosphonium moiety at about 1% to of about 2% by weight, based on the total weight of the composition; c) optionally additives and d) optionally additional active ingredient.

In some embodiments, the aqueous pesticidal suspension composition comprising a) emamectin or salt thereof at about 7.5% by weight, based on the total weight of the composition; b) at least one polycationic type rheology modifier comprises monomers with ammonium, sulfonium or phosphonium moiety at about 1% to of about 2% by weight, based on the total weight of the composition; c) optionally additives and d) optionally additional active ingredient.

In some embodiments, the aqueous pesticidal suspension composition comprising a) emamectin or salt thereof at about 1% to of about 20% by weight, based on the total weight of the composition; b) at least one polycationic type rheology modifier comprises monomers with ammonium, sulfonium or phosphonium moiety at about 1.1% to of about 1.7% by weight, based on the total weight of the composition; c) optionally additives and d) optionally additional active ingredient.

In some embodiments, the aqueous pesticidal suspension composition comprising a) emamectin or salt thereof at about 3% to of about 10% by weight, based on the total weight of the composition; b) at least one polycationic type rheology modifier comprises monomers with ammonium, sulfonium or phosphonium moiety at about 1.1% to of about 1.7% by weight, based on the total weight of the composition; c) optionally additives and d) optionally additional active ingredient.

In some embodiments, the aqueous pesticidal suspension composition comprising a) emamectin or salt thereof at about 5% to of about 8% by weight, based on the total weight of the composition; b) at least one polycationic type rheology modifier comprises monomers with ammonium, sulfonium or phosphonium moiety at about 1.1% to of about 1.7% by weight, based on the total weight of the composition; c) optionally additives and d) optionally additional active ingredient.

In some embodiments, the aqueous pesticidal suspension composition comprising a) emamectin or salt thereof at about 7.5% by weight, based on the total weight of the composition; b) at least one polycationic type rheology modifier comprises monomers with ammonium, sulfonium or phosphonium moiety at about 1.1% to of about 1.7% by weight, based on the total weight of the composition; c) optionally additives and d) optionally additional active ingredient.

In some embodiments, the aqueous pesticidal suspension composition comprising a) emamectin or salt thereof at about 1% to of about 20% by weight, based on the total weight of the composition; b) at least one polycationic type rheology modifier comprises monomers with ammonium, sulfonium or phosphonium moiety at about 1.2% by weight, based on the total weight of the composition; c) optionally additives and d) optionally additional active ingredient.

In some embodiments, the aqueous pesticidal suspension composition comprising a) emamectin or salt thereof at about 3% to of about 10% by weight, based on the total weight of the composition; b) at least one polycationic type rheology modifier comprises monomers with ammonium, sulfonium or phosphonium moiety at about 1.2% by weight, based on the total weight of the composition; c) optionally additives and d) optionally additional active ingredient.

In some embodiments, the aqueous pesticidal suspension composition comprising a) emamectin or salt thereof at about 5% to of about 8% by weight, based on the total weight of the composition; b) at least one polycationic type rheology modifier comprises monomers with ammonium, sulfonium or phosphonium moiety at about 1.2% by weight, based on the total weight of the composition; c) optionally additives and d) optionally additional active ingredient.

In some embodiments, the aqueous pesticidal suspension composition comprising a) emamectin or salt thereof at about 7.5% by weight, based on the total weight of the composition; b) at least one polycationic type rheology modifier comprises monomers with ammonium, sulfonium or phosphonium moiety at about 1.2% by weight, based on the total weight of the composition; c) optionally additives and d) optionally additional active ingredient.

In some embodiments, the aqueous pesticidal suspension composition comprising a) emamectin or salt thereof at about 1% to of about 20% by weight, based on the total weight of the composition; b) at least one polycationic type rheology modifier comprises monomers with ammonium moiety at about 1% to of about 3% by weight, based on the total weight of the composition; c) optionally additives and d) optionally additional active ingredient.

In some embodiments, the aqueous pesticidal suspension composition comprising a) emamectin or salt thereof at about 3% to of about 10% by weight, based on the total weight of the composition; b) at least one polycationic type rheology modifier comprises monomers with ammonium moiety at about 1% to of about 3% by weight, based on the total weight of the composition; c) optionally additives and d) optionally additional active ingredient.

In some embodiments, the aqueous pesticidal suspension composition comprising a) emamectin or salt thereof at about 5% to of about 8% by weight, based on the total weight of the composition; b) at least one polycationic type rheology modifier comprises monomers with ammonium moiety at about 1% to of about 3% by weight, based on the total weight of the composition; c) optionally additives and d) optionally additional active ingredient.

In some embodiments, the aqueous pesticidal suspension composition comprising a) emamectin or salt thereof at about 7.5% by weight, based on the total weight of the composition; b) at least one polycationic type rheology modifier comprises monomers with ammonium moiety at about 1% to of about 3% by weight, based on the total weight of the composition; c) optionally additives and d) optionally additional active ingredient.

In some embodiments, the aqueous pesticidal suspension composition comprising a) emamectin or salt thereof at about 1% to of about 20% by weight, based on the total weight of the composition; b) at least one polycationic type rheology modifier comprises monomers with ammonium moiety at about 1% to of about 2% by weight, based on the total weight of the composition; c) optionally additives and d) optionally additional active ingredient.

In some embodiments, the aqueous pesticidal suspension composition comprising a) emamectin or salt thereof at about 3% to of about 10% by weight, based on the total weight of the composition; b) at least one polycationic type rheology modifier comprises monomers with ammonium moiety at about 1% to of about 2% by weight, based on the total weight of the composition; c) optionally additives and d) optionally additional active ingredient.

In some embodiments, the aqueous pesticidal suspension composition comprising a) emamectin or salt thereof at about 5% to of about 8% by weight, based on the total weight of the composition; b) at least one polycationic type rheology modifier comprises monomers with ammonium moiety at about 1% to of about 2% by weight, based on the total weight of the composition; c) optionally additives and d) optionally additional active ingredient.

In some embodiments, the aqueous pesticidal suspension composition comprising a) emamectin or salt thereof at about 7.5% by weight, based on the total weight of the composition; b) at least one polycationic type rheology modifier comprises monomers with ammonium moiety at about 1% to of about 2% by weight, based on the total weight of the composition; c) optionally additives and d) optionally additional active ingredient.

In some embodiments, the aqueous pesticidal suspension composition comprising a) emamectin or salt thereof at about 1% to of about 20% by weight, based on the total weight of the composition; b) at least one polycationic type rheology modifier comprises monomers with ammonium moiety at about 1.1% to of about 1.7% by weight, based on the total weight of the composition; c) optionally additives and d) optionally additional active ingredient.

In some embodiments, the aqueous pesticidal suspension composition comprising a) emamectin or salt thereof at about 3% to of about 10% by weight, based on the total weight of the composition; b) at least one polycationic type rheology modifier comprises monomers with ammonium moiety at about 1.1% to of about 1.7% by weight, based on the total weight of the composition; c) optionally additives and d) optionally additional active ingredient.

In some embodiments, the aqueous pesticidal suspension composition comprising a) emamectin or salt thereof at about 5% to of about 8% by weight, based on the total weight of the composition; b) at least one polycationic type rheology modifier comprises monomers with ammonium moiety at about 1.1% to of about 1.7% by weight, based on the total weight of the composition; c) optionally additives and d) optionally additional active ingredient.

In some embodiments, the aqueous pesticidal suspension composition comprising a) emamectin or salt thereof at about 7.5% by weight, based on the total weight of the composition; b) at least one polycationic type rheology modifier comprises monomers with ammonium moiety at about 1.1% to of about 1.7% by weight, based on the total weight of the composition; c) optionally additives and d) optionally additional active ingredient.

In some embodiments, the aqueous pesticidal suspension composition comprising a) emamectin or salt thereof at about 1% to of about 20% by weight, based on the total weight of the composition; b) at least one polycationic type rheology modifier comprises monomers with ammonium moiety at about 1.2% by weight, based on the total weight of the composition; c) optionally additives and d) optionally additional active ingredient.

In some embodiments, the aqueous pesticidal suspension composition comprising a) emamectin or salt thereof at about 3% to of about 10% by weight, based on the total weight of the composition; b) at least one polycationic type rheology modifier comprises monomers with ammonium moiety at about 1.2% by weight, based on the total weight of the composition; c) optionally additives and d) optionally additional active ingredient.

In some embodiments, the aqueous pesticidal suspension composition comprising a) emamectin or salt thereof at about 5% to of about 8% by weight, based on the total weight of the composition; b) at least one polycationic type rheology modifier comprises monomers with ammonium moiety at about 1.2% by weight, based on the total weight of the composition; c) optionally additives and d) optionally additional active ingredient.

In some embodiments, the aqueous pesticidal suspension composition comprising a) emamectin or salt thereof at about 7.5% by weight, based on the total weight of the composition; b) at least one polycationic type rheology modifier comprises monomers with ammonium moiety at about 1.2% by weight, based on the total weight of the composition; c) optionally additives and d) optionally additional active ingredient.

In some embodiments, the aqueous pesticidal suspension composition comprising a) emamectin or salt thereof at about 1% to of about 20% by weight, based on the total weight of the composition; b) at least one polycationic type rheology modifier comprises monomers with ammonium moiety is selected from polyquaterniums or polyquaternium esters polymers and combinations thereof at about 1% to of about 3% by weight, based on the total weight of the composition; c) optionally additives and d) optionally additional active ingredient.

In some embodiments, the aqueous pesticidal suspension composition comprising a) emamectin or salt thereof at about 3% to of about 10% by weight, based on the total weight of the composition; b) at least one polycationic type rheology modifier comprises monomers with ammonium moiety is selected from polyquaterniums or polyquaternium esters polymers and combinations thereof at about 1% to of about 3% by weight, based on the total weight of the composition; c) optionally additives and d) optionally additional active ingredient.

In some embodiments, the aqueous pesticidal suspension composition comprising a) emamectin or salt thereof at about 5% to of about 8% by weight, based on the total weight of the composition; b) at least one polycationic type rheology modifier comprises monomers with ammonium moiety is selected from polyquaterniums or polyquaternium esters polymers and combinations thereof at about 1% to of about 3% by weight, based on the total weight of the composition; c) optionally additives and d) optionally additional active ingredient.

In some embodiments, the aqueous pesticidal suspension composition comprising a) emamectin or salt thereof at about 7.5% by weight, based on the total weight of the composition; b) at least one polycationic type rheology modifier comprises monomers with ammonium moiety is selected from polyquaterniums or polyquaternium esters polymers and combinations thereof at about 1% to of about 3% by weight, based on the total weight of the composition; c) optionally additives and d) optionally additional active ingredient.

In some embodiments, the aqueous pesticidal suspension composition comprising a) emamectin or salt thereof at about 1% to of about 20% by weight, based on the total weight of the composition; b) at least one polycationic type rheology modifier comprises monomers with ammonium moiety is selected from polyquaterniums or polyquaternium esters polymers and combinations thereof at about 1% to of about 2% by weight, based on the total weight of the composition; c) optionally additives and d) optionally additional active ingredient.

In some embodiments, the aqueous pesticidal suspension composition comprising a) emamectin or salt thereof at about 3% to of about 9% by weight, based on the total weight of the composition; b) at least one polycationic type rheology modifier comprises monomers with ammonium moiety is selected from polyquaterniums or polyquaternium esters polymers and combinations thereof at about 1% to of about 2% by weight, based on the total weight of the composition; c) optionally additives and d) optionally additional active ingredient.

In some embodiments, the aqueous pesticidal suspension composition comprising a) emamectin or salt thereof at about 5% to of about 8% by weight, based on the total weight of the composition; b) at least one polycationic type rheology modifier comprises monomers with ammonium moiety is selected from polyquaterniums or polyquaternium esters polymers and combinations thereof at about 1% to of about 2% by weight, based on the total weight of the composition; c) optionally additives and d) optionally additional active ingredient.

In some embodiments, the aqueous pesticidal suspension composition comprising a) emamectin or salt thereof at about 7.5% by weight, based on the total weight of the composition; b) at least one polycationic type rheology modifier comprises monomers with ammonium moiety is selected from polyquaterniums or polyquaternium esters polymers and combinations thereof at about 1% to of about 2% by weight, based on the total weight of the composition; c) optionally additives and d) optionally additional active ingredient.

In some embodiments, the aqueous pesticidal suspension composition comprising a) emamectin or salt thereof at about 1% to of about 20% by weight, based on the total weight of the composition; b) at least one polycationic type rheology modifier comprises monomers with ammonium moiety is selected from polyquaterniums or polyquaternium esters polymers and combinations thereof at about 1.1% to of about 1.7% by weight, based on the total weight of the composition; c) optionally additives and d) optionally additional active ingredient.

In some embodiments, the aqueous pesticidal suspension composition comprising a) emamectin or salt thereof at about 3% to of about 10% by weight, based on the total weight of the composition; b) at least one polycationic type rheology modifier comprises monomers with ammonium moiety is selected from polyquaterniums or polyquaternium esters polymers and combinations thereof at about 1.1% to of about 1.7% by weight, based on the total weight of the composition; c) optionally additives and d) optionally additional active ingredient.

In some embodiments, the aqueous pesticidal suspension composition comprising a) emamectin or salt thereof at about 5% to of about 8% by weight, based on the total weight of the composition; b) at least one polycationic type rheology modifier comprises monomers with ammonium moiety is selected from polyquaterniums or polyquaternium esters polymers and combinations thereof at about 1.1% to of about 1.7% by weight, based on the total weight of the composition; c) optionally additives and d) optionally additional active ingredient.

In some embodiments, the aqueous pesticidal suspension composition comprising a) emamectin or salt thereof at about 7.5% by weight, based on the total weight of the composition; b) at least one polycationic type rheology modifier comprises monomers with ammonium moiety is selected from polyquaterniums or polyquaternium esters polymers and combinations thereof at about 1.1% to of about 1.7% by weight, based on the total weight of the composition; c) optionally additives and d) optionally additional active ingredient.

In some embodiments, the aqueous pesticidal suspension composition comprising a) emamectin or salt thereof at about 1% to of about 20% by weight, based on the total weight of the composition; b) at least one polycationic type rheology modifier comprises monomers with ammonium moiety is selected from polyquaterniums or polyquaternium esters polymers and combinations thereof at about 1.2% by weight, based on the total weight of the composition; c) optionally additives and d) optionally additional active ingredient.

In some embodiments, the aqueous pesticidal suspension composition comprising a) emamectin or salt thereof at about 3% to of about 10% by weight, based on the total weight of the composition; b) at least one polycationic type rheology modifier comprises monomers with ammonium moiety is selected from polyquaterniums or polyquaternium esters polymers and combinations thereof at about 1.2% by weight, based on the total weight of the composition; c) optionally additives and d) optionally additional active ingredient.

In some embodiments, the aqueous pesticidal suspension composition comprising a) emamectin or salt thereof at about 5% to of about 8% by weight, based on the total weight of the composition; b) at least one polycationic type rheology modifier comprises monomers with ammonium moiety is selected from polyquaterniums or polyquaternium esters polymers and combinations thereof at about 1.2% by weight, based on the total weight of the composition; c) optionally additives and d) optionally additional active ingredient.

In some embodiments, the aqueous pesticidal suspension composition comprising a) emamectin or salt thereof at about 7.5% by weight, based on the total weight of the composition; b) at least one polycationic type rheology modifier comprises monomers with ammonium moiety is selected from polyquaterniums or polyquaternium esters polymers and combinations thereof at about 1.2% by weight, based on the total weight of the composition; c) optionally additives and d) optionally additional active ingredient.

In some embodiments, the aqueous pesticidal suspension composition comprising a) emamectin or salt thereof at about 1% to of about 20% by weight, based on the total weight of the composition; b) at least one polycationic type rheology modifier comprises monomers with ammonium moiety is poly(2-methacryloxyethyltrimethylammonium chloride) at about 1% to of about 3% by weight, based on the total weight of the composition; c) optionally additives and d) optionally additional active ingredient.

In some embodiments, the aqueous pesticidal suspension composition comprising a) emamectin or salt thereof at about 3% to of about 10% by weight, based on the total weight of the composition; b) at least one polycationic type rheology modifier comprises monomers with ammonium moiety is poly(2-methacryloxyethyltrimethylammonium chloride) at about 1% to of about 3% by weight, based on the total weight of the composition; c) optionally additives and d) optionally additional active ingredient.

In some embodiments, the aqueous pesticidal suspension composition comprising a) emamectin or salt thereof at about 5% to of about 8% by weight, based on the total weight of the composition; b) at least one polycationic type rheology modifier comprises monomers with ammonium moiety is poly(2-methacryloxyethyltrimethylammonium chloride) at about 1% to of about 3% by weight, based on the total weight of the composition; c) optionally additives and d) optionally additional active ingredient.

In some embodiments, the aqueous pesticidal suspension composition comprising a) emamectin or salt thereof at about 7.5% by weight, based on the total weight of the composition; b) at least one polycationic type rheology modifier comprises monomers with ammonium moiety is poly(2-methacryloxyethyltrimethylammonium chloride) at about 1% to of about 3% by weight, based on the total weight of the composition; c) optionally additives and d) optionally additional active ingredient.

In some embodiments, the aqueous pesticidal suspension composition comprising a) emamectin or salt thereof at about 1% to of about 20% by weight, based on the total weight of the composition; b) at least one polycationic type rheology modifier comprises monomers with ammonium moiety is poly(2-methacryloxyethyltrimethylammonium chloride) at about 1% to of about 2% by weight, based on the total weight of the composition; c) optionally additives and d) optionally additional active ingredient.

In some embodiments, the aqueous pesticidal suspension composition comprising a) emamectin or salt thereof at about 3% to of about 10% by weight, based on the total weight of the composition; b) at least one polycationic type rheology modifier comprises monomers with ammonium moiety is poly(2-methacryloxyethyltrimethylammonium chloride) at about 1% to of about 2% by weight, based on the total weight of the composition; c) optionally additives and d) optionally additional active ingredient.

In some embodiments, the aqueous pesticidal suspension composition comprising a) emamectin or salt thereof at about 5% to of about 8% by weight, based on the total weight of the composition; b) at least one polycationic type rheology modifier comprises monomers with ammonium moiety is poly(2-methacryloxyethyltrimethylammonium chloride) at about 1% to of about 2% by weight, based on the total weight of the composition; c) optionally additives and d) optionally additional active ingredient.

In some embodiments, the aqueous pesticidal suspension composition comprising a) emamectin or salt thereof at about 7.5% by weight, based on the total weight of the composition; b) at least one polycationic type rheology modifier comprises monomers with ammonium moiety is poly(2-methacryloxyethyltrimethylammonium chloride) at about 1% to of about 2% by weight, based on the total weight of the composition; c) optionally additives and d) optionally additional active ingredient.

In some embodiments, the aqueous pesticidal suspension composition comprising a) emamectin or salt thereof at about 1% to of about 20% by weight, based on the total weight of the composition; b) at least one polycationic type rheology modifier comprises monomers with ammonium moiety is poly(2-methacryloxyethyltrimethylammonium chloride) at about 1.1% to of about 1.7% by weight, based on the total weight of the composition; c) optionally additives and d) optionally additional active ingredient.

In some embodiments, the aqueous pesticidal suspension composition comprising a) emamectin or salt thereof at about 3% to of about 10% by weight, based on the total weight of the composition; b) at least one polycationic type rheology modifier comprises monomers with ammonium moiety is poly(2-methacryloxyethyltrimethylammonium chloride) at about 1.1% to of about 1.7% by weight, based on the total weight of the composition; c) optionally additives and d) optionally additional active ingredient.

In some embodiments, the aqueous pesticidal suspension composition comprising a) emamectin or salt thereof at about 5% to of about 8% by weight, based on the total weight of the composition; b) at least one polycationic type rheology modifier comprises monomers with ammonium moiety is poly(2-methacryloxyethyltrimethylammonium chloride) at about 1.1% to of about 1.7% by weight, based on the total weight of the composition; c) optionally additives and d) optionally additional active ingredient.

In some embodiments, the aqueous pesticidal suspension composition comprising a) emamectin or salt thereof at about 7.5% by weight, based on the total weight of the composition; b) at least one polycationic type rheology modifier comprises monomers with ammonium moiety is poly(2-methacryloxyethyltrimethylammonium chloride) at about 1.1% to of about 1.7% by weight, based on the total weight of the composition; c) optionally additives and d) optionally additional active ingredient.

In some embodiments, the aqueous pesticidal suspension composition comprising a) emamectin or salt thereof at about 1% to of about 20% by weight, based on the total weight of the composition; b) at least one polycationic type rheology modifier comprises monomers with ammonium moiety is poly(2-methacryloxyethyltrimethylammonium chloride) at about 1.2% by weight, based on the total weight of the composition; c) optionally additives and d) optionally additional active ingredient.

In some embodiments, the aqueous pesticidal suspension composition comprising a) emamectin or salt thereof at about 3% to of about 10% by weight, based on the total weight of the composition; b) at least one polycationic type rheology modifier comprises monomers with ammonium moiety is poly(2-methacryloxyethyltrimethylammonium chloride) at about 1.2% by weight, based on the total weight of the composition; c) optionally additives and d) optionally additional active ingredient.

In some embodiments, the aqueous pesticidal suspension composition comprising a) emamectin or salt thereof at about 5% to of about 8% by weight, based on the total weight of the composition; b) at least one polycationic type rheology modifier comprises monomers with ammonium moiety is poly(2-methacryloxyethyltrimethylammonium chloride) at about 1.2% by weight, based on the total weight of the composition; c) optionally additives and d) optionally additional active ingredient.

In some embodiments, the aqueous pesticidal suspension composition comprising a) emamectin or salt thereof at about 7.5% by weight, based on the total weight of the composition; b) at least one polycationic type rheology modifier comprises monomers with ammonium moiety is poly(2-methacryloxyethyltrimethylammonium chloride) at about 1.2% by weight, based on the total weight of the composition; c) optionally additives and d) optionally additional active ingredient.

In some embodiments, the aqueous pesticidal suspension composition comprising a) emamectin or salt thereof at about 1% to of about 20% by weight, based on the total weight of the composition; b) at least one polycationic rheology modifier at about 1% to of about 3% by weight, based on the total weight of the composition; c) optionally additives and d) a diamide insecticide.

In some embodiments, the aqueous pesticidal suspension composition comprising a) emamectin or salt thereof at about 3% to of about 10% by weight, based on the total weight of the composition; b) at least one polycationic rheology modifier at about 1% to of about 3% by weight, based on the total weight of the composition; c) optionally additives and d) a diamide insecticide.

In some embodiments, the aqueous pesticidal suspension composition comprising a) emamectin or salt thereof at about 5% to of about 8% by weight, based on the total weight of the composition; b) at least one polycationic rheology modifier at about 1% to of about 3% by weight, based on the total weight of the composition; c) optionally additives and d) a diamide insecticide.

In some embodiments, the aqueous pesticidal suspension composition comprising a) emamectin or salt thereof at about 7.5% by weight, based on the total weight of the composition; b) at least one polycationic rheology modifier at about 1% to of about 3% by weight, based on the total weight of the composition; c) optionally additives and d) a diamide insecticide.

In some embodiments, the aqueous pesticidal suspension composition comprising a) emamectin or salt thereof at about 1% to of about 20% by weight, based on the total weight of the composition; b) at least one polycationic rheology modifier at about 1% to of about 2% by weight, based on the total weight of the composition; c) optionally additives and d) a diamide insecticide.

In some embodiments, the aqueous pesticidal suspension composition comprising a) emamectin or salt thereof at about 3% to of about 10% by weight, based on the total weight of the composition; b) at least one polycationic rheology modifier at about 1% to of about 2% by weight, based on the total weight of the composition; c) optionally additives and d) a diamide insecticide.

In some embodiments, the aqueous pesticidal suspension composition comprising a) emamectin or salt thereof at about 5% to of about 8% by weight, based on the total weight of the composition; b) at least one polycationic rheology modifier at about 1% to of about 2% by weight, based on the total weight of the composition; c) optionally additives and d) a diamide insecticide.

In some embodiments, the aqueous pesticidal suspension composition comprising a) emamectin or salt thereof at about 7.5% by weight, based on the total weight of the composition; b) at least one polycationic rheology modifier at about 1% to of about 2% by weight, based on the total weight of the composition; c) optionally additives and d) a diamide insecticide.

In some embodiments, the aqueous pesticidal suspension composition comprising a) emamectin or salt thereof at about 1% to of about 20% by weight, based on the total weight of the composition; b) at least one polycationic rheology modifier at about 1.1% to of about 1.7% by weight, based on the total weight of the composition; c) optionally additives and d) a diamide insecticide.

In some embodiments, the aqueous pesticidal suspension composition comprising a) emamectin or salt thereof at about 3% to of about 10% by weight, based on the total weight of the composition; b) at least one polycationic rheology modifier at about 1.1% to of about 1.7% by weight, based on the total weight of the composition; c) optionally additives and d) a diamide insecticide.

In some embodiments, the aqueous pesticidal suspension composition comprising a) emamectin or salt thereof at about 5% to of about 8% by weight, based on the total weight of the composition; b) at least one polycationic rheology modifier at about 1.1% to of about 1.7% by weight, based on the total weight of the composition; c) optionally additives and d) a diamide insecticide.

In some embodiments, the aqueous pesticidal suspension composition comprising a) emamectin or salt thereof at about 7.5% by weight, based on the total weight of the composition; b) at least one polycationic rheology modifier at about 1.1% to of about 1.7% by weight, based on the total weight of the composition; c) optionally additives and d) a diamide insecticide.

In some embodiments, the aqueous pesticidal suspension composition comprising a) emamectin or salt thereof at about 1% to of about 20% by weight, based on the total weight of the composition; b) at least one polycationic rheology modifier at about 1.2% by weight, based on the total weight of the composition; c) optionally additives and d) a diamide insecticide.

In some embodiments, the aqueous pesticidal suspension composition comprising a) emamectin or salt thereof at about 3% to of about 10% by weight, based on the total weight of the composition; b) at least one polycationic rheology modifier at about 1.2% by weight, based on the total weight of the composition; c) optionally additives and d) a diamide insecticide.

In some embodiments, the aqueous pesticidal suspension composition comprising a) emamectin or salt thereof at about 5% to of about 8% by weight, based on the total weight of the composition; b) at least one polycationic rheology modifier at about 1.2% by weight, based on the total weight of the composition; c) optionally additives and d) a diamide insecticide.

In some embodiments, the aqueous pesticidal suspension composition comprising a) emamectin or salt thereof at about 7.5% by weight, based on the total weight of the composition; b) at least one polycationic rheology modifier at about 1.2% by weight, based on the total weight of the composition; c) optionally additives and d) a diamide insecticide.

In some embodiments, the aqueous pesticidal suspension composition comprising a) emamectin or salt thereof at about 1% to of about 20% by weight, based on the total weight of the composition; b) at least one polycationic type rheology modifier comprises monomers with ammonium, sulfonium or phosphonium moiety at about 1% to of about 3% by weight, based on the total weight of the composition; c) optionally additives and d) a diamide insecticide.

In some embodiments, the aqueous pesticidal suspension composition comprising a) emamectin or salt thereof at about 3% to of about 10% by weight, based on the total weight of the composition; b) at least one polycationic type rheology modifier comprises monomers with ammonium, sulfonium or phosphonium moiety at about 1% to of about 3% by weight, based on the total weight of the composition; c) optionally additives and d) a diamide insecticide.

In some embodiments, the aqueous pesticidal suspension composition comprising a) emamectin or salt thereof at about 5% to of about 8% by weight, based on the total weight of the composition; b) at least one polycationic type rheology modifier comprises monomers with ammonium, sulfonium or phosphonium moiety at about 1% to of about 3% by weight, based on the total weight of the composition; c) optionally additives and d) a diamide insecticide.

In some embodiments, the aqueous pesticidal suspension composition comprising a) emamectin or salt thereof at about 7.5% by weight, based on the total weight of the composition; b) at least one polycationic type rheology modifier comprises monomers with ammonium, sulfonium or phosphonium moiety at about 1% to of about 3% by weight, based on the total weight of the composition; c) optionally additives and d) a diamide insecticide.

In some embodiments, the aqueous pesticidal suspension composition comprising a) emamectin or salt thereof at about 1% to of about 20% by weight, based on the total weight of the composition; b) at least one polycationic type rheology modifier comprises monomers with ammonium, sulfonium or phosphonium moiety at about 1% to of about 2% by weight, based on the total weight of the composition; c) optionally additives and d) a diamide insecticide.

In some embodiments, the aqueous pesticidal suspension composition comprising a) emamectin or salt thereof at about 3% to of about 10% by weight, based on the total weight of the composition; b) at least one polycationic type rheology modifier comprises monomers with ammonium, sulfonium or phosphonium moiety at about 1% to of about 2% by weight, based on the total weight of the composition; c) optionally additives and d) a diamide insecticide.

In some embodiments, the aqueous pesticidal suspension composition comprising a) emamectin or salt thereof at about 5% to of about 8% by weight, based on the total weight of the composition; b) at least one polycationic type rheology modifier comprises monomers with ammonium, sulfonium or phosphonium moiety at about 1% to of about 2% by weight, based on the total weight of the composition; c) optionally additives and d) a diamide insecticide.

In some embodiments, the aqueous pesticidal suspension composition comprising a) emamectin or salt thereof at about 7.5% by weight, based on the total weight of the composition; b) at least one polycationic type rheology modifier comprises monomers with ammonium, sulfonium or phosphonium moiety at about 1% to of about 2% by weight, based on the total weight of the composition; c) optionally additives and d) a diamide insecticide.

In some embodiments, the aqueous pesticidal suspension composition comprising a) emamectin or salt thereof at about 1% to of about 20% by weight, based on the total weight of the composition; b) at least one polycationic type rheology modifier comprises monomers with ammonium, sulfonium or phosphonium moiety at about 1.1% to of about 1.7% by weight, based on the total weight of the composition; c) optionally additives and d) a diamide insecticide.

In some embodiments, the aqueous pesticidal suspension composition comprising a) emamectin or salt thereof at about 3% to of about 10% by weight, based on the total weight of the composition; b) at least one polycationic type rheology modifier comprises monomers with ammonium, sulfonium or phosphonium moiety at about 1.1% to of about 1.7% by weight, based on the total weight of the composition; c) optionally additives and d) a diamide insecticide.

In some embodiments, the aqueous pesticidal suspension composition comprising a) emamectin or salt thereof at about 5% to of about 8% by weight, based on the total weight of the composition; b) at least one polycationic type rheology modifier comprises monomers with ammonium, sulfonium or phosphonium moiety at about 1.1% to of about 1.7% by weight, based on the total weight of the composition; c) optionally additives and d) a diamide insecticide.

In some embodiments, the aqueous pesticidal suspension composition comprising a) emamectin or salt thereof at about 7.5% by weight, based on the total weight of the composition; b) at least one polycationic type rheology modifier comprises monomers with ammonium, sulfonium or phosphonium moiety at about 1.1% to of about 1.7% by weight, based on the total weight of the composition; c) optionally additives and d) a diamide insecticide.

In some embodiments, the aqueous pesticidal suspension composition comprising a) emamectin or salt thereof at about 1% to of about 20% by weight, based on the total weight of the composition; b) at least one polycationic type rheology modifier comprises monomers with ammonium, sulfonium or phosphonium moiety at about 1.2% by weight, based on the total weight of the composition; c) optionally additives and d) a diamide insecticide.

In some embodiments, the aqueous pesticidal suspension composition comprising a) emamectin or salt thereof at about 3% to of about 10% by weight, based on the total weight of the composition; b) at least one polycationic type rheology modifier comprises monomers with ammonium, sulfonium or phosphonium moiety at about 1.2% by weight, based on the total weight of the composition; c) optionally additives and d) a diamide insecticide.

In some embodiments, the aqueous pesticidal suspension composition comprising a) emamectin or salt thereof at about 5% to of about 8% by weight, based on the total weight of the composition; b) at least one polycationic type rheology modifier comprises monomers with ammonium, sulfonium or phosphonium moiety at about 1.2% by weight, based on the total weight of the composition; c) optionally additives and d) a diamide insecticide.

In some embodiments, the aqueous pesticidal suspension composition comprising a) emamectin or salt thereof at about 7.5% by weight, based on the total weight of the composition; b) at least one polycationic type rheology modifier comprises monomers with ammonium, sulfonium or phosphonium moiety at about 1.2% by weight, based on the total weight of the composition; c) optionally additives and d) a diamide insecticide.

In some embodiments, the aqueous pesticidal suspension composition comprising a) emamectin or salt thereof at about 1% to of about 20% by weight, based on the total weight of the composition; b) at least one polycationic type rheology modifier comprises monomers with ammonium moiety at about 1% to of about 3% by weight, based on the total weight of the composition; c) optionally additives and d) a diamide insecticide.

In some embodiments, the aqueous pesticidal suspension composition comprising a) emamectin or salt thereof at about 3% to of about 10% by weight, based on the total weight of the composition; b) at least one polycationic type rheology modifier comprises monomers with ammonium moiety at about 1% to of about 3% by weight, based on the total weight of the composition; c) optionally additives and d) a diamide insecticide.

In some embodiments, the aqueous pesticidal suspension composition comprising a) emamectin or salt thereof at about 5% to of about 8% by weight, based on the total weight of the composition; b) at least one polycationic type rheology modifier comprises monomers with ammonium moiety at about 1% to of about 3% by weight, based on the total weight of the composition; c) optionally additives and d) a diamide insecticide.

In some embodiments, the aqueous pesticidal suspension composition comprising a) emamectin or salt thereof at about 7.5% by weight, based on the total weight of the composition; b) at least one polycationic type rheology modifier comprises monomers with ammonium moiety at about 1% to of about 3% by weight, based on the total weight of the composition; c) optionally additives and d) a diamide insecticide.

In some embodiments, the aqueous pesticidal suspension composition comprising a) emamectin or salt thereof at about 1% to of about 20% by weight, based on the total weight of the composition; b) at least one polycationic type rheology modifier comprises monomers with ammonium moiety at about 1% to of about 2% by weight, based on the total weight of the composition; c) optionally additives and d) a diamide insecticide.

In some embodiments, the aqueous pesticidal suspension composition comprising a) emamectin or salt thereof at about 3% to of about 10% by weight, based on the total weight of the composition; b) at least one polycationic type rheology modifier comprises monomers with ammonium moiety at about 1% to of about 2% by weight, based on the total weight of the composition; c) optionally additives and d) a diamide insecticide.

In some embodiments, the aqueous pesticidal suspension composition comprising a) emamectin or salt thereof at about 5% to of about 8% by weight, based on the total weight of the composition; b) at least one polycationic type rheology modifier comprises monomers with ammonium moiety at about 1% to of about 2% by weight, based on the total weight of the composition; c) optionally additives and d) a diamide insecticide.

In some embodiments, the aqueous pesticidal suspension composition comprising a) emamectin or salt thereof at about 7.5% by weight, based on the total weight of the composition; b) at least one polycationic type rheology modifier comprises monomers with ammonium moiety at about 1% to of about 2% by weight, based on the total weight of the composition; c) optionally additives and d) a diamide insecticide.

In some embodiments, the aqueous pesticidal suspension composition comprising a) emamectin or salt thereof at about 1% to of about 20% by weight, based on the total weight of the composition; b) at least one polycationic type rheology modifier comprises monomers with ammonium moiety at about 1.1% to of about 1.7% by weight, based on the total weight of the composition; c) optionally additives and d) a diamide insecticide.

In some embodiments, the aqueous pesticidal suspension composition comprising a) emamectin or salt thereof at about 3% to of about 10% by weight, based on the total weight of the composition; b) at least one polycationic type rheology modifier comprises monomers with ammonium moiety at about 1.1% to of about 1.7% by weight, based on the total weight of the composition; c) optionally additives and d) a diamide insecticide.

In some embodiments, the aqueous pesticidal suspension composition comprising a) emamectin or salt thereof at about 5% to of about 8% by weight, based on the total weight of the composition; b) at least one polycationic type rheology modifier comprises monomers with ammonium moiety at about 1.1% to of about 1.7% by weight, based on the total weight of the composition; c) optionally additives and d) a diamide insecticide.

In some embodiments, the aqueous pesticidal suspension composition comprising a) emamectin or salt thereof at about 7.5% by weight, based on the total weight of the composition; b) at least one polycationic type rheology modifier comprises monomers with ammonium moiety at about 1.1% to of about 1.7% by weight, based on the total weight of the composition; c) optionally additives and d) a diamide insecticide.

In some embodiments, the aqueous pesticidal suspension composition comprising a) emamectin or salt thereof at about 1% to of about 20% by weight, based on the total weight of the composition; b) at least one polycationic type rheology modifier comprises monomers with ammonium moiety at about 1.2% by weight, based on the total weight of the composition; c) optionally additives and d) a diamide insecticide.

In some embodiments, the aqueous pesticidal suspension composition comprising a) emamectin or salt thereof at about 3% to of about 10% by weight, based on the total weight of the composition; b) at least one polycationic type rheology modifier comprises monomers with ammonium moiety at about 1.2% by weight, based on the total weight of the composition; c) optionally additives and d) a diamide insecticide.

In some embodiments, the aqueous pesticidal suspension composition comprising a) emamectin or salt thereof at about 5% to of about 8% by weight, based on the total weight of the composition; b) at least one polycationic type rheology modifier comprises monomers with ammonium moiety at about 1.2% by weight, based on the total weight of the composition; c) optionally additives and d) a diamide insecticide.

In some embodiments, the aqueous pesticidal suspension composition comprising a) emamectin or salt thereof at about 7.5% by weight, based on the total weight of the composition; b) at least one polycationic type rheology modifier comprises monomers with ammonium moiety at about 1.2% by weight, based on the total weight of the composition; c) optionally additives and d) a diamide insecticide.

In some embodiments, the aqueous pesticidal suspension composition comprising a) emamectin or salt thereof at about 1% to of about 20% by weight, based on the total weight of the composition; b) at least one polycationic type rheology modifier comprises monomers with ammonium moiety is selected from polyquaterniums or polyquaternium esters polymers and combinations thereof at about 1% to of about 3% by weight, based on the total weight of the composition; c) optionally additives and d) a diamide insecticide.

In some embodiments, the aqueous pesticidal suspension composition comprising a) emamectin or salt thereof at about 3% to of about 10% by weight, based on the total weight of the composition; b) at least one polycationic type rheology modifier comprises monomers with ammonium moiety is selected from polyquaterniums or polyquaternium esters polymers and combinations thereof at about 1% to of about 3% by weight, based on the total weight of the composition; c) optionally additives and d) a diamide insecticide.

In some embodiments, the aqueous pesticidal suspension composition comprising a) emamectin or salt thereof at about 5% to of about 8% by weight, based on the total weight of the composition; b) at least one polycationic type rheology modifier comprises monomers with ammonium moiety is selected from polyquaterniums or polyquaternium esters polymers and combinations thereof at about 1% to of about 3% by weight, based on the total weight of the composition; c) optionally additives and d) a diamide insecticide.

In some embodiments, the aqueous pesticidal suspension composition comprising a) emamectin or salt thereof at about 7.5% by weight, based on the total weight of the composition; b) at least one polycationic type rheology modifier comprises monomers with ammonium moiety is selected from polyquaterniums or polyquaternium esters polymers and combinations thereof at about 1% to of about 3% by weight, based on the total weight of the composition; c) optionally additives and d) a diamide insecticide.

In some embodiments, the aqueous pesticidal suspension composition comprising a) emamectin or salt thereof at about 1% to of about 20% by weight, based on the total weight of the composition; b) at least one polycationic type rheology modifier comprises monomers with ammonium moiety is selected from polyquaterniums or polyquaternium esters polymers and combinations thereof at about 1% to of about 2% by weight, based on the total weight of the composition; c) optionally additives and d) a diamide insecticide.

In some embodiments, the aqueous pesticidal suspension composition comprising a) emamectin or salt thereof at about 3% to of about 10% by weight, based on the total weight of the composition; b) at least one polycationic type rheology modifier comprises monomers with ammonium moiety is selected from polyquaterniums or polyquaternium esters polymers and combinations thereof at about 1% to of about 2% by weight, based on the total weight of the composition; c) optionally additives and d) a diamide insecticide.

In some embodiments, the aqueous pesticidal suspension composition comprising a) emamectin or salt thereof at about 5% to of about 8% by weight, based on the total weight of the composition; b) at least one polycationic type rheology modifier comprises monomers with ammonium moiety is selected from polyquaterniums or polyquaternium esters polymers and combinations thereof at about 1% to of about 2% by weight, based on the total weight of the composition; c) optionally additives and d) a diamide insecticide.

In some embodiments, the aqueous pesticidal suspension composition comprising a) emamectin or salt thereof at about 7.5% by weight, based on the total weight of the composition; b) at least one polycationic type rheology modifier comprises monomers with ammonium moiety is selected from polyquaterniums or polyquaternium esters polymers and combinations thereof at about 1% to of about 2% by weight, based on the total weight of the composition; c) optionally additives and d) a diamide insecticide.

In some embodiments, the aqueous pesticidal suspension composition comprising a) emamectin or salt thereof at about 1% to of about 20% by weight, based on the total weight of the composition; b) at least one polycationic type rheology modifier comprises monomers with ammonium moiety is selected from polyquaterniums or polyquaternium esters polymers and combinations thereof at about 1.1% to of about 1.7% by weight, based on the total weight of the composition; c) optionally additives and d) a diamide insecticide.

In some embodiments, the aqueous pesticidal suspension composition comprising a) emamectin or salt thereof at about 3% to of about 10% by weight, based on the total weight of the composition; b) at least one polycationic type rheology modifier comprises monomers with ammonium moiety is selected from polyquaterniums or polyquaternium esters polymers and combinations thereof at about 1.1% to of about 1.7% by weight, based on the total weight of the composition; c) optionally additives and d) a diamide insecticide.

In some embodiments, the aqueous pesticidal suspension composition comprising a) emamectin or salt thereof at about 5% to of about 8% by weight, based on the total weight of the composition; b) at least one polycationic type rheology modifier comprises monomers with ammonium moiety is selected from polyquaterniums or polyquaternium esters polymers and combinations thereof at about 1.1% to of about 1.7% by weight, based on the total weight of the composition; c) optionally additives and d) a diamide insecticide.

In some embodiments, the aqueous pesticidal suspension composition comprising a) emamectin or salt thereof at about 7.5% by weight, based on the total weight of the composition; b) at least one polycationic type rheology modifier comprises monomers with ammonium moiety is selected from polyquaterniums or polyquaternium esters polymers and combinations thereof at about 1.1% to of about 1.7% by weight, based on the total weight of the composition; c) optionally additives and d) a diamide insecticide.

In some embodiments, the aqueous pesticidal suspension composition comprising a) emamectin or salt thereof at about 1% to of about 20% by weight, based on the total weight of the composition; b) at least one polycationic type rheology modifier comprises monomers with ammonium moiety is selected from polyquaterniums or polyquaternium esters polymers and combinations thereof at about 1.2% by weight, based on the total weight of the composition; c) optionally additives and d) a diamide insecticide.

In some embodiments, the aqueous pesticidal suspension composition comprising a) emamectin or salt thereof at about 3% to of about 10% by weight, based on the total weight of the composition; b) at least one polycationic type rheology modifier comprises monomers with ammonium moiety is selected from polyquaterniums or polyquaternium esters polymers and combinations thereof at about 1.2% by weight, based on the total weight of the composition; c) optionally additives and d) a diamide insecticide.

In some embodiments, the aqueous pesticidal suspension composition comprising a) emamectin or salt thereof at about 5% to of about 8% by weight, based on the total weight of the composition; b) at least one polycationic type rheology modifier comprises monomers with ammonium moiety is selected from polyquaterniums or polyquaternium esters polymers and combinations thereof at about 1.2% by weight, based on the total weight of the composition; c) optionally additives and d) a diamide insecticide.

In some embodiments, the aqueous pesticidal suspension composition comprising a) emamectin or salt thereof at about 7.5% by weight, based on the total weight of the composition; b) at least one polycationic type rheology modifier comprises monomers with ammonium moiety is selected from polyquaterniums or polyquaternium esters polymers and combinations thereof at about 1.2% by weight, based on the total weight of the composition; c) optionally additives and d) a diamide insecticide.

In some embodiments, the aqueous pesticidal suspension composition comprising a) emamectin or salt thereof at about 1% to of about 20% by weight, based on the total weight of the composition; b) at least one polycationic type rheology modifier comprises monomers with ammonium moiety is poly(2-methacryloxyethyltrimethylammonium chloride) at about 1% to of about 3% by weight, based on the total weight of the composition; c) optionally additives and d) a diamide insecticide.

In some embodiments, the aqueous pesticidal suspension composition comprising a) emamectin or salt thereof at about 3% to of about 10% by weight, based on the total weight of the composition; b) at least one polycationic type rheology modifier comprises monomers with ammonium moiety is poly(2-methacryloxyethyltrimethylammonium chloride) at about 1% to of about 3% by weight, based on the total weight of the composition; c) optionally additives and d) a diamide insecticide.

In some embodiments, the aqueous pesticidal suspension composition comprising a) emamectin or salt thereof at about 5% to of about 8% by weight, based on the total weight of the composition; b) at least one polycationic type rheology modifier comprises monomers with ammonium moiety is poly(2-methacryloxyethyltrimethylammonium chloride) at about 1% to of about 3% by weight, based on the total weight of the composition; c) optionally additives and d) a diamide insecticide.

In some embodiments, the aqueous pesticidal suspension composition comprising a) emamectin or salt thereof at about 7.5% by weight, based on the total weight of the composition; b) at least one polycationic type rheology modifier comprises monomers with ammonium moiety is poly(2-methacryloxyethyltrimethylammonium chloride) at about 1% to of about 3% by weight, based on the total weight of the composition; c) optionally additives and d) a diamide insecticide.

In some embodiments, the aqueous pesticidal suspension composition comprising a) emamectin or salt thereof at about 1% to of about 20% by weight, based on the total weight of the composition; b) at least one polycationic type rheology modifier comprises monomers with ammonium moiety is poly(2-methacryloxyethyltrimethylammonium chloride) at about 1% to of about 2% by weight, based on the total weight of the composition; c) optionally additives and d) a diamide insecticide.

In some embodiments, the aqueous pesticidal suspension composition comprising a) emamectin or salt thereof at about 3% to of about 10% by weight, based on the total weight of the composition; b) at least one polycationic type rheology modifier comprises monomers with ammonium moiety is poly(2-methacryloxyethyltrimethylammonium chloride) at about 1% to of about 2% by weight, based on the total weight of the composition; c) optionally additives and d) a diamide insecticide.

In some embodiments, the aqueous pesticidal suspension composition comprising a) emamectin or salt thereof at about 5% to of about 8% by weight, based on the total weight of the composition; b) at least one polycationic type rheology modifier comprises monomers with ammonium moiety is poly(2-methacryloxyethyltrimethylammonium chloride) at about 1% to of about 2% by weight, based on the total weight of the composition; c) optionally additives and d) a diamide insecticide.

In some embodiments, the aqueous pesticidal suspension composition comprising a) emamectin or salt thereof at about 7.5% by weight, based on the total weight of the composition; b) at least one polycationic type rheology modifier comprises monomers with ammonium moiety is poly(2-methacryloxyethyltrimethylammonium chloride) at about 1% to of about 2% by weight, based on the total weight of the composition; c) optionally additives and d) a diamide insecticide.

In some embodiments, the aqueous pesticidal suspension composition comprising a) emamectin or salt thereof at about 1% to of about 20% by weight, based on the total weight of the composition; b) at least one polycationic type rheology modifier comprises monomers with ammonium moiety is poly(2-methacryloxyethyltrimethylammonium chloride) at about 1.1% to of about 1.7% by weight, based on the total weight of the composition; c) optionally additives and d) a diamide insecticide.

In some embodiments, the aqueous pesticidal suspension composition comprising a) emamectin or salt thereof at about 3% to of about 10% by weight, based on the total weight of the composition; b) at least one polycationic type rheology modifier comprises monomers with ammonium moiety is poly(2-methacryloxyethyltrimethylammonium chloride) at about 1.1% to of about 1.7% by weight, based on the total weight of the composition; c) optionally additives and d) a diamide insecticide.

In some embodiments, the aqueous pesticidal suspension composition comprising a) emamectin or salt thereof at about 5% to of about 8% by weight, based on the total weight of the composition; b) at least one polycationic type rheology modifier comprises monomers with ammonium moiety is poly(2-methacryloxyethyltrimethylammonium chloride) at about 1.1% to of about 1.7% by weight, based on the total weight of the composition; c) optionally additives and d) a diamide insecticide.

In some embodiments, the aqueous pesticidal suspension composition comprising a) emamectin or salt thereof at about 7.5% by weight, based on the total weight of the composition; b) at least one polycationic type rheology modifier comprises monomers with ammonium moiety is poly(2-methacryloxyethyltrimethylammonium chloride) at about 1.1% to of about 1.7% by weight, based on the total weight of the composition; c) optionally additives and d) a diamide insecticide.

In some embodiments, the aqueous pesticidal suspension composition comprising a) emamectin or salt thereof at about 1% to of about 20% by weight, based on the total weight of the composition; b) at least one polycationic type rheology modifier comprises monomers with ammonium moiety is poly(2-methacryloxyethyltrimethylammonium chloride) at about 1.2% by weight, based on the total weight of the composition; c) optionally additives and d) a diamide insecticide.

In some embodiments, the aqueous pesticidal suspension composition comprising a) emamectin or salt thereof at about 3% to of about 10% by weight, based on the total weight of the composition; b) at least one polycationic type rheology modifier comprises monomers with ammonium moiety is poly(2-methacryloxyethyltrimethylammonium chloride) at about 1.2% by weight, based on the total weight of the composition; c) optionally additives and d) a diamide insecticide.

In some embodiments, the aqueous pesticidal suspension composition comprising a) emamectin or salt thereof at about 5% to of about 8% by weight, based on the total weight of the composition; b) at least one polycationic type rheology modifier comprises monomers with ammonium moiety is poly(2-methacryloxyethyltrimethylammonium chloride) at about 1.2% by weight, based on the total weight of the composition; c) optionally additives and d) a diamide insecticide.

In some embodiments, the aqueous pesticidal suspension composition comprising a) emamectin or salt thereof at about 7.5% by weight, based on the total weight of the composition; b) at least one polycationic type rheology modifier comprises monomers with ammonium moiety is poly(2-methacryloxyethyltrimethylammonium chloride) at about 1.2% by weight, based on the total weight of the composition; c) optionally additives and d) a diamide insecticide.

In some embodiments, the aqueous pesticidal suspension composition comprising a) emamectin or salt thereof at about 1% to of about 20% by weight, based on the total weight of the composition; b) at least one polycationic rheology modifier at about 1% to of about 3% by weight, based on the total weight of the composition; c) optionally additives and d) chlorantraniliprole.

In some embodiments, the aqueous pesticidal suspension composition comprising a) emamectin or salt thereof at about 3% to of about 10% by weight, based on the total weight of the composition; b) at least one polycationic rheology modifier at about 1% to of about 3% by weight, based on the total weight of the composition; c) optionally additives and d) chlorantraniliprole.

In some embodiments, the aqueous pesticidal suspension composition comprising a) emamectin or salt thereof at about 5% to of about 8% by weight, based on the total weight of the composition; b) at least one polycationic rheology modifier at about 1% to of about 3% by weight, based on the total weight of the composition; c) optionally additives and d) chlorantraniliprole.

In some embodiments, the aqueous pesticidal suspension composition comprising a) emamectin or salt thereof at about 7.5% by weight, based on the total weight of the composition; b) at least one polycationic rheology modifier at about 1% to of about 3% by weight, based on the total weight of the composition; c) optionally additives and d) chlorantraniliprole.

In some embodiments, the aqueous pesticidal suspension composition comprising a) emamectin or salt thereof at about 1% to of about 20% by weight, based on the total weight of the composition; b) at least one polycationic rheology modifier at about 1% to of about 2% by weight, based on the total weight of the composition; c) optionally additives and d) chlorantraniliprole.

In some embodiments, the aqueous pesticidal suspension composition comprising a) emamectin or salt thereof at about 3% to of about 10% by weight, based on the total weight of the composition; b) at least one polycationic rheology modifier at about 1% to of about 2% by weight, based on the total weight of the composition; c) optionally additives and d) chlorantraniliprole.

In some embodiments, the aqueous pesticidal suspension composition comprising a) emamectin or salt thereof at about 5% to of about 8% by weight, based on the total weight of the composition; b) at least one polycationic rheology modifier at about 1% to of about 2% by weight, based on the total weight of the composition; c) optionally additives and d) chlorantraniliprole.

In some embodiments, the aqueous pesticidal suspension composition comprising a) emamectin or salt thereof at about 7.5% by weight, based on the total weight of the composition; b) at least one polycationic rheology modifier at about 1% to of about 2% by weight, based on the total weight of the composition; c) optionally additives and d) chlorantraniliprole.

In some embodiments, the aqueous pesticidal suspension composition comprising a) emamectin or salt thereof at about 1% to of about 20% by weight, based on the total weight of the composition; b) at least one polycationic rheology modifier at about 1.1% to of about 1.7% by weight, based on the total weight of the composition; c) optionally additives and d) chlorantraniliprole.

In some embodiments, the aqueous pesticidal suspension composition comprising a) emamectin or salt thereof at about 3% to of about 10% by weight, based on the total weight of the composition; b) at least one polycationic rheology modifier at about 1.1% to of about 1.7% by weight, based on the total weight of the composition; c) optionally additives and d) chlorantraniliprole.

In some embodiments, the aqueous pesticidal suspension composition comprising a) emamectin or salt thereof at about 5% to of about 8% by weight, based on the total weight of the composition; b) at least one polycationic rheology modifier at about 1.1% to of about 1.7% by weight, based on the total weight of the composition; c) optionally additives and d) chlorantraniliprole.

In some embodiments, the aqueous pesticidal suspension composition comprising a) emamectin or salt thereof at about 7.5% by weight, based on the total weight of the composition; b) at least one polycationic rheology modifier at about 1.1% to of about 1.7% by weight, based on the total weight of the composition; c) optionally additives and d) chlorantraniliprole.

In some embodiments, the aqueous pesticidal suspension composition comprising a) emamectin or salt thereof at about 1% to of about 20% by weight, based on the total weight of the composition; b) at least one polycationic rheology modifier at about 1.2% by weight, based on the total weight of the composition; c) optionally additives and d) chlorantraniliprole.

In some embodiments, the aqueous pesticidal suspension composition comprising a) emamectin or salt thereof at about 3% to of about 10% by weight, based on the total weight of the composition; b) at least one polycationic rheology modifier at about 1.2% by weight, based on the total weight of the composition; c) optionally additives and d) chlorantraniliprole.

In some embodiments, the aqueous pesticidal suspension composition comprising a) emamectin or salt thereof at about 5% to of about 8% by weight, based on the total weight of the composition; b) at least one polycationic rheology modifier at about 1.2% by weight, based on the total weight of the composition; c) optionally additives and d) chlorantraniliprole.

In some embodiments, the aqueous pesticidal suspension composition comprising a) emamectin or salt thereof at about 7.5% by weight, based on the total weight of the composition; b) at least one polycationic rheology modifier at about 1.2% by weight, based on the total weight of the composition; c) optionally additives and d) chlorantraniliprole.

In some embodiments, the aqueous pesticidal suspension composition comprising a) emamectin or salt thereof at about 1% to of about 20% by weight, based on the total weight of the composition; b) at least one polycationic type rheology modifier comprises monomers with ammonium, sulfonium or phosphonium moiety at about 1% to of about 3% by weight, based on the total weight of the composition; c) optionally additives and d) chlorantraniliprole.

In some embodiments, the aqueous pesticidal suspension composition comprising a) emamectin or salt thereof at about 3% to of about 10% by weight, based on the total weight of the composition; b) at least one polycationic type rheology modifier comprises monomers with ammonium, sulfonium or phosphonium moiety at about 1% to of about 3% by weight, based on the total weight of the composition; c) optionally additives and d) chlorantraniliprole.

In some embodiments, the aqueous pesticidal suspension composition comprising a) emamectin or salt thereof at about 5% to of about 8% by weight, based on the total weight of the composition; b) at least one polycationic type rheology modifier comprises monomers with ammonium, sulfonium or phosphonium moiety at about 1% to of about 3% by weight, based on the total weight of the composition; c) optionally additives and d) chlorantraniliprole.

In some embodiments, the aqueous pesticidal suspension composition comprising a) emamectin or salt thereof at about 7.5% by weight, based on the total weight of the composition; b) at least one polycationic type rheology modifier comprises monomers with ammonium, sulfonium or phosphonium moiety at about 1% to of about 3% by weight, based on the total weight of the composition; c) optionally additives and d) chlorantraniliprole.

In some embodiments, the aqueous pesticidal suspension composition comprising a) emamectin or salt thereof at about 1% to of about 20% by weight, based on the total weight of the composition; b) at least one polycationic type rheology modifier comprises monomers with ammonium, sulfonium or phosphonium moiety at about 1% to of about 2% by weight, based on the total weight of the composition; c) optionally additives and d) chlorantraniliprole.

In some embodiments, the aqueous pesticidal suspension composition comprising a) emamectin or salt thereof at about 3% to of about 10% by weight, based on the total weight of the composition; b) at least one polycationic type rheology modifier comprises monomers with ammonium, sulfonium or phosphonium moiety at about 1% to of about 2% by weight, based on the total weight of the composition; c) optionally additives and d) chlorantraniliprole.

In some embodiments, the aqueous pesticidal suspension composition comprising a) emamectin or salt thereof at about 5% to of about 8% by weight, based on the total weight of the composition; b) at least one polycationic type rheology modifier comprises monomers with ammonium, sulfonium or phosphonium moiety at about 1% to of about 2% by weight, based on the total weight of the composition; c) optionally additives and d) chlorantraniliprole.

In some embodiments, the aqueous pesticidal suspension composition comprising a) emamectin or salt thereof at about 7.5% by weight, based on the total weight of the composition; b) at least one polycationic type rheology modifier comprises monomers with ammonium, sulfonium or phosphonium moiety at about 1% to of about 2% by weight, based on the total weight of the composition; c) optionally additives and d) chlorantraniliprole.

In some embodiments, the aqueous pesticidal suspension composition comprising a) emamectin or salt thereof at about 1% to of about 20% by weight, based on the total weight of the composition; b) at least one polycationic type rheology modifier comprises monomers with ammonium, sulfonium or phosphonium moiety at about 1.1% to of about 1.7% by weight, based on the total weight of the composition; c) optionally additives and d) chlorantraniliprole.

In some embodiments, the aqueous pesticidal suspension composition comprising a) emamectin or salt thereof at about 3% to of about 10% by weight, based on the total weight of the composition; b) at least one polycationic type rheology modifier comprises monomers with ammonium, sulfonium or phosphonium moiety at about 1.1% to of about 1.7% by weight, based on the total weight of the composition; c) optionally additives and d) chlorantraniliprole.

In some embodiments, the aqueous pesticidal suspension composition comprising a) emamectin or salt thereof at about 5% to of about 8% by weight, based on the total weight of the composition; b) at least one polycationic type rheology modifier comprises monomers with ammonium, sulfonium or phosphonium moiety at about 1.1% to of about 1.7% by weight, based on the total weight of the composition; c) optionally additives and d) chlorantraniliprole.

In some embodiments, the aqueous pesticidal suspension composition comprising a) emamectin or salt thereof at about 7.5% by weight, based on the total weight of the composition; b) at least one polycationic type rheology modifier comprises monomers with ammonium, sulfonium or phosphonium moiety at about 1.1% to of about 1.7% by weight, based on the total weight of the composition; c) optionally additives and d) chlorantraniliprole.

In some embodiments, the aqueous pesticidal suspension composition comprising a) emamectin or salt thereof at about 1% to of about 20% by weight, based on the total weight of the composition; b) at least one polycationic type rheology modifier comprises monomers with ammonium, sulfonium or phosphonium moiety at about 1.2% by weight, based on the total weight of the composition; c) optionally additives and d) chlorantraniliprole.

In some embodiments, the aqueous pesticidal suspension composition comprising a) emamectin or salt thereof at about 3% to of about 10% by weight, based on the total weight of the composition; b) at least one polycationic type rheology modifier comprises monomers with ammonium, sulfonium or phosphonium moiety at about 1.2% by weight, based on the total weight of the composition; c) optionally additives and d) chlorantraniliprole.

In some embodiments, the aqueous pesticidal suspension composition comprising a) emamectin or salt thereof at about 5% to of about 8% by weight, based on the total weight of the composition; b) at least one polycationic type rheology modifier comprises monomers with ammonium, sulfonium or phosphonium moiety at about 1.2% by weight, based on the total weight of the composition; c) optionally additives and d) chlorantraniliprole.

In some embodiments, the aqueous pesticidal suspension composition comprising a) emamectin or salt thereof at about 7.5% by weight, based on the total weight of the composition; b) at least one polycationic type rheology modifier comprises monomers with ammonium, sulfonium or phosphonium moiety at about 1.2% by weight, based on the total weight of the composition; c) optionally additives and d) chlorantraniliprole.

In some embodiments, the aqueous pesticidal suspension composition comprising a) emamectin or salt thereof at about 1% to of about 20% by weight, based on the total weight of the composition; b) at least one polycationic type rheology modifier comprises monomers with ammonium moiety at about 1% to of about 3% by weight, based on the total weight of the composition; c) optionally additives and d) chlorantraniliprole.

In some embodiments, the aqueous pesticidal suspension composition comprising a) emamectin or salt thereof at about 3% to of about 10% by weight, based on the total weight of the composition; b) at least one polycationic type rheology modifier comprises monomers with ammonium moiety at about 1% to of about 3% by weight, based on the total weight of the composition; c) optionally additives and d) chlorantraniliprole.

In some embodiments, the aqueous pesticidal suspension composition comprising a) emamectin or salt thereof at about 5% to of about 8% by weight, based on the total weight of the composition; b) at least one polycationic type rheology modifier comprises monomers with ammonium moiety at about 1% to of about 3% by weight, based on the total weight of the composition; c) optionally additives and d) chlorantraniliprole.

In some embodiments, the aqueous pesticidal suspension composition comprising a) emamectin or salt thereof at about 7.5% by weight, based on the total weight of the composition; b) at least one polycationic type rheology modifier comprises monomers with ammonium moiety at about 1% to of about 3% by weight, based on the total weight of the composition; c) optionally additives and d) chlorantraniliprole.

In some embodiments, the aqueous pesticidal suspension composition comprising a) emamectin or salt thereof at about 1% to of about 20% by weight, based on the total weight of the composition; b) at least one polycationic type rheology modifier comprises monomers with ammonium moiety at about 1% to of about 2% by weight, based on the total weight of the composition; c) optionally additives and d) chlorantraniliprole.

In some embodiments, the aqueous pesticidal suspension composition comprising a) emamectin or salt thereof at about 3% to of about 10% by weight, based on the total weight of the composition; b) at least one polycationic type rheology modifier comprises monomers with ammonium moiety at about 1% to of about 2% by weight, based on the total weight of the composition; c) optionally additives and d) chlorantraniliprole.

In some embodiments, the aqueous pesticidal suspension composition comprising a) emamectin or salt thereof at about 5% to of about 8% by weight, based on the total weight of the composition; b) at least one polycationic type rheology modifier comprises monomers with ammonium moiety at about 1% to of about 2% by weight, based on the total weight of the composition; c) optionally additives and d) chlorantraniliprole.

In some embodiments, the aqueous pesticidal suspension composition comprising a) emamectin or salt thereof at about 7.5% by weight, based on the total weight of the composition; b) at least one polycationic type rheology modifier comprises monomers with ammonium moiety at about 1% to of about 2% by weight, based on the total weight of the composition; c) optionally additives and d) chlorantraniliprole.

In some embodiments, the aqueous pesticidal suspension composition comprising a) emamectin or salt thereof at about 1% to of about 20% by weight, based on the total weight of the composition; b) at least one polycationic type rheology modifier comprises monomers with ammonium moiety at about 1.1% to of about 1.7% by weight, based on the total weight of the composition; c) optionally additives and d) chlorantraniliprole.

In some embodiments, the aqueous pesticidal suspension composition comprising a) emamectin or salt thereof at about 3% to of about 10% by weight, based on the total weight of the composition; b) at least one polycationic type rheology modifier comprises monomers with ammonium moiety at about 1.1% to of about 1.7% by weight, based on the total weight of the composition; c) optionally additives and d) chlorantraniliprole.

In some embodiments, the aqueous pesticidal suspension composition comprising a) emamectin or salt thereof at about 5% to of about 8% by weight, based on the total weight of the composition; b) at least one polycationic type rheology modifier comprises monomers with ammonium moiety at about 1.1% to of about 1.7% by weight, based on the total weight of the composition; c) optionally additives and d) chlorantraniliprole.

In some embodiments, the aqueous pesticidal suspension composition comprising a) emamectin or salt thereof at about 7.5% by weight, based on the total weight of the composition; b) at least one polycationic type rheology modifier comprises monomers with ammonium moiety at about 1.1% to of about 1.7% by weight, based on the total weight of the composition; c) optionally additives and d) chlorantraniliprole.

In some embodiments, the aqueous pesticidal suspension composition comprising a) emamectin or salt thereof at about 1% to of about 20% by weight, based on the total weight of the composition; b) at least one polycationic type rheology modifier comprises monomers with ammonium moiety at about 1.2% by weight, based on the total weight of the composition; c) optionally additives and d) chlorantraniliprole.

In some embodiments, the aqueous pesticidal suspension composition comprising a) emamectin or salt thereof at about 3% to of about 10% by weight, based on the total weight of the composition; b) at least one polycationic type rheology modifier comprises monomers with ammonium moiety at about 1.2% by weight, based on the total weight of the composition; c) optionally additives and d) chlorantraniliprole.

In some embodiments, the aqueous pesticidal suspension composition comprising a) emamectin or salt thereof at about 5% to of about 8% by weight, based on the total weight of the composition; b) at least one polycationic type rheology modifier comprises monomers with ammonium moiety at about 1.2% by weight, based on the total weight of the composition; c) optionally additives and d) chlorantraniliprole.

In some embodiments, the aqueous pesticidal suspension composition comprising a) emamectin or salt thereof at about 7.5% by weight, based on the total weight of the composition; b) at least one polycationic type rheology modifier comprises monomers with ammonium moiety at about 1.2% by weight, based on the total weight of the composition; c) optionally additives and d) chlorantraniliprole.

In some embodiments, the aqueous pesticidal suspension composition comprising a) emamectin or salt thereof at about 1% to of about 20% by weight, based on the total weight of the composition; b) at least one polycationic type rheology modifier comprises monomers with ammonium moiety is selected from polyquaterniums or polyquaternium esters polymers and combinations thereof at about 1% to of about 3% by weight, based on the total weight of the composition; c) optionally additives and d) chlorantraniliprole.

In some embodiments, the aqueous pesticidal suspension composition comprising a) emamectin or salt thereof at about 3% to of about 10% by weight, based on the total weight of the composition; b) at least one polycationic type rheology modifier comprises monomers with ammonium moiety is selected from polyquaterniums or polyquaternium esters polymers and combinations thereof at about 1% to of about 3% by weight, based on the total weight of the composition; c) optionally additives and d) chlorantraniliprole.

In some embodiments, the aqueous pesticidal suspension composition comprising a) emamectin or salt thereof at about 5% to of about 8% by weight, based on the total weight of the composition; b) at least one polycationic type rheology modifier comprises monomers with ammonium moiety is selected from polyquaterniums or polyquaternium esters polymers and combinations thereof at about 1% to of about 3% by weight, based on the total weight of the composition; c) optionally additives and d) chlorantraniliprole.

In some embodiments, the aqueous pesticidal suspension composition comprising a) emamectin or salt thereof at about 7.5% by weight, based on the total weight of the composition; b) at least one polycationic type rheology modifier comprises monomers with ammonium moiety is selected from polyquaterniums or polyquaternium esters polymers and combinations thereof at about 1% to of about 3% by weight, based on the total weight of the composition; c) optionally additives and d) chlorantraniliprole.

In some embodiments, the aqueous pesticidal suspension composition comprising a) emamectin or salt thereof at about 1% to of about 20% by weight, based on the total weight of the composition; b) at least one polycationic type rheology modifier comprises monomers with ammonium moiety is selected from polyquaterniums or polyquaternium esters polymers and combinations thereof at about 1% to of about 2% by weight, based on the total weight of the composition; c) optionally additives and d) chlorantraniliprole.

In some embodiments, the aqueous pesticidal suspension composition comprising a) emamectin or salt thereof at about 3% to of about 10% by weight, based on the total weight of the composition; b) at least one polycationic type rheology modifier comprises monomers with ammonium moiety is selected from polyquaterniums or polyquaternium esters polymers and combinations thereof at about 1% to of about 2% by weight, based on the total weight of the composition; c) optionally additives and d) chlorantraniliprole.

In some embodiments, the aqueous pesticidal suspension composition comprising a) emamectin or salt thereof at about 5% to of about 8% by weight, based on the total weight of the composition; b) at least one polycationic type rheology modifier comprises monomers with ammonium moiety is selected from polyquaterniums or polyquaternium esters polymers and combinations thereof at about 1% to of about 2% by weight, based on the total weight of the composition; c) optionally additives and d) chlorantraniliprole.

In some embodiments, the aqueous pesticidal suspension composition comprising a) emamectin or salt thereof at about 7.5% by weight, based on the total weight of the composition; b) at least one polycationic type rheology modifier comprises monomers with ammonium moiety is selected from polyquaterniums or polyquaternium esters polymers and combinations thereof at about 1% to of about 2% by weight, based on the total weight of the composition; c) optionally additives and d) chlorantraniliprole.

In some embodiments, the aqueous pesticidal suspension composition comprising a) emamectin or salt thereof at about 1% to of about 20% by weight, based on the total weight of the composition; b) at least one polycationic type rheology modifier comprises monomers with ammonium moiety is selected from polyquaterniums or polyquaternium esters polymers and combinations thereof at about 1.1% to of about 1.7% by weight, based on the total weight of the composition; c) optionally additives and d) chlorantraniliprole.

In some embodiments, the aqueous pesticidal suspension composition comprising a) emamectin or salt thereof at about 3% to of about 10% by weight, based on the total weight of the composition; b) at least one polycationic type rheology modifier comprises monomers with ammonium moiety is selected from polyquaterniums or polyquaternium esters polymers and combinations thereof at about 1.1% to of about 1.7% by weight, based on the total weight of the composition; c) optionally additives and d) chlorantraniliprole.

In some embodiments, the aqueous pesticidal suspension composition comprising a) emamectin or salt thereof at about 5% to of about 8% by weight, based on the total weight of the composition; b) at least one polycationic type rheology modifier comprises monomers with ammonium moiety is selected from polyquaterniums or polyquaternium esters polymers and combinations thereof at about 1.1% to of about 1.7% by weight, based on the total weight of the composition; c) optionally additives and d) chlorantraniliprole.

In some embodiments, the aqueous pesticidal suspension composition comprising a) emamectin or salt thereof at about 7.5% by weight, based on the total weight of the composition; b) at least one polycationic type rheology modifier comprises monomers with ammonium moiety is selected from polyquaterniums or polyquaternium esters polymers and combinations thereof at about 1.1% to of about 1.7% by weight, based on the total weight of the composition; c) optionally additives and d) chlorantraniliprole.

In some embodiments, the aqueous pesticidal suspension composition comprising a) emamectin or salt thereof at about 1% to of about 20% by weight, based on the total weight of the composition; b) at least one polycationic type rheology modifier comprises monomers with ammonium moiety is selected from polyquaterniums or polyquaternium esters polymers and combinations thereof at about 1.2% by weight, based on the total weight of the composition; c) optionally additives and d) chlorantraniliprole.

In some embodiments, the aqueous pesticidal suspension composition comprising a) emamectin or salt thereof at about 3% to of about 10% by weight, based on the total weight of the composition; b) at least one polycationic type rheology modifier comprises monomers with ammonium moiety is selected from polyquaterniums or polyquaternium esters polymers and combinations thereof at about 1.2% by weight, based on the total weight of the composition; c) optionally additives and d) chlorantraniliprole.

In some embodiments, the aqueous pesticidal suspension composition comprising a) emamectin or salt thereof at about 5% to of about 8% by weight, based on the total weight of the composition; b) at least one polycationic type rheology modifier comprises monomers with ammonium moiety is selected from polyquaterniums or polyquaternium esters polymers and combinations thereof at about 1.2% by weight, based on the total weight of the composition; c) optionally additives and d) chlorantraniliprole.

In some embodiments, the aqueous pesticidal suspension composition comprising a) emamectin or salt thereof at about 7.5% by weight, based on the total weight of the composition; b) at least one polycationic type rheology modifier comprises monomers with ammonium moiety is selected from polyquaterniums or polyquaternium esters polymers and combinations thereof at about 1.2% by weight, based on the total weight of the composition; c) optionally additives and d) chlorantraniliprole.

In some embodiments, the aqueous pesticidal suspension composition comprising a) emamectin or salt thereof at about 1% to of about 20% by weight, based on the total weight of the composition; b) at least one polycationic type rheology modifier comprises monomers with ammonium moiety is poly(2-methacryloxyethyltrimethylammonium chloride) at about 1% to of about 3% by weight, based on the total weight of the composition; c) optionally additives and d) chlorantraniliprole.

In some embodiments, the aqueous pesticidal suspension composition comprising a) emamectin or salt thereof at about 3% to of about 10% by weight, based on the total weight of the composition; b) at least one polycationic type rheology modifier comprises monomers with ammonium moiety is poly(2-methacryloxyethyltrimethylammonium chloride) at about 1% to of about 3% by weight, based on the total weight of the composition; c) optionally additives and d) chlorantraniliprole.

In some embodiments, the aqueous pesticidal suspension composition comprising a) emamectin or salt thereof at about 5% to of about 8% by weight, based on the total weight of the composition; b) at least one polycationic type rheology modifier comprises monomers with ammonium moiety is poly(2-methacryloxyethyltrimethylammonium chloride) at about 1% to of about 3% by weight, based on the total weight of the composition; c) optionally additives and d) chlorantraniliprole.

In some embodiments, the aqueous pesticidal suspension composition comprising a) emamectin or salt thereof at about 7.5% by weight, based on the total weight of the composition; b) at least one polycationic type rheology modifier comprises monomers with ammonium moiety is poly(2-methacryloxyethyltrimethylammonium chloride) at about 1% to of about 3% by weight, based on the total weight of the composition; c) optionally additives and d) chlorantraniliprole.

In some embodiments, the aqueous pesticidal suspension composition comprising a) emamectin or salt thereof at about 1% to of about 20% by weight, based on the total weight of the composition; b) at least one polycationic type rheology modifier comprises monomers with ammonium moiety is poly(2-methacryloxyethyltrimethylammonium chloride) at about 1% to of about 2% by weight, based on the total weight of the composition; c) optionally additives and d) chlorantraniliprole.

In some embodiments, the aqueous pesticidal suspension composition comprising a) emamectin or salt thereof at about 3% to of about 10% by weight, based on the total weight of the composition; b) at least one polycationic type rheology modifier comprises monomers with ammonium moiety is poly(2-methacryloxyethyltrimethylammonium chloride) at about 1% to of about 2% by weight, based on the total weight of the composition; c) optionally additives and d) chlorantraniliprole.

In some embodiments, the aqueous pesticidal suspension composition comprising a) emamectin or salt thereof at about 5% to of about 8% by weight, based on the total weight of the composition; b) at least one polycationic type rheology modifier comprises monomers with ammonium moiety is poly(2-methacryloxyethyltrimethylammonium chloride) at about 1% to of about 2% by weight, based on the total weight of the composition; c) optionally additives and d) chlorantraniliprole.

In some embodiments, the aqueous pesticidal suspension composition comprising a) emamectin or salt thereof at about 7.5% by weight, based on the total weight of the composition; b) at least one polycationic type rheology modifier comprises monomers with ammonium moiety is poly(2-methacryloxyethyltrimethylammonium chloride) at about 1% to of about 2% by weight, based on the total weight of the composition; c) optionally additives and d) chlorantraniliprole.

In some embodiments, the aqueous pesticidal suspension composition comprising a) emamectin or salt thereof at about 1% to of about 20% by weight, based on the total weight of the composition; b) at least one polycationic type rheology modifier comprises monomers with ammonium moiety is poly(2-methacryloxyethyltrimethylammonium chloride) at about 1.1% to of about 1.7% by weight, based on the total weight of the composition; c) optionally additives and d) chlorantraniliprole.

In some embodiments, the aqueous pesticidal suspension composition comprising a) emamectin or salt thereof at about 3% to of about 10% by weight, based on the total weight of the composition; b) at least one polycationic type rheology modifier comprises monomers with ammonium moiety is poly(2-methacryloxyethyltrimethylammonium chloride) at about 1.1% to of about 1.7% by weight, based on the total weight of the composition; c) optionally additives and d) chlorantraniliprole.

In some embodiments, the aqueous pesticidal suspension composition comprising a) emamectin or salt thereof at about 5% to of about 8% by weight, based on the total weight of the composition; b) at least one polycationic type rheology modifier comprises monomers with ammonium moiety is poly(2-methacryloxyethyltrimethylammonium chloride) at about 1.1% to of about 1.7% by weight, based on the total weight of the composition; c) optionally additives and d) chlorantraniliprole.

In some embodiments, the aqueous pesticidal suspension composition comprising a) emamectin or salt thereof at about 7.5% by weight, based on the total weight of the composition; b) at least one polycationic type rheology modifier comprises monomers with ammonium moiety is poly(2-methacryloxyethyltrimethylammonium chloride) at about 1.1% to of about 1.7% by weight, based on the total weight of the composition; c) optionally additives and d) chlorantraniliprole.

In some embodiments, the aqueous pesticidal suspension composition comprising a) emamectin or salt thereof at about 1% to of about 20% by weight, based on the total weight of the composition; b) at least one polycationic type rheology modifier comprises monomers with ammonium moiety is poly(2-methacryloxyethyltrimethylammonium chloride) at about 1.2% by weight, based on the total weight of the composition; c) optionally additives and d) chlorantraniliprole.

In some embodiments, the aqueous pesticidal suspension composition comprising a) emamectin or salt thereof at about 3% to of about 10% by weight, based on the total weight of the composition; b) at least one polycationic type rheology modifier comprises monomers with ammonium moiety is poly(2-methacryloxyethyltrimethylammonium chloride) at about 1.2% by weight, based on the total weight of the composition; c) optionally additives and d) chlorantraniliprole.

In some embodiments, the aqueous pesticidal suspension composition comprising a) emamectin or salt thereof at about 5% to of about 8% by weight, based on the total weight of the composition; b) at least one polycationic type rheology modifier comprises monomers with ammonium moiety is poly(2-methacryloxyethyltrimethylammonium chloride) at about 1.2% by weight, based on the total weight of the composition; c) optionally additives and d) chlorantraniliprole.

In some embodiments, the aqueous pesticidal suspension composition comprising a) emamectin or salt thereof at about 7.5% by weight, based on the total weight of the composition; b) at least one polycationic type rheology modifier comprises monomers with ammonium moiety is poly(2-methacryloxyethyltrimethylammonium chloride) at about 1.2% by weight, based on the total weight of the composition; c) optionally additives and d) chlorantraniliprole.

In some embodiments, the aqueous pesticidal suspension composition comprising a) emamectin or salt thereof at about 1% to of about 20% by weight, based on the total weight of the composition; b) at least one polycationic type rheology modifier at about 1.1% to of about 1.7% by weight, based on the total weight of the composition; c) optionally additives and d) chlorantraniliprole at about 1% to of about 60% by weight, based on the total weight of the composition.

In some embodiments, the aqueous pesticidal suspension composition comprising a) emamectin or salt thereof at about 1% to of about 20% by weight, based on the total weight of the composition; b) at least one polycationic type rheology modifier at about 1.1% to of about 1.7% by weight, based on the total weight of the composition; c) optionally additives and d) chlorantraniliprole at about 1% to of about 20% by weight, based on the total weight of the composition.

In some embodiments, the aqueous pesticidal suspension composition comprising a) emamectin or salt thereof at about 7.5% by weight, based on the total weight of the composition; b) at least one polycationic type rheology modifier at about 1.2% by weight, based on the total weight of the composition; c) optionally additives and d) chlorantraniliprole at about 15% by weight, based on the total weight of the composition.

In some embodiments, the aqueous pesticidal suspension composition comprising a) emamectin or salt thereof at about 1% to of about 20% by weight, based on the total weight of the composition; b) at least one polycationic type rheology modifier comprises monomers with ammonium, sulfonium or phosphonium moiety at about 1.1% to of about 1.7% by weight, based on the total weight of the composition; c) optionally additives and d) chlorantraniliprole at about 1% to of about 60% by weight, based on the total weight of the composition.

In some embodiments, the aqueous pesticidal suspension composition comprising a) emamectin or salt thereof at about 1% to of about 20% by weight, based on the total weight of the composition; b) at least one polycationic type rheology modifier comprises monomers with ammonium, sulfonium or phosphonium moiety at about 1.1% to of about 1.7% by weight, based on the total weight of the composition; c) optionally additives and d) chlorantraniliprole at about 1% to of about 20% by weight, based on the total weight of the composition.

In some embodiments, the aqueous pesticidal suspension composition comprising a) emamectin or salt thereof at about 7.5% by weight, based on the total weight of the composition; b) at least one polycationic type rheology modifier comprises monomers with ammonium, sulfonium or phosphonium moiety at about 1.2% by weight, based on the total weight of the composition; c) optionally additives and d) chlorantraniliprole at about 15% by weight, based on the total weight of the composition.

In some embodiments, the aqueous pesticidal suspension composition comprising a) emamectin or salt thereof at about 1% to of about 20% by weight, based on the total weight of the composition; b) at least one polycationic type rheology modifier comprises monomers with ammonium moiety at about 1.1% to of about 1.7% by weight, based on the total weight of the composition; c) optionally additives and d) chlorantraniliprole at about 1% to of about 60% by weight, based on the total weight of the composition.

In some embodiments, the aqueous pesticidal suspension composition comprising a) emamectin or salt thereof at about 1% to of about 20% by weight, based on the total weight of the composition; b) at least one polycationic type rheology modifier comprises monomers with ammonium moiety at about 1.1% to of about 1.7% by weight, based on the total weight of the composition; c) optionally additives and d) chlorantraniliprole at about 1% to of about 20% by weight, based on the total weight of the composition.

In some embodiments, the aqueous pesticidal suspension composition comprising a) emamectin or salt thereof at about 7.5% by weight, based on the total weight of the composition; b) at least one polycationic type rheology modifier comprises monomers with ammonium moiety at about 1.2% by weight, based on the total weight of the composition; c) optionally additives and d) chlorantraniliprole at about 15% by weight, based on the total weight of the composition.

In some embodiments, the aqueous pesticidal suspension composition comprising a) emamectin or salt thereof at about 1% to of about 20% by weight, based on the total weight of the composition; b) at least one polycationic type rheology modifier comprises monomers with ammonium moiety is selected from polyquaterniums or polyquaternium esters polymers and combinations thereof at about 1.1% to of about 1.7% by weight, based on the total weight of the composition; c) optionally additives and d) chlorantraniliprole at about 1% to of about 60% by weight, based on the total weight of the composition.

In some embodiments, the aqueous pesticidal suspension composition comprising a) emamectin or salt thereof at about 1% to of about 20% by weight, based on the total weight of the composition; b at least one polycationic type rheology modifier comprises monomers with ammonium moiety is selected from polyquaterniums or polyquaternium esters polymers and combinations thereof at about 1.1% to of about 1.7% by weight, based on the total weight of the composition; c) optionally additives and d) chlorantraniliprole at about 1% to of about 20% by weight, based on the total weight of the composition.

In some embodiments, the aqueous pesticidal suspension composition comprising a) emamectin or salt thereof at about 7.5% by weight, based on the total weight of the composition; b) at least one polycationic type rheology modifier comprises monomers with ammonium moiety is selected from polyquaterniums or polyquaternium esters polymers and combinations thereof at about 1.2% by weight, based on the total weight of the composition; c) optionally additives and d) chlorantraniliprole at about 15% by weight, based on the total weight of the composition.

In some embodiments, the aqueous pesticidal suspension composition comprising a) emamectin or salt thereof at about 1% to of about 20% by weight, based on the total weight of the composition; b) poly(2-methacryloxyethyltrimethylammonium chloride) at about 1.1% to of about 1.7% by weight, based on the total weight of the composition; c) optionally additives and d) chlorantraniliprole at about 1% to of about 60% by weight, based on the total weight of the composition.

In some embodiments, the aqueous pesticidal suspension composition comprising a) emamectin or salt thereof at about 1% to of about 20% by weight, based on the total weight of the composition; b) poly(2-methacryloxyethyltrimethylammonium chloride) at about 1.1% to of about 1.7% by weight, based on the total weight of the composition; c) optionally additives and d) chlorantraniliprole at about 1% to of about 20% by weight, based on the total weight of the composition.

In some embodiments, the aqueous pesticidal suspension composition comprising a) emamectin or salt thereof at about 7.5% by weight, based on the total weight of the composition; b) poly(2-methacryloxyethyltrimethylammonium chloride) at about 1.2% by weight, based on the total weight of the composition; c) optionally additives and d) chlorantraniliprole at about 15% by weight, based on the total weight of the composition.

In some embodiments, the aqueous pesticidal suspension composition comprising a) emamectin or salt thereof at about 1% to of about 20% by weight, based on the total weight of the composition; b) at least one polycationic rheology modifier at about 1% to of about 3% by weight, based on the total weight of the composition; c) optionally additives and d) cyantraniliprole.

In some embodiments, the aqueous pesticidal suspension composition comprising a) emamectin or salt thereof at about 3% to of about 10% by weight, based on the total weight of the composition; b) at least one polycationic rheology modifier at about 1% to of about 3% by weight, based on the total weight of the composition; c) optionally additives and d) cyantraniliprole.

In some embodiments, the aqueous pesticidal suspension composition comprising a) emamectin or salt thereof at about 5% to of about 8% by weight, based on the total weight of the composition; b) at least one polycationic rheology modifier at about 1% to of about 3% by weight, based on the total weight of the composition; c) optionally additives and d) cyantraniliprole.

In some embodiments, the aqueous pesticidal suspension composition comprising a) emamectin or salt thereof at about 7.5% by weight, based on the total weight of the composition; b) at least one polycationic rheology modifier at about 1% to of about 3% by weight, based on the total weight of the composition; c) optionally additives and d) cyantraniliprole.

In some embodiments, the aqueous pesticidal suspension composition comprising a) emamectin or salt thereof at about 1% to of about 20% by weight, based on the total weight of the composition; b) at least one polycationic rheology modifier at about 1% to of about 2% by weight, based on the total weight of the composition; c) optionally additives and d) cyantraniliprole.

In some embodiments, the aqueous pesticidal suspension composition comprising a) emamectin or salt thereof at about 3% to of about 10% by weight, based on the total weight of the composition; b) at least one polycationic rheology modifier at about 1% to of about 2% by weight, based on the total weight of the composition; c) optionally additives and d) cyantraniliprole.

In some embodiments, the aqueous pesticidal suspension composition comprising a) emamectin or salt thereof at about 5% to of about 8% by weight, based on the total weight of the composition; b) at least one polycationic rheology modifier at about 1% to of about 2% by weight, based on the total weight of the composition; c) optionally additives and d) cyantraniliprole.

In some embodiments, the aqueous pesticidal suspension composition comprising: a) emamectin or salt thereof at about 7.5% by weight, based on the total weight of the composition; b) at least one polycationic rheology modifier at about 1% to of about 2% by weight, based on the total weight of the composition; c) optionally additives and d) cyantraniliprole.

In some embodiments, the aqueous pesticidal suspension composition comprising a) emamectin or salt thereof at about 1% to of about 20% by weight, based on the total weight of the composition; b) at least one polycationic rheology modifier at about 1.1% to of about 1.7% by weight, based on the total weight of the composition; c) optionally additives and d) cyantraniliprole.

In some embodiments, the aqueous pesticidal suspension composition comprising a) emamectin or salt thereof at about 3% to of about 10% by weight, based on the total weight of the composition; b) at least one polycationic rheology modifier at about 1.1% to of about 1.7% by weight, based on the total weight of the composition; c) optionally additives and d) cyantraniliprole.

In some embodiments, the aqueous pesticidal suspension composition comprising a) emamectin or salt thereof at about 5% to of about 8% by weight, based on the total weight of the composition; b) at least one polycationic rheology modifier at about 1.1% to of about 1.7% by weight, based on the total weight of the composition; c) optionally additives and d) cyantraniliprole.

In some embodiments, the aqueous pesticidal suspension composition comprising a) emamectin or salt thereof at about 7.5% by weight, based on the total weight of the composition; b) at least one polycationic rheology modifier at about 1.1% to of about 1.7% by weight, based on the total weight of the composition; c) optionally additives and d) cyantraniliprole.

In some embodiments, the aqueous pesticidal suspension composition comprising a) emamectin or salt thereof at about 1% to of about 20% by weight, based on the total weight of the composition; b) at least one polycationic rheology modifier at about 1.2% by weight, based on the total weight of the composition; c) optionally additives and d) cyantraniliprole.

In some embodiments, the aqueous pesticidal suspension composition comprising a) emamectin or salt thereof at about 3% to of about 10% by weight, based on the total weight of the composition; b) at least one polycationic rheology modifier at about 1.2% by weight, based on the total weight of the composition; c) optionally additives and d) cyantraniliprole.

In some embodiments, the aqueous pesticidal suspension composition comprising a) emamectin or salt thereof at about 5% to of about 8% by weight, based on the total weight of the composition; b) at least one polycationic rheology modifier at about 1.2% by weight, based on the total weight of the composition; c) optionally additives and d) cyantraniliprole.

In some embodiments, the aqueous pesticidal suspension composition comprising a) emamectin or salt thereof at about 7.5% by weight, based on the total weight of the composition; b) at least one polycationic rheology modifier at about 1.2% by weight, based on the total weight of the composition; c) optionally additives and d) cyantraniliprole.

In some embodiments, the aqueous pesticidal suspension composition comprising a) emamectin or salt thereof at about 1% to of about 20% by weight, based on the total weight of the composition; b) at least one polycationic type rheology modifier comprises monomers with ammonium, sulfonium or phosphonium moiety at about 1% to of about 3% by weight, based on the total weight of the composition; c) optionally additives and d) cyantraniliprole.

In some embodiments, the aqueous pesticidal suspension composition comprising a) emamectin or salt thereof at about 3% to of about 10% by weight, based on the total weight of the composition; b) at least one polycationic type rheology modifier comprises monomers with ammonium, sulfonium or phosphonium moiety at about 1% to of about 3% by weight, based on the total weight of the composition; c) optionally additives and d) cyantraniliprole.

In some embodiments, the aqueous pesticidal suspension composition comprising a) emamectin or salt thereof at about 5% to of about 8% by weight, based on the total weight of the composition; b) at least one polycationic type rheology modifier comprises monomers with ammonium, sulfonium or phosphonium moiety at about 1% to of about 3% by weight, based on the total weight of the composition; c) optionally additives and d) cyantraniliprole.

In some embodiments, the aqueous pesticidal suspension composition comprising a) emamectin or salt thereof at about 7.5% by weight, based on the total weight of the composition; b) at least one polycationic type rheology modifier comprises monomers with ammonium, sulfonium or phosphonium moiety at about 1% to of about 3% by weight, based on the total weight of the composition; c) optionally additives and d) cyantraniliprole.

In some embodiments, the aqueous pesticidal suspension composition comprising a) emamectin or salt thereof at about 1% to of about 20% by weight, based on the total weight of the composition; b) at least one polycationic type rheology modifier comprises monomers with ammonium, sulfonium or phosphonium moiety at about 1% to of about 2% by weight, based on the total weight of the composition; c) optionally additives and d) cyantraniliprole.

In some embodiments, the aqueous pesticidal suspension composition comprising a) emamectin or salt thereof at about 3% to of about 10% by weight, based on the total weight of the composition; b) at least one polycationic type rheology modifier comprises monomers with ammonium, sulfonium or phosphonium moiety at about 1% to of about 2% by weight, based on the total weight of the composition; c) optionally additives and d) cyantraniliprole.

In some embodiments, the aqueous pesticidal suspension composition comprising a) emamectin or salt thereof at about 5% to of about 8% by weight, based on the total weight of the composition; b) at least one polycationic type rheology modifier comprises monomers with ammonium, sulfonium or phosphonium moiety at about 1% to of about 2% by weight, based on the total weight of the composition; c) optionally additives and d) cyantraniliprole.

In some embodiments, the aqueous pesticidal suspension composition comprising a) emamectin or salt thereof at about 7.5% by weight, based on the total weight of the composition; b) at least one polycationic type rheology modifier comprises monomers with ammonium, sulfonium or phosphonium moiety at about 1% to of about 2% by weight, based on the total weight of the composition; c) optionally additives and d) cyantraniliprole.

In some embodiments, the aqueous pesticidal suspension composition comprising a) emamectin or salt thereof at about 1% to of about 20% by weight, based on the total weight of the composition; b) at least one polycationic type rheology modifier comprises monomers with ammonium, sulfonium or phosphonium moiety at about 1.1% to of about 1.7% by weight, based on the total weight of the composition; c) optionally additives and d) cyantraniliprole.

In some embodiments, the aqueous pesticidal suspension composition comprising a) emamectin or salt thereof at about 3% to of about 10% by weight, based on the total weight of the composition; b) at least one polycationic type rheology modifier comprises monomers with ammonium, sulfonium or phosphonium moiety at about 1.1% to of about 1.7% by weight, based on the total weight of the composition; c) optionally additives and d) cyantraniliprole.

In some embodiments, the aqueous pesticidal suspension composition comprising a) emamectin or salt thereof at about 5% to of about 8% by weight, based on the total weight of the composition; b) at least one polycationic type rheology modifier comprises monomers with ammonium, sulfonium or phosphonium moiety at about 1.1% to of about 1.7% by weight, based on the total weight of the composition; c) optionally additives and d) cyantraniliprole.

In some embodiments, the aqueous pesticidal suspension composition comprising a) emamectin or salt thereof at about 7.5% by weight, based on the total weight of the composition; b) at least one polycationic type rheology modifier comprises monomers with ammonium, sulfonium or phosphonium moiety at about 1.1% to of about 1.7% by weight, based on the total weight of the composition; c) optionally additives and d) cyantraniliprole.

In some embodiments, the aqueous pesticidal suspension composition comprising a) emamectin or salt thereof at about 1% to of about 20% by weight, based on the total weight of the composition; b) at least one polycationic type rheology modifier comprises monomers with ammonium, sulfonium or phosphonium moiety at about 1.2% by weight, based on the total weight of the composition; c) optionally additives and d) cyantraniliprole.

In some embodiments, the aqueous pesticidal suspension composition comprising a) emamectin or salt thereof at about 3% to of about 10% by weight, based on the total weight of the composition; b) at least one polycationic type rheology modifier comprises monomers with ammonium, sulfonium or phosphonium moiety at about 1.2% by weight, based on the total weight of the composition; c) optionally additives and d) cyantraniliprole.

In some embodiments, the aqueous pesticidal suspension composition comprising a) emamectin or salt thereof at about 5% to of about 8% by weight, based on the total weight of the composition; b) at least one polycationic type rheology modifier comprises monomers with ammonium, sulfonium or phosphonium moiety at about 1.2% by weight, based on the total weight of the composition; c) optionally additives and d) cyantraniliprole.

In some embodiments, the aqueous pesticidal suspension composition comprising a) emamectin or salt thereof at about 7.5% by weight, based on the total weight of the composition; b) at least one polycationic type rheology modifier comprises monomers with ammonium, sulfonium or phosphonium moiety at about 1.2% by weight, based on the total weight of the composition; c) optionally additives and d) cyantraniliprole.

In some embodiments, the aqueous pesticidal suspension composition comprising a) emamectin or salt thereof at about 1% to of about 20% by weight, based on the total weight of the composition; b) at least one polycationic type rheology modifier comprises monomers with ammonium moiety at about 1% to of about 3% by weight, based on the total weight of the composition; c) optionally additives and d) cyantraniliprole.

In some embodiments, the aqueous pesticidal suspension composition comprising a) emamectin or salt thereof at about 3% to of about 10% by weight, based on the total weight of the composition; b) at least one polycationic type rheology modifier comprises monomers with ammonium moiety at about 1% to of about 3% by weight, based on the total weight of the composition; c) optionally additives and d) cyantraniliprole.

In some embodiments, the aqueous pesticidal suspension composition comprising a) emamectin or salt thereof at about 5% to of about 8% by weight, based on the total weight of the composition; b) at least one polycationic type rheology modifier comprises monomers with ammonium moiety at about 1% to of about 3% by weight, based on the total weight of the composition; c) optionally additives and d) cyantraniliprole.

In some embodiments, the aqueous pesticidal suspension composition comprising a) emamectin or salt thereof at about 7.5% by weight, based on the total weight of the composition; b) at least one polycationic type rheology modifier comprises monomers with ammonium moiety at about 1% to of about 3% by weight, based on the total weight of the composition; c) optionally additives and d) cyantraniliprole.

In some embodiments, the aqueous pesticidal suspension composition comprising a) emamectin or salt thereof at about 1% to of about 20% by weight, based on the total weight of the composition; b) at least one polycationic type rheology modifier comprises monomers with ammonium moiety at about 1% to of about 2% by weight, based on the total weight of the composition; c) optionally additives and d) cyantraniliprole.

In some embodiments, the aqueous pesticidal suspension composition comprising a) emamectin or salt thereof at about 3% to of about 10% by weight, based on the total weight of the composition; b) at least one polycationic type rheology modifier comprises monomers with ammonium moiety at about 1% to of about 2% by weight, based on the total weight of the composition; c) optionally additives and d) cyantraniliprole.

In some embodiments, the aqueous pesticidal suspension composition comprising a) emamectin or salt thereof at about 5% to of about 8% by weight, based on the total weight of the composition; b) at least one polycationic type rheology modifier comprises monomers with ammonium moiety at about 1% to of about 2% by weight, based on the total weight of the composition; c) optionally additives and d) cyantraniliprole.

In some embodiments, the aqueous pesticidal suspension composition comprising a) emamectin or salt thereof at about 7.5% by weight, based on the total weight of the composition; b) at least one polycationic type rheology modifier comprises monomers with ammonium moiety at about 1% to of about 2% by weight, based on the total weight of the composition; c) optionally additives and d) cyantraniliprole.

In some embodiments, the aqueous pesticidal suspension composition comprising a) emamectin or salt thereof at about 1% to of about 20% by weight, based on the total weight of the composition; b) at least one polycationic type rheology modifier comprises monomers with ammonium moiety at about 1.1% to of about 1.7% by weight, based on the total weight of the composition; c) optionally additives and d) cyantraniliprole.

In some embodiments, the aqueous pesticidal suspension composition comprising a) emamectin or salt thereof at about 3% to of about 10% by weight, based on the total weight of the composition; b) at least one polycationic type rheology modifier comprises monomers with ammonium moiety at about 1.1% to of about 1.7% by weight, based on the total weight of the composition; c) optionally additives and d) cyantraniliprole.

In some embodiments, the aqueous pesticidal suspension composition comprising a) emamectin or salt thereof at about 5% to of about 8% by weight, based on the total weight of the composition; b) at least one polycationic type rheology modifier comprises monomers with ammonium moiety at about 1.1% to of about 1.7% by weight, based on the total weight of the composition; c) optionally additives and d) cyantraniliprole.

In some embodiments, the aqueous pesticidal suspension composition comprising a) emamectin or salt thereof at about 7.5% by weight, based on the total weight of the composition; b) at least one polycationic type rheology modifier comprises monomers with ammonium moiety at about 1.1% to of about 1.7% by weight, based on the total weight of the composition; c) optionally additives and d) cyantraniliprole.

In some embodiments, the aqueous pesticidal suspension composition comprising a) emamectin or salt thereof at about 1% to of about 20% by weight, based on the total weight of the composition; b) at least one polycationic type rheology modifier comprises monomers with ammonium moiety at about 1.2% by weight, based on the total weight of the composition; c) optionally additives and d) cyantraniliprole.

In some embodiments, the aqueous pesticidal suspension composition comprising a) emamectin or salt thereof at about 3% to of about 10% by weight, based on the total weight of the composition; b) at least one polycationic type rheology modifier comprises monomers with ammonium moiety at about 1.2% by weight, based on the total weight of the composition; c) optionally additives and d) cyantraniliprole.

In some embodiments, the aqueous pesticidal suspension composition comprising a) emamectin or salt thereof at about 5% to of about 8% by weight, based on the total weight of the composition; b) at least one polycationic type rheology modifier comprises monomers with ammonium moiety at about 1.2% by weight, based on the total weight of the composition; c) optionally additives and d) cyantraniliprole.

In some embodiments, the aqueous pesticidal suspension composition comprising a) emamectin or salt thereof at about 7.5% by weight, based on the total weight of the composition; b) at least one polycationic type rheology modifier comprises monomers with ammonium moiety at about 1.2% by weight, based on the total weight of the composition; c) optionally additives and d) cyantraniliprole.

In some embodiments, the aqueous pesticidal suspension composition comprising a) emamectin or salt thereof at about 1% to of about 20% by weight, based on the total weight of the composition; b) at least one polycationic type rheology modifier comprises monomers with ammonium moiety is selected from polyquaterniums or polyquaternium esters polymers and combinations thereof at about 1% to of about 3% by weight, based on the total weight of the composition; c) optionally additives and d) cyantraniliprole.

In some embodiments, the aqueous pesticidal suspension composition comprising a) emamectin or salt thereof at about 3% to of about 10% by weight, based on the total weight of the composition; b) at least one polycationic type rheology modifier comprises monomers with ammonium moiety is selected from polyquaterniums or polyquaternium esters polymers and combinations thereof at about 1% to of about 3% by weight, based on the total weight of the composition; c) optionally additives and d) cyantraniliprole.

In some embodiments, the aqueous pesticidal suspension composition comprising a) emamectin or salt thereof at about 5% to of about 8% by weight, based on the total weight of the composition; b) at least one polycationic type rheology modifier comprises monomers with ammonium moiety is selected from polyquaterniums or polyquaternium esters polymers and combinations thereof at about 1% to of about 3% by weight, based on the total weight of the composition; c) optionally additives and d) cyantraniliprole.

In some embodiments, the aqueous pesticidal suspension composition comprising a) emamectin or salt thereof at about 7.5% by weight, based on the total weight of the composition; b) at least one polycationic type rheology modifier comprises monomers with ammonium moiety is selected from polyquaterniums or polyquaternium esters polymers and combinations thereof at about 1% to of about 3% by weight, based on the total weight of the composition; c) optionally additives and d) cyantraniliprole.

In some embodiments, the aqueous pesticidal suspension composition comprising a) emamectin or salt thereof at about 1% to of about 20% by weight, based on the total weight of the composition; b) at least one polycationic type rheology modifier comprises monomers with ammonium moiety is selected from polyquaterniums or polyquaternium esters polymers and combinations thereof at about 1% to of about 2% by weight, based on the total weight of the composition; c) optionally additives and d) cyantraniliprole.

In some embodiments, the aqueous pesticidal suspension composition comprising a) emamectin or salt thereof at about 3% to of about 10% by weight, based on the total weight of the composition; b) at least one polycationic type rheology modifier comprises monomers with ammonium moiety is selected from polyquaterniums or polyquaternium esters polymers and combinations thereof at about 1% to of about 2% by weight, based on the total weight of the composition; c) optionally additives and d) cyantraniliprole.

In some embodiments, the aqueous pesticidal suspension composition comprising a) emamectin or salt thereof at about 5% to of about 8% by weight, based on the total weight of the composition; b) at least one polycationic type rheology modifier comprises monomers with ammonium moiety is selected from polyquaterniums or polyquaternium esters polymers and combinations thereof at about 1% to of about 2% by weight, based on the total weight of the composition; c) optionally additives and d) cyantraniliprole.

In some embodiments, the aqueous pesticidal suspension composition comprising a) emamectin or salt thereof at about 7.5% by weight, based on the total weight of the composition; b) at least one polycationic type rheology modifier comprises monomers with ammonium moiety is selected from polyquaterniums or polyquaternium esters polymers and combinations thereof at about 1% to of about 2% by weight, based on the total weight of the composition; c) optionally additives and d) cyantraniliprole.

In some embodiments, the aqueous pesticidal suspension composition comprising a) emamectin or salt thereof at about 1% to of about 20% by weight, based on the total weight of the composition; b) at least one polycationic type rheology modifier comprises monomers with ammonium moiety is selected from polyquaterniums or polyquaternium esters polymers and combinations thereof at about 1.1% to of about 1.7% by weight, based on the total weight of the composition; c) optionally additives and d) cyantraniliprole.

In some embodiments, the aqueous pesticidal suspension composition comprising a) emamectin or salt thereof at about 3% to of about 10% by weight, based on the total weight of the composition; b) at least one polycationic type rheology modifier comprises monomers with ammonium moiety is selected from polyquaterniums or polyquaternium esters polymers and combinations thereof at about 1.1% to of about 1.7% by weight, based on the total weight of the composition; c) optionally additives and d) cyantraniliprole.

In some embodiments, the aqueous pesticidal suspension composition comprising a) emamectin or salt thereof at about 5% to of about 8% by weight, based on the total weight of the composition; b) at least one polycationic type rheology modifier comprises monomers with ammonium moiety is selected from polyquaterniums or polyquaternium esters polymers and combinations thereof at about 1.1% to of about 1.7% by weight, based on the total weight of the composition; c) optionally additives and d) cyantraniliprole.

In some embodiments, the aqueous pesticidal suspension composition comprising a) emamectin or salt thereof at about 7.5% by weight, based on the total weight of the composition; b) at least one polycationic type rheology modifier comprises monomers with ammonium moiety is selected from polyquaterniums or polyquaternium esters polymers and combinations thereof at about 1.1% to of about 1.7% by weight, based on the total weight of the composition; c) optionally additives and d) cyantraniliprole.

In some embodiments, the aqueous pesticidal suspension composition comprising a) emamectin or salt thereof at about 1% to of about 20% by weight, based on the total weight of the composition; b) at least one polycationic type rheology modifier comprises monomers with ammonium moiety is selected from polyquaterniums or polyquaternium esters polymers and combinations thereof at about 1.2% by weight, based on the total weight of the composition; c) optionally additives and d) cyantraniliprole.

In some embodiments, the aqueous pesticidal suspension composition comprising a) emamectin or salt thereof at about 3% to of about 10% by weight, based on the total weight of the composition; b) at least one polycationic type rheology modifier comprises monomers with ammonium moiety is selected from polyquaterniums or polyquaternium esters polymers and combinations thereof at about 1.2% by weight, based on the total weight of the composition; c) optionally additives and d) cyantraniliprole.

In some embodiments, the aqueous pesticidal suspension composition comprising a) emamectin or salt thereof at about 5% to of about 8% by weight, based on the total weight of the composition; b) at least one polycationic type rheology modifier comprises monomers with ammonium moiety is selected from polyquaterniums or polyquaternium esters polymers and combinations thereof at about 1.2% by weight, based on the total weight of the composition; c) optionally additives and d) cyantraniliprole.

In some embodiments, the aqueous pesticidal suspension composition comprising a) emamectin or salt thereof at about 7.5% by weight, based on the total weight of the composition; b) at least one polycationic type rheology modifier comprises monomers with ammonium moiety is selected from polyquaterniums or polyquaternium esters polymers and combinations thereof at about 1.2% by weight, based on the total weight of the composition; c) optionally additives and d) cyantraniliprole.

In some embodiments, the aqueous pesticidal suspension composition comprising a) emamectin or salt thereof at about 1% to of about 20% by weight, based on the total weight of the composition; b) at least one polycationic type rheology modifier comprises monomers with ammonium moiety is poly(2-methacryloxyethyltrimethylammonium chloride) at about 1% to of about 3% by weight, based on the total weight of the composition; c) optionally additives and d) cyantraniliprole.

In some embodiments, the aqueous pesticidal suspension composition comprising a) emamectin or salt thereof at about 3% to of about 10% by weight, based on the total weight of the composition; b) at least one polycationic type rheology modifier comprises monomers with ammonium moiety is poly(2-methacryloxyethyltrimethylammonium chloride) at about 1% to of about 3% by weight, based on the total weight of the composition; c) optionally additives and d) cyantraniliprole.

In some embodiments, the aqueous pesticidal suspension composition comprising a) emamectin or salt thereof at about 5% to of about 8% by weight, based on the total weight of the composition; b) at least one polycationic type rheology modifier comprises monomers with ammonium moiety is poly(2-methacryloxyethyltrimethylammonium chloride) at about 1% to of about 3% by weight, based on the total weight of the composition; c) optionally additives and d) cyantraniliprole.

In some embodiments, the aqueous pesticidal suspension composition comprising a) emamectin or salt thereof at about 7.5% by weight, based on the total weight of the composition; b) at least one polycationic type rheology modifier comprises monomers with ammonium moiety is poly(2-methacryloxyethyltrimethylammonium chloride) at about 1% to of about 3% by weight, based on the total weight of the composition; c) optionally additives and d) cyantraniliprole.

In some embodiments, the aqueous pesticidal suspension composition comprising a) emamectin or salt thereof at about 1% to of about 20% by weight, based on the total weight of the composition; b) at least one polycationic type rheology modifier comprises monomers with ammonium moiety is poly(2-methacryloxyethyltrimethylammonium chloride) at about 1% to of about 2% by weight, based on the total weight of the composition; c) optionally additives and d) cyantraniliprole.

In some embodiments, the aqueous pesticidal suspension composition comprising a) emamectin or salt thereof at about 3% to of about 10% by weight, based on the total weight of the composition; b) at least one polycationic type rheology modifier comprises monomers with ammonium moiety is poly(2-methacryloxyethyltrimethylammonium chloride) at about 1% to of about 2% by weight, based on the total weight of the composition; c) optionally additives and d) cyantraniliprole.

In some embodiments, the aqueous pesticidal suspension composition comprising a) emamectin or salt thereof at about 5% to of about 8% by weight, based on the total weight of the composition; b) at least one polycationic type rheology modifier comprises monomers with ammonium moiety is poly(2-methacryloxyethyltrimethylammonium chloride) at about 1% to of about 2% by weight, based on the total weight of the composition; c) optionally additives and d) cyantraniliprole.

In some embodiments, the aqueous pesticidal suspension composition comprising a) emamectin or salt thereof at about 7.5% by weight, based on the total weight of the composition; b) at least one polycationic type rheology modifier comprises monomers with ammonium moiety is poly(2-methacryloxyethyltrimethylammonium chloride) at about 1% to of about 2% by weight, based on the total weight of the composition; c) optionally additives and d) cyantraniliprole.

In some embodiments, the aqueous pesticidal suspension composition comprising a) emamectin or salt thereof at about 1% to of about 20% by weight, based on the total weight of the composition; b) at least one polycationic type rheology modifier comprises monomers with ammonium moiety is poly(2-methacryloxyethyltrimethylammonium chloride) at about 1.1% to of about 1.7% by weight, based on the total weight of the composition; c) optionally additives and d) cyantraniliprole.

In some embodiments, the aqueous pesticidal suspension composition comprising a) emamectin or salt thereof at about 3% to of about 10% by weight, based on the total weight of the composition; b) at least one polycationic type rheology modifier comprises monomers with ammonium moiety is poly(2-methacryloxyethyltrimethylammonium chloride) at about 1.1% to of about 1.7% by weight, based on the total weight of the composition; c) optionally additives and d) cyantraniliprole.

In some embodiments, the aqueous pesticidal suspension composition comprising a) emamectin or salt thereof at about 5% to of about 8% by weight, based on the total weight of the composition; b) at least one polycationic type rheology modifier comprises monomers with ammonium moiety is poly(2-methacryloxyethyltrimethylammonium chloride) at about 1.1% to of about 1.7% by weight, based on the total weight of the composition; c) optionally additives and d) cyantraniliprole.

In some embodiments, the aqueous pesticidal suspension composition comprising a) emamectin or salt thereof at about 7.5% by weight, based on the total weight of the composition; b) at least one polycationic type rheology modifier comprises monomers with ammonium moiety is poly(2-methacryloxyethyltrimethylammonium chloride) at about 1.1% to of about 1.7% by weight, based on the total weight of the composition; c) optionally additives and d) cyantraniliprole.

In some embodiments, the aqueous pesticidal suspension composition comprising a) emamectin or salt thereof at about 1% to of about 20% by weight, based on the total weight of the composition; b) at least one polycationic type rheology modifier comprises monomers with ammonium moiety is poly(2-methacryloxyethyltrimethylammonium chloride) at about 1.2% by weight, based on the total weight of the composition; c) optionally additives and d) cyantraniliprole.

In some embodiments, the aqueous pesticidal suspension composition comprising a) emamectin or salt thereof at about 3% to of about 10% by weight, based on the total weight of the composition; b) at least one polycationic type rheology modifier comprises monomers with ammonium moiety is poly(2-methacryloxyethyltrimethylammonium chloride) at about 1.2% by weight, based on the total weight of the composition; c) optionally additives and d) cyantraniliprole.

In some embodiments, the aqueous pesticidal suspension composition comprising a) emamectin or salt thereof at about 5% to of about 8% by weight, based on the total weight of the composition; b) at least one polycationic type rheology modifier comprises monomers with ammonium moiety is poly(2-methacryloxyethyltrimethylammonium chloride) at about 1.2% by weight, based on the total weight of the composition; c) optionally additives and d) cyantraniliprole.

In some embodiments, the aqueous pesticidal suspension composition comprising a) emamectin or salt thereof at about 7.5% by weight, based on the total weight of the composition; b) at least one polycationic type rheology modifier comprises monomers with ammonium moiety is poly(2-methacryloxyethyltrimethylammonium chloride) at about 1.2% by weight, based on the total weight of the composition; c) optionally additives and d) cyantraniliprole.

In some embodiments, the aqueous pesticidal suspension composition comprising a) emamectin or salt thereof at about 1% to of about 20% by weight, based on the total weight of the composition; b) at least one polycationic type rheology modifier at about 1.1% to of about 1.7% by weight, based on the total weight of the composition; c) optionally additives and d) cyantraniliprole at about 1% to of about 60% by weight, based on the total weight of the composition.

In some embodiments, the aqueous pesticidal suspension composition comprising a) emamectin or salt thereof at about 1% to of about 20% by weight, based on the total weight of the composition; b) at least one polycationic type rheology modifier at about 1.1% to of about 1.7% by weight, based on the total weight of the composition; c) optionally additives and d) cyantraniliprole at about 1% to of about 20% by weight, based on the total weight of the composition.

In some embodiments, the aqueous pesticidal suspension composition comprising a) emamectin or salt thereof at about 7.5% by weight, based on the total weight of the composition; b) at least one polycationic type rheology modifier at about 1.2% by weight, based on the total weight of the composition; c) optionally additives and d) cyantraniliprole at about 15% by weight, based on the total weight of the composition.

In some embodiments, the aqueous pesticidal suspension composition comprising a) emamectin or salt thereof at about 1% to of about 20% by weight, based on the total weight of the composition; b) at least one polycationic type rheology modifier comprises monomers with ammonium, sulfonium or phosphonium moiety at about 1.1% to of about 1.7% by weight, based on the total weight of the composition; c) optionally additives and d) cyantraniliprole at about 1% to of about 60% by weight, based on the total weight of the composition.

In some embodiments, the aqueous pesticidal suspension composition comprising a) emamectin or salt thereof at about 1% to of about 20% by weight, based on the total weight of the composition; b) at least one polycationic type rheology modifier comprises monomers with ammonium, sulfonium or phosphonium moiety at about 1.1% to of about 1.7% by weight, based on the total weight of the composition; c) optionally additives and d) cyantraniliprole at about 1% to of about 20% by weight, based on the total weight of the composition.

In some embodiments, the aqueous pesticidal suspension composition comprising a) emamectin or salt thereof at about 7.5% by weight, based on the total weight of the composition; b) at least one polycationic type rheology modifier comprises monomers with ammonium, sulfonium or phosphonium moiety at about 1.2% by weight, based on the total weight of the composition; c) optionally additives and d) cyantraniliprole at about 15% by weight, based on the total weight of the composition.

In some embodiments, the aqueous pesticidal suspension composition comprising a) emamectin or salt thereof at about 1% to of about 20% by weight, based on the total weight of the composition; b) at least one polycationic type rheology modifier comprises monomers with ammonium moiety at about 1.1% to of about 1.7% by weight, based on the total weight of the composition; c) optionally additives and d) cyantraniliprole at about 1% to of about 60% by weight, based on the total weight of the composition.

In some embodiments, the aqueous pesticidal suspension composition comprising a) emamectin or salt thereof at about 1% to of about 20% by weight, based on the total weight of the composition; b) at least one polycationic type rheology modifier comprises monomers with ammonium moiety at about 1.1% to of about 1.7% by weight, based on the total weight of the composition; c) optionally additives and d) cyantraniliprole at about 1% to of about 20% by weight, based on the total weight of the composition.

In some embodiments, the aqueous pesticidal suspension composition comprising a) emamectin or salt thereof at about 7.5% by weight, based on the total weight of the composition; b) at least one polycationic type rheology modifier comprises monomers with ammonium moiety at about 1.2% by weight, based on the total weight of the composition; c) optionally additives and d) cyantraniliprole at about 15% by weight, based on the total weight of the composition.

In some embodiments, the aqueous pesticidal suspension composition comprising a) emamectin or salt thereof at about 1% to of about 20% by weight, based on the total weight of the composition; b) at least one polycationic type rheology modifier comprises monomers with ammonium moiety is selected from polyquaterniums or polyquaternium esters polymers and combinations thereof at about 1.1% to of about 1.7% by weight, based on the total weight of the composition; c) optionally additives and d) cyantraniliprole at about 1% to of about 60% by weight, based on the total weight of the composition.

In some embodiments, the aqueous pesticidal suspension composition comprising a) emamectin or salt thereof at about 1% to of about 20% by weight, based on the total weight of the composition; b at least one polycationic type rheology modifier comprises monomers with ammonium moiety is selected from polyquaterniums or polyquaternium esters polymers and combinations thereof at about 1.1% to of about 1.7% by weight, based on the total weight of the composition; c) optionally additives and d) cyantraniliprole at about 1% to of about 20% by weight, based on the total weight of the composition.

In some embodiments, the aqueous pesticidal suspension composition comprising a) emamectin or salt thereof at about 7.5% by weight, based on the total weight of the composition; b) at least one polycationic type rheology modifier comprises monomers with ammonium moiety is selected from polyquaterniums or polyquaternium esters polymers and combinations thereof at about 1.2% by weight, based on the total weight of the composition; c) optionally additives and d) cyantraniliprole at about 15% by weight, based on the total weight of the composition.

In some embodiments, the aqueous pesticidal suspension composition comprising a) emamectin or salt thereof at about 1% to of about 20% by weight, based on the total weight of the composition; b) poly(2-methacryloxyethyltrimethylammonium chloride) at about 1.1% to of about 1.7% by weight, based on the total weight of the composition; c) optionally additives and d) cyantraniliprole at about 1% to of about 60% by weight, based on the total weight of the composition.

In some embodiments, the aqueous pesticidal suspension composition comprising a) emamectin or salt thereof at about 1% to of about 20% by weight, based on the total weight of the composition; b) poly(2-methacryloxyethyltrimethylammonium chloride) at about 1.1% to of about 1.7% by weight, based on the total weight of the composition; c) optionally additives and d) cyantraniliprole at about 1% to of about 20% by weight, based on the total weight of the composition.

In some embodiments, the aqueous pesticidal suspension composition comprising a) emamectin or salt thereof at about 7.5% by weight, based on the total weight of the composition; b) poly(2-methacryloxyethyltrimethylammonium chloride) at about 1.2% by weight, based on the total weight of the composition; c) optionally additives and d) cyantraniliprole at about 15% by weight, based on the total weight of the composition.

The invention also relates to a method for stabilizing an aqueous pesticidal suspension composition comprising a macrolide insecticidal compound or salt thereof; optionally additives and optionally additional active ingredient by the addition of at least one polycationic type rheology modifier.

In some embodiments, the macrolide insecticidal compound is selected from emamectin, abamectin, spinosad, spinetoram or salt thereof.

In some embodiments, the macrolide insecticidal compound is emamectin or salt thereof.

In some embodiments, the macrolide insecticidal compound is emamectin benzoate.

In some embodiments, the amount of the macrolide insecticidal compound is of about 1% to of about 20% by weight, based on the total weight of the composition.

In some embodiments, the additive is selected from the group comprising of dispersants, wetting agents, antifreezing agents, antifoaming agents, surfactants, pH modifiers and stabilizers.

In some embodiments, the additional active ingredient is a diamide insecticide.

In some embodiments, the diamide insecticide is selected from chlorantraniliprole, cyantraniliprole, cyclaniliprole, fluchlordiniliprole, tetrachlorantraniliprole and tetraniliprole.

In some embodiments, wherein the diamide insecticide is selected from chlorantraniliprole or cyantraniliprole.

In some embodiments, the diamide insecticide is chlorantraniliprole.

In some embodiments, the diamide insecticide is cyantraniliprole.

In some embodiments, the additional active ingredient is of about 1% to of about 60% by weight, based on the total weight of the composition.

In some embodiments, the additional active ingredient is of about 1% to of about 40% by weight, based on the total weight of the composition.

In some embodiments, the additional active ingredient is of about 1% to of about 20% by weight, based on the total weight of the composition.

In some embodiments, the additional active ingredient is of about 15% by weight, based on the total weight of the composition.

In some embodiments, the at least one polycationic type rheology modifier comprises monomers with ammonium, sulfonium or phosphonium moiety.

In some embodiments, the at least one polycationic type rheology modifier comprises monomers with ammonium moiety.

In some embodiments, the at least one polycationic type rheology modifier comprises monomers with ammonium moiety is selected from polyquaterniums or polyquaternium esters polymers and combinations thereof.

In some embodiments,

In some embodiments, the amount of the at least one polycationic type thickener is of about 1% to of about 3% by weight, based on the total weight of the composition.

In some embodiments, the amount of the at least one polycationic type thickener is of about 1% to of about 2% by weight, based on the total weight of the composition.

In some embodiments, the amount of the at least one polycationic type thickener is of about 1.1% to of about 1.7% by weight, based on the total weight of the composition.

In some embodiments, the amount of the at least one polycationic type thickener is of about 1.2% by weight, based on the total weight of the composition.

In some embodiments, the composition is applied in an amount from about 0.06 L/ha to about 0.62 L/ha.

In some embodiments, the composition is applied in an amount from about 5 g/ha of macrolide insecticidal compound or salt thereof to about 15 g/ha of macrolide insecticidal compound or salt thereof.

In some embodiments, the composition is applied in an amount from about 10 g/ha of diamide insecticide to about 100 g/ha of diamide insecticide.

In some embodiments, the diamide insecticide is selected from chlorantraniliprole, cyantraniliprole, cyclaniliprole, fluchlordiniliprole, tetrachlorantraniliprole and tetraniliprole.

In some embodiments, the diamide insecticide is selected from chlorantraniliprole or cyantraniliprole.

In some embodiments, the diamide insecticide is chlorantraniliprole.

In some embodiments, the diamide insecticide is cyantraniliprole.

In some embodiments, the method is for stabilizing an aqueous pesticidal suspension composition comprising a macrolide insecticidal compound or salt thereof; optionally additives and optionally additional active ingredient by the addition of at least one polycationic type rheology modifier.

In some embodiments, the method is for stabilizing an aqueous pesticidal suspension composition comprising a macrolide insecticidal compound or salt thereof; optionally additives and optionally additional active ingredient by the addition of at least one polycationic type rheology modifier comprises monomers with ammonium, sulfonium or phosphonium moiety.

In some embodiments, the method is for stabilizing an aqueous pesticidal suspension composition comprising a macrolide insecticidal compound or salt thereof; optionally additives and optionally additional active ingredient by the addition of at least one polycationic type rheology modifier comprises monomers with ammonium moiety.

In some embodiments, the method is for stabilizing an aqueous pesticidal suspension composition comprising a macrolide insecticidal compound or salt thereof; optionally additives and optionally additional active ingredient by the addition of at least one polycationic type rheology modifier comprises monomers with ammonium moiety is selected from polyquaterniums or polyquaternium esters polymers and combinations thereof.

In some embodiments, the method is for stabilizing an aqueous pesticidal suspension composition comprising a macrolide insecticidal compound or salt thereof; optionally additives and optionally additional active ingredient by the addition of poly(2-methacryloxyethyltrimethylammonium chloride).

In some embodiments, the method is for stabilizing an aqueous pesticidal suspension composition comprising a macrolide insecticidal compound or salt thereof; optionally additives and optionally additional active ingredient by the addition of at least one polycationic type rheology modifier at about 1% to about 3% by weight, based on the total weight of the composition.

In some embodiments, the method is for stabilizing an aqueous pesticidal suspension composition comprising a macrolide insecticidal compound or salt thereof; optionally additives and optionally additional active ingredient by the addition of at least one polycationic type rheology modifier at about 1% to about 2% by weight, based on the total weight of the composition.

In some embodiments, the method is for stabilizing an aqueous pesticidal suspension composition comprising a macrolide insecticidal compound or salt thereof; optionally additives and optionally additional active ingredient by the addition of at least one polycationic type rheology modifier at about 1.1% to about 1.7% by weight, based on the total weight of the composition.

In some embodiments, the method is for stabilizing an aqueous pesticidal suspension composition comprising a macrolide insecticidal compound or salt thereof; optionally additives and optionally additional active ingredient by the addition of at least one polycationic type rheology modifier at about 1.2% by weight, based on the total weight of the composition.

In some embodiments, the method is for stabilizing an aqueous pesticidal suspension composition comprising a macrolide insecticidal compound or salt thereof; optionally additives and optionally additional active ingredient by the addition of at least one polycationic type rheology modifier comprises monomers with ammonium, sulfonium or phosphonium moiety at about 1% to about 3% by weight, based on the total weight of the composition.

In some embodiments, the method is for stabilizing an aqueous pesticidal suspension composition comprising a macrolide insecticidal compound or salt thereof; optionally additives and optionally additional active ingredient by the addition of at least one polycationic type rheology modifier comprises monomers with ammonium, sulfonium or phosphonium moiety at about 1% to about 2% by weight, based on the total weight of the composition.

In some embodiments, the method is for stabilizing an aqueous pesticidal suspension composition comprising a macrolide insecticidal compound or salt thereof; optionally additives and optionally additional active ingredient by the addition of at least one polycationic type rheology modifier comprises monomers with ammonium, sulfonium or phosphonium moiety at about 1.1% to about 1.7% by weight, based on the total weight of the composition.

In some embodiments, the method is for stabilizing an aqueous pesticidal suspension composition comprising a macrolide insecticidal compound or salt thereof; optionally additives and optionally additional active ingredient by the addition of at least one polycationic type rheology modifier comprises monomers with ammonium, sulfonium or phosphonium moiety at about 1.2% by weight, based on the total weight of the composition.

In some embodiments, the method is for stabilizing an aqueous pesticidal suspension composition comprising a macrolide insecticidal compound or salt thereof; optionally additives and optionally additional active ingredient by the addition of at least one polycationic type rheology modifier comprises monomers with ammonium moiety at about 1% to about 3% by weight, based on the total weight of the composition.

In some embodiments, the method is for stabilizing an aqueous pesticidal suspension composition comprising a macrolide insecticidal compound or salt thereof; optionally additives and optionally additional active ingredient by the addition of at least one polycationic type rheology modifier comprises monomers with ammonium moiety at about 1% to about 2% by weight, based on the total weight of the composition.

In some embodiments, the method is for stabilizing an aqueous pesticidal suspension composition comprising a macrolide insecticidal compound or salt thereof; optionally additives and optionally additional active ingredient by the addition of at least one polycationic type rheology modifier comprises monomers with ammonium moiety at about 1.1% to about 1.7% by weight, based on the total weight of the composition.

In some embodiments, the method is for stabilizing an aqueous pesticidal suspension composition comprising a macrolide insecticidal compound or salt thereof; optionally additives and optionally additional active ingredient by the addition of at least one polycationic type rheology modifier comprises monomers with ammonium moiety at about 1.2% by weight, based on the total weight of the composition.

In some embodiments, the method is for stabilizing an aqueous pesticidal suspension composition comprising a macrolide insecticidal compound or salt thereof; optionally additives and optionally additional active ingredient by the addition of at least one polycationic type rheology modifier comprises monomers with ammonium moiety is selected from polyquaterniums or polyquaternium esters polymers and combinations thereof at about 1% to about 3% by weight, based on the total weight of the composition.

In some embodiments, the method is for stabilizing an aqueous pesticidal suspension composition comprising a macrolide insecticidal compound or salt thereof; optionally additives and optionally additional active ingredient by the addition of at least one polycationic type rheology modifier comprises monomers with ammonium moiety is selected from polyquaterniums or polyquaternium esters polymers and combinations thereof at about 1% to about 2% by weight, based on the total weight of the composition.

In some embodiments, the method is for stabilizing an aqueous pesticidal suspension composition comprising a macrolide insecticidal compound or salt thereof; optionally additives and optionally additional active ingredient by the addition of at least one polycationic type rheology modifier comprises monomers with ammonium moiety is selected from polyquaterniums or polyquaternium esters polymers and combinations thereof at about 1.1% to about 1.7% by weight, based on the total weight of the composition.

In some embodiments, the method is for stabilizing an aqueous pesticidal suspension composition comprising a macrolide insecticidal compound or salt thereof; optionally additives and optionally additional active ingredient by the addition of at least one polycationic type rheology modifier comprises monomers with ammonium moiety is selected from polyquaterniums or polyquaternium esters polymers and combinations thereof at about 1.2% by weight, based on the total weight of the composition.

In some embodiments, the method is for stabilizing an aqueous pesticidal suspension composition comprising a macrolide insecticidal compound or salt thereof; optionally additives and optionally additional active ingredient by the addition of poly(2-methacryloxyethyltrimethylammonium chloride) at about 1% to about 3% by weight, based on the total weight of the composition.

In some embodiments, the method is for stabilizing an aqueous pesticidal suspension composition comprising a macrolide insecticidal compound or salt thereof; optionally additives and optionally additional active ingredient by the addition of poly(2-methacryloxyethyltrimethylammonium chloride) at about 1% to about 2% by weight, based on the total weight of the composition.

In some embodiments, the method is for stabilizing an aqueous pesticidal suspension composition comprising a macrolide insecticidal compound or salt thereof; optionally additives and optionally additional active ingredient by the addition of poly(2-methacryloxyethyltrimethylammonium chloride) at about 1.1% to about 1.7% by weight, based on the total weight of the composition.

In some embodiments, the method is for stabilizing an aqueous pesticidal suspension composition comprising a macrolide insecticidal compound or salt thereof; optionally additives and optionally additional active ingredient by the addition of poly(2-methacryloxyethyltrimethylammonium chloride) at about 1.2% by weight, based on the total weight of the composition.

In some embodiments, the method is for stabilizing an aqueous pesticidal suspension composition comprising emamectin or salt thereof; optionally additives and optionally additional active ingredient by the addition of at least one polycationic type rheology modifier at about 1% to about 3% by weight, based on the total weight of the composition.

In some embodiments, the method is for stabilizing an aqueous pesticidal suspension composition comprising emamectin or salt thereof; optionally additives and optionally additional active ingredient by the addition of at least one polycationic type rheology modifier at about 1% to about 2% by weight, based on the total weight of the composition.

In some embodiments, the method is for stabilizing an aqueous pesticidal suspension composition comprising emamectin or salt thereof; optionally additives and optionally additional active ingredient by the addition of at least one polycationic type rheology modifier at about 1.1% to about 1.7% by weight, based on the total weight of the composition.

In some embodiments, the method is for stabilizing an aqueous pesticidal suspension composition comprising emamectin or salt thereof; optionally additives and optionally additional active ingredient by the addition of at least one polycationic type rheology modifier at about 1.2% by weight, based on the total weight of the composition.

In some embodiments, the method is for stabilizing an aqueous pesticidal suspension composition comprising emamectin or salt thereof; optionally additives and optionally additional active ingredient by the addition of at least one polycationic type rheology modifier comprises monomers with ammonium, sulfonium or phosphonium moiety at about 1% to about 3% by weight, based on the total weight of the composition.

In some embodiments, the method is for stabilizing an aqueous pesticidal suspension composition comprising emamectin or salt thereof; optionally additives and optionally additional active ingredient by the addition of at least one polycationic type rheology modifier comprises monomers with ammonium, sulfonium or phosphonium moiety at about 1% to about 2% by weight, based on the total weight of the composition.

In some embodiments, the method is for stabilizing an aqueous pesticidal suspension composition comprising emamectin or salt thereof; optionally additives and optionally additional active ingredient by the addition of at least one polycationic type rheology modifier comprises monomers with ammonium, sulfonium or phosphonium moiety at about 1.1% to about 1.7% by weight, based on the total weight of the composition.

In some embodiments, the method is for stabilizing an aqueous pesticidal suspension composition comprising emamectin or salt thereof; optionally additives and optionally additional active ingredient by the addition of at least one polycationic type rheology modifier comprises monomers with ammonium, sulfonium or phosphonium moiety at about 1.2% by weight, based on the total weight of the composition.

In some embodiments, the method is for stabilizing an aqueous pesticidal suspension composition comprising emamectin or salt thereof; optionally additives and optionally additional active ingredient by the addition of at least one polycationic type rheology modifier comprises monomers with ammonium moiety at about 1% to about 3% by weight, based on the total weight of the composition.

In some embodiments, the method is for stabilizing an aqueous pesticidal suspension composition comprising emamectin or salt thereof; optionally additives and optionally additional active ingredient by the addition of at least one polycationic type rheology modifier comprises monomers with ammonium moiety at about 1% to about 2% by weight, based on the total weight of the composition.

In some embodiments, the method is for stabilizing an aqueous pesticidal suspension composition comprising emamectin or salt thereof; optionally additives and optionally additional active ingredient by the addition of at least one polycationic type rheology modifier comprises monomers with ammonium moiety at about 1.1% to about 1.7% by weight, based on the total weight of the composition.

In some embodiments, the method is for stabilizing an aqueous pesticidal suspension composition comprising emamectin or salt thereof; optionally additives and optionally additional active ingredient by the addition of at least one polycationic type rheology modifier comprises monomers with ammonium moiety at about 1.2% by weight, based on the total weight of the composition.

In some embodiments, the method is for stabilizing an aqueous pesticidal suspension composition comprising emamectin or salt thereof; optionally additives and optionally additional active ingredient by the addition of at least one polycationic type rheology modifier comprises monomers with ammonium moiety is selected from polyquaterniums or polyquaternium esters polymers and combinations thereof at about 1% to about 3% by weight, based on the total weight of the composition.

In some embodiments, the method is for stabilizing an aqueous pesticidal suspension composition comprising emamectin or salt thereof; optionally additives and optionally additional active ingredient by the addition of at least one polycationic type rheology modifier comprises monomers with ammonium moiety is selected from polyquaterniums or polyquaternium esters polymers and combinations thereof at about 1% to about 2% by weight, based on the total weight of the composition.

In some embodiments, the method is for stabilizing an aqueous pesticidal suspension composition comprising emamectin or salt thereof; optionally additives and optionally additional active ingredient by the addition of at least one polycationic type rheology modifier comprises monomers with ammonium moiety is selected from polyquaterniums or polyquaternium esters polymers and combinations thereof at about 1.1% to about 1.7% by weight, based on the total weight of the composition.

In some embodiments, the method is for stabilizing an aqueous pesticidal suspension composition comprising emamectin or salt thereof; optionally additives and optionally additional active ingredient by the addition of at least one polycationic type rheology modifier comprises monomers with ammonium moiety is selected from polyquaterniums or polyquaternium esters polymers and combinations thereof at about 1.2% by weight, based on the total weight of the composition.

In some embodiments, the method is for stabilizing an aqueous pesticidal suspension composition comprising emamectin or salt thereof; optionally additives and optionally additional active ingredient by the addition of poly(2-methacryloxyethyltrimethylammonium chloride) at about 1% to about 3% by weight, based on the total weight of the composition.

In some embodiments, the method is for stabilizing an aqueous pesticidal suspension composition comprising emamectin or salt thereof; optionally additives and optionally additional active ingredient by the addition of poly(2-methacryloxyethyltrimethylammonium chloride) at about 1% to about 2% by weight, based on the total weight of the composition.

In some embodiments, the method is for stabilizing an aqueous pesticidal suspension composition comprising emamectin or salt thereof; optionally additives and optionally additional active ingredient by the addition of poly(2-methacryloxyethyltrimethylammonium chloride) at about 1.1% to about 1.7% by weight, based on the total weight of the composition.

In some embodiments, the method is for stabilizing an aqueous pesticidal suspension composition comprising emamectin or salt thereof; optionally additives and optionally additional active ingredient by the addition of poly(2-methacryloxyethyltrimethylammonium chloride) at about 1.2% by weight, based on the total weight of the composition.

In some embodiments, the method is for stabilizing an aqueous pesticidal suspension composition comprising emamectin or salt thereof at about 1% to about 20% by weight, based on the total weight of the composition; optionally additives and optionally additional active ingredient by the addition of at least one polycationic type rheology modifier at about 1% to about 3% by weight, based on the total weight of the composition.

In some embodiments, the method is for stabilizing an aqueous pesticidal suspension composition comprising emamectin or salt thereof at about 3% to about 10% by weight, based on the total weight of the composition; optionally additives and optionally additional active ingredient by the addition of at least one polycationic type rheology modifier at about 1% to about 3% by weight, based on the total weight of the composition.

In some embodiments, the method is for stabilizing an aqueous pesticidal suspension composition comprising emamectin or salt thereof at about 5% to about 8% by weight, based on the total weight of the composition; optionally additives and optionally additional active ingredient by the addition of at least one polycationic type rheology modifier at about 1% to about 3% by weight, based on the total weight of the composition.

In some embodiments, the method is for stabilizing an aqueous pesticidal suspension composition comprising emamectin or salt thereof at about 7.5% by weight, based on the total weight of the composition; optionally additives and optionally additional active ingredient by the addition of at least one polycationic type rheology modifier at about 1% to about 3% by weight, based on the total weight of the composition.

In some embodiments, the method is for stabilizing an aqueous pesticidal suspension composition comprising emamectin or salt thereof at about 1% to about 20% by weight, based on the total weight of the composition; optionally additives and optionally additional active ingredient by the addition of at least one polycationic type rheology modifier at about 1% to about 2% by weight, based on the total weight of the composition.

In some embodiments, the method is for stabilizing an aqueous pesticidal suspension composition comprising emamectin or salt thereof at about 3% to about 10% by weight, based on the total weight of the composition; optionally additives and optionally additional active ingredient by the addition of at least one polycationic type rheology modifier at about 1% to about 2% by weight, based on the total weight of the composition.

In some embodiments, the method is for stabilizing an aqueous pesticidal suspension composition comprising emamectin or salt thereof at about 5% to about 8% by weight, based on the total weight of the composition; optionally additives and optionally additional active ingredient by the addition of at least one polycationic type rheology modifier at about 1% to about 2% by weight, based on the total weight of the composition.

In some embodiments, the method is for stabilizing an aqueous pesticidal suspension composition comprising emamectin or salt thereof at about 7.5% by weight, based on the total weight of the composition; optionally additives and optionally additional active ingredient by the addition of at least one polycationic type rheology modifier at about 1% to about 2% by weight, based on the total weight of the composition.

In some embodiments, the method is for stabilizing an aqueous pesticidal suspension composition comprising emamectin or salt thereof at about 1% to about 20% by weight, based on the total weight of the composition; optionally additives and optionally additional active ingredient by the addition of at least one polycationic type rheology modifier at about 1.1% to about 1.7% by weight, based on the total weight of the composition.

In some embodiments, the method is for stabilizing an aqueous pesticidal suspension composition comprising emamectin or salt thereof at about 3% to about 10% by weight, based on the total weight of the composition; optionally additives and optionally additional active ingredient by the addition of at least one polycationic type rheology modifier at about 1.1% to about 1.7% by weight, based on the total weight of the composition.

In some embodiments, the method is for stabilizing an aqueous pesticidal suspension composition comprising emamectin or salt thereof at about 5% to about 8% by weight, based on the total weight of the composition; optionally additives and optionally additional active ingredient by the addition of at least one polycationic type rheology modifier at about 1.1% to about 1.7% by weight, based on the total weight of the composition.

In some embodiments, the method is for stabilizing an aqueous pesticidal suspension composition comprising emamectin or salt thereof at about 7.5% by weight, based on the total weight of the composition; optionally additives and optionally additional active ingredient by the addition of at least one polycationic type rheology modifier at about 1.1% to about 1.7% by weight, based on the total weight of the composition.

In some embodiments, the method is for stabilizing an aqueous pesticidal suspension composition comprising emamectin or salt thereof at about 1% to about 20% by weight, based on the total weight of the composition; optionally additives and optionally additional active ingredient by the addition of at least one polycationic type rheology modifier at about 1.2% by weight, based on the total weight of the composition.

In some embodiments, the method is for stabilizing an aqueous pesticidal suspension composition comprising emamectin or salt thereof at about 3% to about 10% by weight, based on the total weight of the composition; optionally additives and optionally additional active ingredient by the addition of at least one polycationic type rheology modifier at about 1.2% by weight, based on the total weight of the composition.

In some embodiments, the method is for stabilizing an aqueous pesticidal suspension composition comprising emamectin or salt thereof at about 5% to about 8% by weight, based on the total weight of the composition; optionally additives and optionally additional active ingredient by the addition of at least one polycationic type rheology modifier at about 1.2% by weight, based on the total weight of the composition.

In some embodiments, the method is for stabilizing an aqueous pesticidal suspension composition comprising emamectin or salt thereof at about 7.5% by weight, based on the total weight of the composition; optionally additives and optionally additional active ingredient by the addition of at least one polycationic type rheology modifier at about 1.2% by weight, based on the total weight of the composition.

In some embodiments, the method is for stabilizing an aqueous pesticidal suspension composition comprising emamectin or salt thereof at about 1% to about 20% by weight, based on the total weight of the composition; optionally additives and optionally additional active ingredient by the addition of at least one polycationic type rheology modifier comprises monomers with ammonium, sulfonium or phosphonium moiety at about 1% to about 3% by weight, based on the total weight of the composition.

In some embodiments, the method is for stabilizing an aqueous pesticidal suspension composition comprising emamectin or salt thereof at about 3% to about 10% by weight, based on the total weight of the composition; optionally additives and optionally additional active ingredient by the addition of at least one polycationic type rheology modifier comprises monomers with ammonium, sulfonium or phosphonium moiety at about 1% to about 3% by weight, based on the total weight of the composition.

In some embodiments, the method is for stabilizing an aqueous pesticidal suspension composition comprising emamectin or salt thereof at about 5% to about 8% by weight, based on the total weight of the composition; optionally additives and optionally additional active ingredient by the addition of at least one polycationic type rheology modifier comprises monomers with ammonium, sulfonium or phosphonium moiety at about 1% to about 3% by weight, based on the total weight of the composition.

In some embodiments, the method is for stabilizing an aqueous pesticidal suspension composition comprising emamectin or salt thereof at about 7.5% by weight, based on the total weight of the composition; optionally additives and optionally additional active ingredient by the addition of at least one polycationic type rheology modifier comprises monomers with ammonium, sulfonium or phosphonium moiety at about 1% to about 3% by weight, based on the total weight of the composition.

In some embodiments, the method is for stabilizing an aqueous pesticidal suspension composition comprising emamectin or salt thereof at about 1% to about 20% by weight, based on the total weight of the composition; optionally additives and optionally additional active ingredient by the addition of at least one polycationic type rheology modifier comprises monomers with ammonium, sulfonium or phosphonium moiety at about 1% to about 2% by weight, based on the total weight of the composition.

In some embodiments, the method is for stabilizing an aqueous pesticidal suspension composition comprising emamectin or salt thereof at about 3% to about 10% by weight, based on the total weight of the composition; optionally additives and optionally additional active ingredient by the addition of at least one polycationic type rheology modifier comprises monomers with ammonium, sulfonium or phosphonium moiety at about 1% to about 2% by weight, based on the total weight of the composition.

In some embodiments, the method is for stabilizing an aqueous pesticidal suspension composition comprising emamectin or salt thereof at about 5% to about 8% by weight, based on the total weight of the composition; optionally additives and optionally additional active ingredient by the addition of at least one polycationic type rheology modifier comprises monomers with ammonium, sulfonium or phosphonium moiety at about 1% to about 2% by weight, based on the total weight of the composition.

In some embodiments, the method is for stabilizing an aqueous pesticidal suspension composition comprising emamectin or salt thereof at about 7.5% by weight, based on the total weight of the composition; optionally additives and optionally additional active ingredient by the addition of at least one polycationic type rheology modifier comprises monomers with ammonium, sulfonium or phosphonium moiety at about 1% to about 2% by weight, based on the total weight of the composition.

In some embodiments, the method is for stabilizing an aqueous pesticidal suspension composition comprising emamectin or salt thereof at about 1% to about 20% by weight, based on the total weight of the composition; optionally additives and optionally additional active ingredient by the addition of at least one polycationic type rheology modifier comprises monomers with ammonium, sulfonium or phosphonium moiety at about 1.1% to about 1.7% by weight, based on the total weight of the composition.

In some embodiments, the method is for stabilizing an aqueous pesticidal suspension composition comprising emamectin or salt thereof at about 3% to about 10% by weight, based on the total weight of the composition; optionally additives and optionally additional active ingredient by the addition of at least one polycationic type rheology modifier comprises monomers with ammonium, sulfonium or phosphonium moiety at about 1.1% to about 1.7% by weight, based on the total weight of the composition.

In some embodiments, the method is for stabilizing an aqueous pesticidal suspension composition comprising emamectin or salt thereof at about 5% to about 8% by weight, based on the total weight of the composition; optionally additives and optionally additional active ingredient by the addition of at least one polycationic type rheology modifier comprises monomers with ammonium, sulfonium or phosphonium moiety at about 1.1% to about 1.7% by weight, based on the total weight of the composition.

In some embodiments, the method is for stabilizing an aqueous pesticidal suspension composition comprising emamectin or salt thereof at about 7.5% by weight, based on the total weight of the composition; optionally additives and optionally additional active ingredient by the addition of at least one polycationic type rheology modifier comprises monomers with ammonium, sulfonium or phosphonium moiety at about 1.1% to about 1.7% by weight, based on the total weight of the composition.

In some embodiments, the method is for stabilizing an aqueous pesticidal suspension composition comprising emamectin or salt thereof at about 1% to about 20% by weight, based on the total weight of the composition; optionally additives and optionally additional active ingredient by the addition of at least one polycationic type rheology modifier comprises monomers with ammonium, sulfonium or phosphonium moiety at about 1.2% by weight, based on the total weight of the composition.

In some embodiments, the method is for stabilizing an aqueous pesticidal suspension composition comprising emamectin or salt thereof at about 3% to about 10% by weight, based on the total weight of the composition; optionally additives and optionally additional active ingredient by the addition of at least one polycationic type rheology modifier comprises monomers with ammonium, sulfonium or phosphonium moiety at about 1.2% by weight, based on the total weight of the composition.

In some embodiments, the method is for stabilizing an aqueous pesticidal suspension composition comprising emamectin or salt thereof at about 5% to about 8% by weight, based on the total weight of the composition; optionally additives and optionally additional active ingredient by the addition of at least one polycationic type rheology modifier comprises monomers with ammonium, sulfonium or phosphonium moiety at about 1.2% by weight, based on the total weight of the composition.

In some embodiments, the method is for stabilizing an aqueous pesticidal suspension composition comprising emamectin or salt thereof at about 7.5% by weight, based on the total weight of the composition; optionally additives and optionally additional active ingredient by the addition of at least one polycationic type rheology modifier comprises monomers with ammonium, sulfonium or phosphonium moiety at about 1.2% by weight, based on the total weight of the composition.

In some embodiments, the method is for stabilizing an aqueous pesticidal suspension composition comprising emamectin or salt thereof at about 1% to about 20% by weight, based on the total weight of the composition; optionally additives and optionally additional active ingredient by the addition of at least one polycationic type rheology modifier comprises monomers with ammonium moiety at about 1% to about 3% by weight, based on the total weight of the composition.

In some embodiments, the method is for stabilizing an aqueous pesticidal suspension composition comprising emamectin or salt thereof at about 3% to about 10% by weight, based on the total weight of the composition; optionally additives and optionally additional active ingredient by the addition of at least one polycationic type rheology modifier comprises monomers with ammonium moiety at about 1% to about 3% by weight, based on the total weight of the composition.

In some embodiments, the method is for stabilizing an aqueous pesticidal suspension composition comprising emamectin or salt thereof at about 5% to about 8% by weight, based on the total weight of the composition; optionally additives and optionally additional active ingredient by the addition of at least one polycationic type rheology modifier comprises monomers with ammonium moiety at about 1% to about 3% by weight, based on the total weight of the composition.

In some embodiments, the method is for stabilizing an aqueous pesticidal suspension composition comprising emamectin or salt thereof at about 7.5% by weight, based on the total weight of the composition; optionally additives and optionally additional active ingredient by the addition of at least one polycationic type rheology modifier comprises monomers with ammonium moiety at about 1% to about 3% by weight, based on the total weight of the composition.

In some embodiments, the method is for stabilizing an aqueous pesticidal suspension composition comprising emamectin at about 1% to about 20% by weight, based on the total weight of the composition; optionally additives and optionally additional active ingredient by the addition of at least one polycationic type rheology modifier comprises monomers with ammonium moiety at about 1% to about 2% by weight, based on the total weight of the composition.

In some embodiments, the method is for stabilizing an aqueous pesticidal suspension composition comprising emamectin at about 3% to about 10% by weight, based on the total weight of the composition; optionally additives and optionally additional active ingredient by the addition of at least one polycationic type rheology modifier comprises monomers with ammonium moiety at about 1% to about 2% by weight, based on the total weight of the composition.

In some embodiments, the method is for stabilizing an aqueous pesticidal suspension composition comprising emamectin at about 5% to about 8% by weight, based on the total weight of the composition; optionally additives and optionally additional active ingredient by the addition of at least one polycationic type rheology modifier comprises monomers with ammonium moiety at about 1% to about 2% by weight, based on the total weight of the composition.

In some embodiments, the method is for stabilizing an aqueous pesticidal suspension composition comprising emamectin at about 7.5% by weight, based on the total weight of the composition; optionally additives and optionally additional active ingredient by the addition of at least one polycationic type rheology modifier comprises monomers with ammonium moiety at about 1% to about 2% by weight, based on the total weight of the composition.

In some embodiments, the method is for stabilizing an aqueous pesticidal suspension composition comprising emamectin or salt thereof at about 1% to about 20% by weight, based on the total weight of the composition; optionally additives and optionally additional active ingredient by the addition of at least one polycationic type rheology modifier comprises monomers with ammonium moiety at about 1.1% to about 1.7% by weight, based on the total weight of the composition.

In some embodiments, the method is for stabilizing an aqueous pesticidal suspension composition comprising emamectin or salt thereof at about 3% to about 10% by weight, based on the total weight of the composition; optionally additives and optionally additional active ingredient by the addition of at least one polycationic type rheology modifier comprises monomers with ammonium moiety at about 1.1% to about 1.7% by weight, based on the total weight of the composition.

In some embodiments, the method is for stabilizing an aqueous pesticidal suspension composition comprising emamectin or salt thereof at about 5% to about 8% by weight, based on the total weight of the composition; optionally additives and optionally additional active ingredient by the addition of at least one polycationic type rheology modifier comprises monomers with ammonium moiety at about 1.1% to about 1.7% by weight, based on the total weight of the composition.

In some embodiments, the method is for stabilizing an aqueous pesticidal suspension composition comprising emamectin or salt thereof at about 7.5% by weight, based on the total weight of the composition; optionally additives and optionally additional active ingredient by the addition of at least one polycationic type rheology modifier comprises monomers with ammonium moiety at about 1.1% to about 1.7% by weight, based on the total weight of the composition.

In some embodiments, the method is for stabilizing an aqueous pesticidal suspension composition comprising emamectin or salt thereof at about 1% to about 20% by weight, based on the total weight of the composition; optionally additives and optionally additional active ingredient by the addition of at least one polycationic type rheology modifier comprises monomers with ammonium moiety at about 1.2% by weight, based on the total weight of the composition.

In some embodiments, the method is for stabilizing an aqueous pesticidal suspension composition comprising emamectin or salt thereof at about 3% to about 10% by weight, based on the total weight of the composition; optionally additives and optionally additional active ingredient by the addition of at least one polycationic type rheology modifier comprises monomers with ammonium moiety at about 1.2% by weight, based on the total weight of the composition.

In some embodiments, the method is for stabilizing an aqueous pesticidal suspension composition comprising emamectin or salt thereof at about 5% to about 8% by weight, based on the total weight of the composition; optionally additives and optionally additional active ingredient by the addition of at least one polycationic type rheology modifier comprises monomers with ammonium moiety at about 1.2% by weight, based on the total weight of the composition.

In some embodiments, the method is for stabilizing an aqueous pesticidal suspension composition comprising emamectin or salt thereof at about 7.5% by weight, based on the total weight of the composition; optionally additives and optionally additional active ingredient by the addition of at least one polycationic type rheology modifier comprises monomers with ammonium moiety at about 1.2% by weight, based on the total weight of the composition.

In some embodiments, the method is for stabilizing an aqueous pesticidal suspension composition comprising emamectin or salt thereof at about 1% to about 20% by weight, based on the total weight of the composition; optionally additives and optionally additional active ingredient by the addition of at least one polycationic type rheology modifier comprises monomers with ammonium moiety is selected from polyquaterniums or polyquaternium esters polymers and combinations thereof at about 1% to about 3% by weight, based on the total weight of the composition.

In some embodiments, the method is for stabilizing an aqueous pesticidal suspension composition comprising emamectin or salt thereof at about 3% to about 10% by weight, based on the total weight of the composition; optionally additives and optionally additional active ingredient by the addition of at least one polycationic type rheology modifier comprises monomers with ammonium moiety is selected from polyquaterniums or polyquaternium esters polymers and combinations thereof at about 1% to about 3% by weight, based on the total weight of the composition.

In some embodiments, the method is for stabilizing an aqueous pesticidal suspension composition comprising emamectin or salt thereof at about 5% to about 8% by weight, based on the total weight of the composition; optionally additives and optionally additional active ingredient by the addition of at least one polycationic type rheology modifier comprises monomers with ammonium moiety is selected from polyquaterniums or polyquaternium esters polymers and combinations thereof at about 1% to about 3% by weight, based on the total weight of the composition.

In some embodiments, the method is for stabilizing an aqueous pesticidal suspension composition comprising emamectin or salt thereof at about 7.5% by weight, based on the total weight of the composition; optionally additives and optionally additional active ingredient by the addition of at least one polycationic type rheology modifier comprises monomers with ammonium moiety is selected from polyquaterniums or polyquaternium esters polymers and combinations thereof at about 1% to about 3% by weight, based on the total weight of the composition.

In some embodiments, the method is for stabilizing an aqueous pesticidal suspension composition comprising emamectin or salt thereof at about 1% to about 20% by weight, based on the total weight of the composition; optionally additives and optionally additional active ingredient by the addition of at least one polycationic type rheology modifier comprises monomers with ammonium moiety is selected from polyquaterniums or polyquaternium esters polymers and combinations thereof at about 1% to about 2% by weight, based on the total weight of the composition.

In some embodiments, the method is for stabilizing an aqueous pesticidal suspension composition comprising emamectin or salt thereof at about 3% to about 10% by weight, based on the total weight of the composition; optionally additives and optionally additional active ingredient by the addition of at least one polycationic type rheology modifier comprises monomers with ammonium moiety is selected from polyquaterniums or polyquaternium esters polymers and combinations thereof at about 1% to about 2% by weight, based on the total weight of the composition.

In some embodiments, the method is for stabilizing an aqueous pesticidal suspension composition comprising emamectin or salt thereof at about 5% to about 8% by weight, based on the total weight of the composition; optionally additives and optionally additional active ingredient by the addition of at least one polycationic type rheology modifier comprises monomers with ammonium moiety is selected from polyquaterniums or polyquaternium esters polymers and combinations thereof at about 1% to about 2% by weight, based on the total weight of the composition.

In some embodiments, the method is for stabilizing an aqueous pesticidal suspension composition comprising emamectin or salt thereof at about 7.5% to about 10% by weight, based on the total weight of the composition; optionally additives and optionally additional active ingredient by the addition of at least one polycationic type rheology modifier comprises monomers with ammonium moiety is selected from polyquaterniums or polyquaternium esters polymers and combinations thereof at about 1% to about 2% by weight, based on the total weight of the composition.

In some embodiments, the method is for stabilizing an aqueous pesticidal suspension composition comprising emamectin or salt thereof at about 1% to about 20% by weight, based on the total weight of the composition; optionally additives and optionally additional active ingredient by the addition of at least one polycationic type rheology modifier comprises monomers with ammonium moiety is selected from polyquaterniums or polyquaternium esters polymers and combinations thereof at about 1.1% to about 1.7% by weight, based on the total weight of the composition.

In some embodiments, the method is for stabilizing an aqueous pesticidal suspension composition comprising emamectin or salt thereof at about 3% to about 10% by weight, based on the total weight of the composition; optionally additives and optionally additional active ingredient by the addition of at least one polycationic type rheology modifier comprises monomers with ammonium moiety is selected from polyquaterniums or polyquaternium esters polymers and combinations thereof at about 1.1% to about 1.7% by weight, based on the total weight of the composition.

In some embodiments, the method is for stabilizing an aqueous pesticidal suspension composition comprising emamectin or salt thereof at about 5% to about 8% by weight, based on the total weight of the composition; optionally additives and optionally additional active ingredient by the addition of at least one polycationic type rheology modifier comprises monomers with ammonium moiety is selected from polyquaterniums or polyquaternium esters polymers and combinations thereof at about 1.1% to about 1.7% by weight, based on the total weight of the composition.

In some embodiments, the method is for stabilizing an aqueous pesticidal suspension composition comprising emamectin or salt thereof at about 7.5% by weight, based on the total weight of the composition; optionally additives and optionally additional active ingredient by the addition of at least one polycationic type rheology modifier comprises monomers with ammonium moiety is selected from polyquaterniums or polyquaternium esters polymers and combinations thereof at about 1.1% to about 1.7% by weight, based on the total weight of the composition.

In some embodiments, the method is for stabilizing an aqueous pesticidal suspension composition comprising emamectin or salt thereof at about 1% to about 20% by weight, based on the total weight of the composition; optionally additives and optionally additional active ingredient by the addition of at least one polycationic type rheology modifier comprises monomers with ammonium moiety is selected from polyquaterniums or polyquaternium esters polymers and combinations thereof at about 1.2% by weight, based on the total weight of the composition.

In some embodiments, the method is for stabilizing an aqueous pesticidal suspension composition comprising emamectin or salt thereof at about 3% to about 10% by weight, based on the total weight of the composition; optionally additives and optionally additional active ingredient by the addition of at least one polycationic type rheology modifier comprises monomers with ammonium moiety is selected from polyquaterniums or polyquaternium esters polymers and combinations thereof at about 1.2% by weight, based on the total weight of the composition.

In some embodiments, the method is for stabilizing an aqueous pesticidal suspension composition comprising emamectin or salt thereof at about 5% to about 8% by weight, based on the total weight of the composition; optionally additives and optionally additional active ingredient by the addition of at least one polycationic type rheology modifier comprises monomers with ammonium moiety is selected from polyquaterniums or polyquaternium esters polymers and combinations thereof at about 1.2% by weight, based on the total weight of the composition.

In some embodiments, the method is for stabilizing an aqueous pesticidal suspension composition comprising emamectin or salt thereof at about 7.5% by weight, based on the total weight of the composition; optionally additives and optionally additional active ingredient by the addition of at least one polycationic type rheology modifier comprises monomers with ammonium moiety is selected from polyquaterniums or polyquaternium esters polymers and combinations thereof at about 1.2% by weight, based on the total weight of the composition.

In some embodiments, the method is for stabilizing an aqueous pesticidal suspension composition comprising emamectin or salt thereof at about 1% to about 20% by weight, based on the total weight of the composition; optionally additives and optionally additional active ingredient by the addition of poly(2-methacryloxyethyltrimethylammonium chloride) at about 1% to about 3% by weight, based on the total weight of the composition.

In some embodiments, the method is for stabilizing an aqueous pesticidal suspension composition comprising emamectin or salt thereof at about 3% to about 10% by weight, based on the total weight of the composition; optionally additives and optionally additional active ingredient by the addition of poly(2-methacryloxyethyltrimethylammonium chloride) at about 1% to about 3% by weight, based on the total weight of the composition.

In some embodiments, the method is for stabilizing an aqueous pesticidal suspension composition comprising emamectin or salt thereof at about 5% to about 8% by weight, based on the total weight of the composition; optionally additives and optionally additional active ingredient by the addition of poly(2-methacryloxyethyltrimethylammonium chloride) at about 1% to about 3% by weight, based on the total weight of the composition.

In some embodiments, the method is for stabilizing an aqueous pesticidal suspension composition comprising emamectin or salt thereof at about 7.5% by weight, based on the total weight of the composition; optionally additives and optionally additional active ingredient by the addition of poly(2-methacryloxyethyltrimethylammonium chloride) at about 1% to about 3% by weight, based on the total weight of the composition.

In some embodiments, the method is for stabilizing an aqueous pesticidal suspension composition comprising emamectin or salt thereof at about 1% to about 20% by weight, based on the total weight of the composition; optionally additives and optionally additional active ingredient by the addition of poly(2-methacryloxyethyltrimethylammonium chloride) at about 1% to about 2% by weight, based on the total weight of the composition.

In some embodiments, the method is for stabilizing an aqueous pesticidal suspension composition comprising emamectin or salt thereof at about 3% to about 10% by weight, based on the total weight of the composition; optionally additives and optionally additional active ingredient by the addition of poly(2-methacryloxyethyltrimethylammonium chloride) at about 1% to about 2% by weight, based on the total weight of the composition.

In some embodiments, the method is for stabilizing an aqueous pesticidal suspension composition comprising emamectin or salt thereof at about 5% to about 8% by weight, based on the total weight of the composition; optionally additives and optionally additional active ingredient by the addition of poly(2-methacryloxyethyltrimethylammonium chloride) at about 1% to about 2% by weight, based on the total weight of the composition.

In some embodiments, the method is for stabilizing an aqueous pesticidal suspension composition comprising emamectin or salt thereof at about 7.5% by weight, based on the total weight of the composition; optionally additives and optionally additional active ingredient by the addition of poly(2-methacryloxyethyltrimethylammonium chloride) at about 1% to about 2% by weight, based on the total weight of the composition.

In some embodiments, the method is for stabilizing an aqueous pesticidal suspension composition comprising emamectin or salt thereof at about 1% to about 20% by weight, based on the total weight of the composition; optionally additives and optionally additional active ingredient by the addition of poly(2-methacryloxyethyltrimethylammonium chloride) at about 1.1% to about 1.7% by weight, based on the total weight of the composition.

In some embodiments, the method is for stabilizing an aqueous pesticidal suspension composition comprising emamectin or salt thereof at about 3% to about 10% by weight, based on the total weight of the composition; optionally additives and optionally additional active ingredient by the addition of poly(2-methacryloxyethyltrimethylammonium chloride) at about 1.1% to about 1.7% by weight, based on the total weight of the composition.

In some embodiments, the method is for stabilizing an aqueous pesticidal suspension composition comprising emamectin or salt thereof at about 5% to about 8% by weight, based on the total weight of the composition; optionally additives and optionally additional active ingredient by the addition of poly(2-methacryloxyethyltrimethylammonium chloride) at about 1.1% to about 1.7% by weight, based on the total weight of the composition.

In some embodiments, the method is for stabilizing an aqueous pesticidal suspension composition comprising emamectin or salt thereof at about 7.5% by weight, based on the total weight of the composition; optionally additives and optionally additional active ingredient by the addition of poly(2-methacryloxyethyltrimethylammonium chloride) at about 1.1% to about 1.7% by weight, based on the total weight of the composition.

In some embodiments, the method is for stabilizing an aqueous pesticidal suspension composition comprising emamectin or salt thereof at about 1% to about 20% by weight, based on the total weight of the composition; optionally additives and optionally additional active ingredient by the addition of poly(2-methacryloxyethyltrimethylammonium chloride) at about 1.2% by weight, based on the total weight of the composition.

In some embodiments, the method is for stabilizing an aqueous pesticidal suspension composition comprising emamectin or salt thereof at about 3% to about 10% by weight, based on the total weight of the composition; optionally additives and optionally additional active ingredient by the addition of poly(2-methacryloxyethyltrimethylammonium chloride) at about 1.2% by weight, based on the total weight of the composition.

In some embodiments, the method is for stabilizing an aqueous pesticidal suspension composition comprising emamectin or salt thereof at about 5% to about 8% by weight, based on the total weight of the composition; optionally additives and optionally additional active ingredient by the addition of poly(2-methacryloxyethyltrimethylammonium chloride) at about 1.2% by weight, based on the total weight of the composition.

In some embodiments, the method is for stabilizing an aqueous pesticidal suspension composition comprising emamectin or salt thereof at about 7.5% by weight, based on the total weight of the composition; optionally additives and optionally additional active ingredient by the addition of poly(2-methacryloxyethyltrimethylammonium chloride) at about 1.2% by weight, based on the total weight of the composition.

In some embodiments, the method is for stabilizing an aqueous pesticidal suspension composition comprising emamectin or salt thereof at about 1% to about 20% by weight, based on the total weight of the composition; optionally additives and optionally a diamide insecticide by the addition of at least one polycationic type rheology modifier at about 1% to about 3% by weight, based on the total weight of the composition.

In some embodiments, the method is for stabilizing an aqueous pesticidal suspension composition comprising emamectin or salt thereof at about 3% to about 10% by weight, based on the total weight of the composition; optionally additives and optionally a diamide insecticide by the addition of at least one polycationic type rheology modifier at about 1% to about 3% by weight, based on the total weight of the composition.

In some embodiments, the method is for stabilizing an aqueous pesticidal suspension composition comprising emamectin or salt thereof at about 5% to about 8% by weight, based on the total weight of the composition; optionally additives and optionally a diamide insecticide by the addition of at least one polycationic type rheology modifier at about 1% to about 3% by weight, based on the total weight of the composition.

In some embodiments, the method is for stabilizing an aqueous pesticidal suspension composition comprising emamectin or salt thereof at about 7.5% by weight, based on the total weight of the composition; optionally additives and optionally a diamide insecticide by the addition of at least one polycationic type rheology modifier at about 1% to about 3% by weight, based on the total weight of the composition.

In some embodiments, the method is for stabilizing an aqueous pesticidal suspension composition comprising emamectin or salt thereof at about 1% to about 20% by weight, based on the total weight of the composition; optionally additives and optionally a diamide insecticide by the addition of at least one polycationic type rheology modifier at about 1% to about 2% by weight, based on the total weight of the composition.

In some embodiments, the method is for stabilizing an aqueous pesticidal suspension composition comprising emamectin or salt thereof at about 3% to about 10% by weight, based on the total weight of the composition; optionally additives and optionally a diamide insecticide by the addition of at least one polycationic type rheology modifier at about 1% to about 2% by weight, based on the total weight of the composition.

In some embodiments, the method is for stabilizing an aqueous pesticidal suspension composition comprising emamectin or salt thereof at about 5% to about 8% by weight, based on the total weight of the composition; optionally additives and optionally a diamide insecticide by the addition of at least one polycationic type rheology modifier at about 1% to about 2% by weight, based on the total weight of the composition.

In some embodiments, the method is for stabilizing an aqueous pesticidal suspension composition comprising emamectin or salt thereof at about 7.5% by weight, based on the total weight of the composition; optionally additives and optionally a diamide insecticide by the addition of at least one polycationic type rheology modifier at about 1% to about 2% by weight, based on the total weight of the composition.

In some embodiments, the method is for stabilizing an aqueous pesticidal suspension composition comprising emamectin or salt thereof at about 1% to about 20% by weight, based on the total weight of the composition; optionally additives and optionally a diamide insecticide by the addition of at least one polycationic type rheology modifier at about 1.1% to about 1.7% by weight, based on the total weight of the composition.

In some embodiments, the method is for stabilizing an aqueous pesticidal suspension composition comprising emamectin or salt thereof at about 3% to about 10% by weight, based on the total weight of the composition; optionally additives and optionally a diamide insecticide by the addition of at least one polycationic type rheology modifier at about 1.1% to about 1.7% by weight, based on the total weight of the composition.

In some embodiments, the method is for stabilizing an aqueous pesticidal suspension composition comprising emamectin or salt thereof at about 5% to about 8% by weight, based on the total weight of the composition; optionally additives and optionally a diamide insecticide by the addition of at least one polycationic type rheology modifier at about 1.1% to about 1.7% by weight, based on the total weight of the composition.

In some embodiments, the method is for stabilizing an aqueous pesticidal suspension composition comprising emamectin or salt thereof at about 7.5% by weight, based on the total weight of the composition; optionally additives and optionally a diamide insecticide by the addition of at least one polycationic type rheology modifier at about 1.1% to about 1.7% by weight, based on the total weight of the composition.

In some embodiments, the method is for stabilizing an aqueous pesticidal suspension composition comprising emamectin or salt thereof at about 1% to about 20% by weight, based on the total weight of the composition; optionally additives and optionally a diamide insecticide by the addition of at least one polycationic type rheology modifier at about 1.2% by weight, based on the total weight of the composition.

In some embodiments, the method is for stabilizing an aqueous pesticidal suspension composition comprising emamectin or salt thereof at about 3% to about 10% by weight, based on the total weight of the composition; optionally additives and optionally a diamide insecticide by the addition of at least one polycationic type rheology modifier at about 1.2% by weight, based on the total weight of the composition.

In some embodiments, the method is for stabilizing an aqueous pesticidal suspension composition comprising emamectin or salt thereof at about 5% to about 8% by weight, based on the total weight of the composition; optionally additives and optionally a diamide insecticide by the addition of at least one polycationic type rheology modifier at about 1.2% by weight, based on the total weight of the composition.

In some embodiments, the method is for stabilizing an aqueous pesticidal suspension composition comprising emamectin or salt thereof at about 7.5% by weight, based on the total weight of the composition; optionally additives and optionally a diamide insecticide by the addition of at least one polycationic type rheology modifier at about 1.2% by weight, based on the total weight of the composition.

In some embodiments, the method is for stabilizing an aqueous pesticidal suspension composition comprising emamectin or salt thereof at about 1% to about 20% by weight, based on the total weight of the composition; optionally additives and optionally a diamide insecticide by the addition of at least one polycationic type rheology modifier comprises monomers with ammonium, sulfonium or phosphonium moiety at about 1% to about 3% by weight, based on the total weight of the composition.

In some embodiments, the method is for stabilizing an aqueous pesticidal suspension composition comprising emamectin or salt thereof at about 3% to about 10% by weight, based on the total weight of the composition; optionally additives and optionally a diamide insecticide by the addition of at least one polycationic type rheology modifier comprises monomers with ammonium, sulfonium or phosphonium moiety at about 1% to about 3% by weight, based on the total weight of the composition.

In some embodiments, the method is for stabilizing an aqueous pesticidal suspension composition comprising emamectin or salt thereof at about 5% to about 8% by weight, based on the total weight of the composition; optionally additives and optionally a diamide insecticide by the addition of at least one polycationic type rheology modifier comprises monomers with ammonium, sulfonium or phosphonium moiety at about 1% to about 3% by weight, based on the total weight of the composition.

In some embodiments, the method is for stabilizing an aqueous pesticidal suspension composition comprising emamectin or salt thereof at about 7.5% by weight, based on the total weight of the composition; optionally additives and optionally a diamide insecticide by the addition of at least one polycationic type rheology modifier comprises monomers with ammonium, sulfonium or phosphonium moiety at about 1% to about 3% by weight, based on the total weight of the composition.

In some embodiments, the method is for stabilizing an aqueous pesticidal suspension composition comprising emamectin or salt thereof at about 1% to about 20% by weight, based on the total weight of the composition; optionally additives and optionally a diamide insecticide by the addition of at least one polycationic type rheology modifier comprises monomers with ammonium, sulfonium or phosphonium moiety at about 1% to about 2% by weight, based on the total weight of the composition.

In some embodiments, the method is for stabilizing an aqueous pesticidal suspension composition comprising emamectin or salt thereof at about 3% to about 10% by weight, based on the total weight of the composition; optionally additives and optionally a diamide insecticide by the addition of at least one polycationic type rheology modifier comprises monomers with ammonium, sulfonium or phosphonium moiety at about 1% to about 2% by weight, based on the total weight of the composition.

In some embodiments, the method is for stabilizing an aqueous pesticidal suspension composition comprising emamectin or salt thereof at about 5% to about 8% by weight, based on the total weight of the composition; optionally additives and optionally a diamide insecticide by the addition of at least one polycationic type rheology modifier comprises monomers with ammonium, sulfonium or phosphonium moiety at about 1% to about 2% by weight, based on the total weight of the composition.

In some embodiments, the method is for stabilizing an aqueous pesticidal suspension composition comprising emamectin or salt thereof at about 7.5% by weight, based on the total weight of the composition; optionally additives and optionally a diamide insecticide by the addition of at least one polycationic type rheology modifier comprises monomers with ammonium, sulfonium or phosphonium moiety at about 1% to about 2% by weight, based on the total weight of the composition.

In some embodiments, the method is for stabilizing an aqueous pesticidal suspension composition comprising emamectin or salt thereof at about 1% to about 20% by weight, based on the total weight of the composition; optionally additives and optionally a diamide insecticide by the addition of at least one polycationic type rheology modifier comprises monomers with ammonium, sulfonium or phosphonium moiety at about 1.1% to about 1.7% by weight, based on the total weight of the composition.

In some embodiments, the method is for stabilizing an aqueous pesticidal suspension composition comprising emamectin or salt thereof at about 3% to about 10% by weight, based on the total weight of the composition; optionally additives and optionally a diamide insecticide by the addition of at least one polycationic type rheology modifier comprises monomers with ammonium, sulfonium or phosphonium moiety at about 1.1% to about 1.7% by weight, based on the total weight of the composition.

In some embodiments, the method is for stabilizing an aqueous pesticidal suspension composition comprising emamectin or salt thereof at about 5% to about 8% by weight, based on the total weight of the composition; optionally additives and optionally a diamide insecticide by the addition of at least one polycationic type rheology modifier comprises monomers with ammonium, sulfonium or phosphonium moiety at about 1.1% to about 1.7% by weight, based on the total weight of the composition.

In some embodiments, the method is for stabilizing an aqueous pesticidal suspension composition comprising emamectin or salt thereof at about 7.5% by weight, based on the total weight of the composition; optionally additives and optionally a diamide insecticide by the addition of at least one polycationic type rheology modifier comprises monomers with ammonium, sulfonium or phosphonium moiety at about 1.1% to about 1.7% by weight, based on the total weight of the composition.

In some embodiments, the method is for stabilizing an aqueous pesticidal suspension composition comprising emamectin or salt thereof at about 1% to about 20% by weight, based on the total weight of the composition; optionally additives and optionally a diamide insecticide by the addition of at least one polycationic type rheology modifier comprises monomers with ammonium, sulfonium or phosphonium moiety at about 1.2% by weight, based on the total weight of the composition.

In some embodiments, the method is for stabilizing an aqueous pesticidal suspension composition comprising emamectin or salt thereof at about 3% to about 10% by weight, based on the total weight of the composition; optionally additives and optionally a diamide insecticide by the addition of at least one polycationic type rheology modifier comprises monomers with ammonium, sulfonium or phosphonium moiety at about 1.2% by weight, based on the total weight of the composition.

In some embodiments, the method is for stabilizing an aqueous pesticidal suspension composition comprising emamectin or salt thereof at about 5% to about 8% by weight, based on the total weight of the composition; optionally additives and optionally a diamide insecticide by the addition of at least one polycationic type rheology modifier comprises monomers with ammonium, sulfonium or phosphonium moiety at about 1.2% by weight, based on the total weight of the composition.

In some embodiments, the method is for stabilizing an aqueous pesticidal suspension composition comprising emamectin or salt thereof at about 7.5% by weight, based on the total weight of the composition; optionally additives and optionally a diamide insecticide by the addition of at least one polycationic type rheology modifier comprises monomers with ammonium, sulfonium or phosphonium moiety at about 1.2% by weight, based on the total weight of the composition.

In some embodiments, the method is for stabilizing an aqueous pesticidal suspension composition comprising emamectin or salt thereof at about 1% to about 20% by weight, based on the total weight of the composition; optionally additives and optionally a diamide insecticide by the addition of at least one polycationic type rheology modifier comprises monomers with ammonium moiety at about 1% to about 3% by weight, based on the total weight of the composition.

In some embodiments, the method is for stabilizing an aqueous pesticidal suspension composition comprising emamectin or salt thereof at about 3% to about 10% by weight, based on the total weight of the composition; optionally additives and optionally a diamide insecticide by the addition of at least one polycationic type rheology modifier comprises monomers with ammonium moiety at about 1% to about 3% by weight, based on the total weight of the composition.

In some embodiments, the method is for stabilizing an aqueous pesticidal suspension composition comprising emamectin or salt thereof at about 5% to about 8% by weight, based on the total weight of the composition; optionally additives and optionally a diamide insecticide by the addition of at least one polycationic type rheology modifier comprises monomers with ammonium moiety at about 1% to about 3% by weight, based on the total weight of the composition.

In some embodiments, the method is for stabilizing an aqueous pesticidal suspension composition comprising emamectin or salt thereof at about 7.5% by weight, based on the total weight of the composition; optionally additives and optionally a diamide insecticide by the addition of at least one polycationic type rheology modifier comprises monomers with ammonium moiety at about 1% to about 3% by weight, based on the total weight of the composition.

In some embodiments, the method is for stabilizing an aqueous pesticidal suspension composition comprising emamectin at about 1% to about 20% by weight, based on the total weight of the composition; optionally additives and optionally a diamide insecticide by the addition of at least one polycationic type rheology modifier comprises monomers with ammonium moiety at about 1% to about 2% by weight, based on the total weight of the composition.

In some embodiments, the method is for stabilizing an aqueous pesticidal suspension composition comprising emamectin at about 3% to about 10% by weight, based on the total weight of the composition; optionally additives and optionally a diamide insecticide by the addition of at least one polycationic type rheology modifier comprises monomers with ammonium moiety at about 1% to about 2% by weight, based on the total weight of the composition.

In some embodiments, the method is for stabilizing an aqueous pesticidal suspension composition comprising emamectin at about 5% to about 8% by weight, based on the total weight of the composition; optionally additives and optionally a diamide insecticide by the addition of at least one polycationic type rheology modifier comprises monomers with ammonium moiety at about 1% to about 2% by weight, based on the total weight of the composition.

In some embodiments, the method is for stabilizing an aqueous pesticidal suspension composition comprising emamectin at about 7.5% by weight, based on the total weight of the composition; optionally additives and optionally a diamide insecticide by the addition of at least one polycationic type rheology modifier comprises monomers with ammonium moiety at about 1% to about 2% by weight, based on the total weight of the composition.

In some embodiments, the method is for stabilizing an aqueous pesticidal suspension composition comprising emamectin or salt thereof at about 1% to about 20% by weight, based on the total weight of the composition; optionally additives and optionally a diamide insecticide by the addition of at least one polycationic type rheology modifier comprises monomers with ammonium moiety at about 1.1% to about 1.7% by weight, based on the total weight of the composition.

In some embodiments, the method is for stabilizing an aqueous pesticidal suspension composition comprising emamectin or salt thereof at about 3% to about 10% by weight, based on the total weight of the composition; optionally additives and optionally a diamide insecticide by the addition of at least one polycationic type rheology modifier comprises monomers with ammonium moiety at about 1.1% to about 1.7% by weight, based on the total weight of the composition.

In some embodiments, the method is for stabilizing an aqueous pesticidal suspension composition comprising emamectin or salt thereof at about 5% to about 8% by weight, based on the total weight of the composition; optionally additives and optionally a diamide insecticide by the addition of at least one polycationic type rheology modifier comprises monomers with ammonium moiety at about 1.1% to about 1.7% by weight, based on the total weight of the composition.

In some embodiments, the method is for stabilizing an aqueous pesticidal suspension composition comprising emamectin or salt thereof at about 7.5% by weight, based on the total weight of the composition; optionally additives and optionally a diamide insecticide by the addition of at least one polycationic type rheology modifier comprises monomers with ammonium moiety at about 1.1% to about 1.7% by weight, based on the total weight of the composition.

In some embodiments, the method is for stabilizing an aqueous pesticidal suspension composition comprising emamectin or salt thereof at about 1% to about 20% by weight, based on the total weight of the composition; optionally additives and optionally a diamide insecticide by the addition of at least one polycationic type rheology modifier comprises monomers with ammonium moiety at about 1.2% by weight, based on the total weight of the composition.

In some embodiments, the method is for stabilizing an aqueous pesticidal suspension composition comprising emamectin or salt thereof at about 3% to about 10% by weight, based on the total weight of the composition; optionally additives and optionally a diamide insecticide by the addition of at least one polycationic type rheology modifier comprises monomers with ammonium moiety at about 1.2% by weight, based on the total weight of the composition.

In some embodiments, the method is for stabilizing an aqueous pesticidal suspension composition comprising emamectin or salt thereof at about 5% to about 8% by weight, based on the total weight of the composition; optionally additives and optionally a diamide insecticide by the addition of at least one polycationic type rheology modifier comprises monomers with ammonium moiety at about 1.2% by weight, based on the total weight of the composition.

In some embodiments, the method is for stabilizing an aqueous pesticidal suspension composition comprising emamectin or salt thereof at about 7.5% by weight, based on the total weight of the composition; optionally additives and optionally a diamide insecticide by the addition of at least one polycationic type rheology modifier comprises monomers with ammonium moiety at about 1.2% by weight, based on the total weight of the composition.

In some embodiments, the method is for stabilizing an aqueous pesticidal suspension composition comprising emamectin or salt thereof at about 1% to about 20% by weight, based on the total weight of the composition; optionally additives and optionally a diamide insecticide by the addition of at least one polycationic type rheology modifier comprises monomers with ammonium moiety is selected from polyquaterniums or polyquaternium esters polymers and combinations thereof at about 1% to about 3% by weight, based on the total weight of the composition.

In some embodiments, the method is for stabilizing an aqueous pesticidal suspension composition comprising emamectin or salt thereof at about 3% to about 10% by weight, based on the total weight of the composition; optionally additives and optionally a diamide insecticide by the addition of at least one polycationic type rheology modifier comprises monomers with ammonium moiety is selected from polyquaterniums or polyquaternium esters polymers and combinations thereof at about 1% to about 3% by weight, based on the total weight of the composition.

In some embodiments, the method is for stabilizing an aqueous pesticidal suspension composition comprising emamectin or salt thereof at about 5% to about 8% by weight, based on the total weight of the composition; optionally additives and optionally a diamide insecticide by the addition of at least one polycationic type rheology modifier comprises monomers with ammonium moiety is selected from polyquaterniums or polyquaternium esters polymers and combinations thereof at about 1% to about 3% by weight, based on the total weight of the composition.

In some embodiments, the method is for stabilizing an aqueous pesticidal suspension composition comprising emamectin or salt thereof at about 7.5% by weight, based on the total weight of the composition; optionally additives and optionally a diamide insecticide by the addition of at least one polycationic type rheology modifier comprises monomers with ammonium moiety is selected from polyquaterniums or polyquaternium esters polymers and combinations thereof at about 1% to about 3% by weight, based on the total weight of the composition.

In some embodiments, the method is for stabilizing an aqueous pesticidal suspension composition comprising emamectin or salt thereof at about 1% to about 20% by weight, based on the total weight of the composition; optionally additives and optionally a diamide insecticide by the addition of at least one polycationic type rheology modifier comprises monomers with ammonium moiety is selected from polyquaterniums or polyquaternium esters polymers and combinations thereof at about 1% to about 2% by weight, based on the total weight of the composition.

In some embodiments, the method is for stabilizing an aqueous pesticidal suspension composition comprising emamectin or salt thereof at about 3% to about 10% by weight, based on the total weight of the composition; optionally additives and optionally a diamide insecticide by the addition of at least one polycationic type rheology modifier comprises monomers with ammonium moiety is selected from polyquaterniums or polyquaternium esters polymers and combinations thereof at about 1% to about 2% by weight, based on the total weight of the composition.

In some embodiments, the method is for stabilizing an aqueous pesticidal suspension composition comprising emamectin or salt thereof at about 5% to about 8% by weight, based on the total weight of the composition; optionally additives and optionally a diamide insecticide by the addition of at least one polycationic type rheology modifier comprises monomers with ammonium moiety is selected from polyquaterniums or polyquaternium esters polymers and combinations thereof at about 1% to about 2% by weight, based on the total weight of the composition.

In some embodiments, the method is for stabilizing an aqueous pesticidal suspension composition comprising emamectin or salt thereof at about 7.5% by weight, based on the total weight of the composition; optionally additives and optionally a diamide insecticide by the addition of at least one polycationic type rheology modifier comprises monomers with ammonium moiety is selected from polyquaterniums or polyquaternium esters polymers and combinations thereof at about 1% to about 2% by weight, based on the total weight of the composition.

In some embodiments, the method is for stabilizing an aqueous pesticidal suspension composition comprising emamectin or salt thereof at about 1% to about 20% by weight, based on the total weight of the composition; optionally additives and optionally a diamide insecticide by the addition of at least one polycationic type rheology modifier comprises monomers with ammonium moiety is selected from polyquaterniums or polyquaternium esters polymers and combinations thereof at about 1.1% to about 1.7% by weight, based on the total weight of the composition.

In some embodiments, the method is for stabilizing an aqueous pesticidal suspension composition comprising emamectin or salt thereof at about 3% to about 10% by weight, based on the total weight of the composition; optionally additives and optionally a diamide insecticide by the addition of at least one polycationic type rheology modifier comprises monomers with ammonium moiety is selected from polyquaterniums or polyquaternium esters polymers and combinations thereof at about 1.1% to about 1.7% by weight, based on the total weight of the composition.

In some embodiments, the method is for stabilizing an aqueous pesticidal suspension composition comprising emamectin or salt thereof at about 5% to about 8% by weight, based on the total weight of the composition; optionally additives and optionally a diamide insecticide by the addition of at least one polycationic type rheology modifier comprises monomers with ammonium moiety is selected from polyquaterniums or polyquaternium esters polymers and combinations thereof at about 1.1% to about 1.7% by weight, based on the total weight of the composition.

In some embodiments, the method is for stabilizing an aqueous pesticidal suspension composition comprising emamectin or salt thereof at about 7.5% by weight, based on the total weight of the composition; optionally additives and optionally a diamide insecticide by the addition of at least one polycationic type rheology modifier comprises monomers with ammonium moiety is selected from polyquaterniums or polyquaternium esters polymers and combinations thereof at about 1.1% to about 1.7% by weight, based on the total weight of the composition.

In some embodiments, the method is for stabilizing an aqueous pesticidal suspension composition comprising emamectin or salt thereof at about 1% to about 20% by weight, based on the total weight of the composition; optionally additives and optionally a diamide insecticide by the addition of at least one polycationic type rheology modifier comprises monomers with ammonium moiety is selected from polyquaterniums or polyquaternium esters polymers and combinations thereof at about 1.2% by weight, based on the total weight of the composition.

In some embodiments, the method is for stabilizing an aqueous pesticidal suspension composition comprising emamectin or salt thereof at about 3% to about 10% by weight, based on the total weight of the composition; optionally additives and optionally a diamide insecticide by the addition of at least one polycationic type rheology modifier comprises monomers with ammonium moiety is selected from polyquaterniums or polyquaternium esters polymers and combinations thereof at about 1.2% by weight, based on the total weight of the composition.

In some embodiments, the method is for stabilizing an aqueous pesticidal suspension composition comprising emamectin or salt thereof at about 5% to about 8% by weight, based on the total weight of the composition; optionally additives and optionally a diamide insecticide by the addition of at least one polycationic type rheology modifier comprises monomers with ammonium moiety is selected from polyquaterniums or polyquaternium esters polymers and combinations thereof at about 1.2% by weight, based on the total weight of the composition.

In some embodiments, the method is for stabilizing an aqueous pesticidal suspension composition comprising emamectin or salt thereof at about 7.5% by weight, based on the total weight of the composition; optionally additives and optionally a diamide insecticide by the addition of at least one polycationic type rheology modifier comprises monomers with ammonium moiety is selected from polyquaterniums or polyquaternium esters polymers and combinations thereof at about 1.2% by weight, based on the total weight of the composition.

In some embodiments, the method is for stabilizing an aqueous pesticidal suspension composition comprising emamectin or salt thereof at about 1% to about 20% by weight, based on the total weight of the composition; optionally additives and optionally a diamide insecticide by the addition of poly(2-methacryloxyethyltrimethylammonium chloride) at about 1% to about 3% by weight, based on the total weight of the composition.

In some embodiments, the method is for stabilizing an aqueous pesticidal suspension composition comprising emamectin or salt thereof at about 3% to about 10% by weight, based on the total weight of the composition; optionally additives and optionally a diamide insecticide by the addition of poly(2-methacryloxyethyltrimethylammonium chloride) at about 1% to about 3% by weight, based on the total weight of the composition.

In some embodiments, the method is for stabilizing an aqueous pesticidal suspension composition comprising emamectin or salt thereof at about 5% to about 8% by weight, based on the total weight of the composition; optionally additives and optionally a diamide insecticide by the addition of poly(2-methacryloxyethyltrimethylammonium chloride) at about 1% to about 3% by weight, based on the total weight of the composition.

In some embodiments, the method is for stabilizing an aqueous pesticidal suspension composition comprising emamectin or salt thereof at about 7.5% by weight, based on the total weight of the composition; optionally additives and optionally a diamide insecticide by the addition of poly(2-methacryloxyethyltrimethylammonium chloride) at about 1% to about 3% by weight, based on the total weight of the composition.

In some embodiments, the method is for stabilizing an aqueous pesticidal suspension composition comprising emamectin or salt thereof at about 1% to about 20% by weight, based on the total weight of the composition; optionally additives and optionally a diamide insecticide by the addition of poly(2-methacryloxyethyltrimethylammonium chloride) at about 1% to about 2% by weight, based on the total weight of the composition.

In some embodiments, the method is for stabilizing an aqueous pesticidal suspension composition comprising emamectin or salt thereof at about 3% to about 10% by weight, based on the total weight of the composition; optionally additives and optionally a diamide insecticide by the addition of poly(2-methacryloxyethyltrimethylammonium chloride) at about 1% to about 2% by weight, based on the total weight of the composition.

In some embodiments, the method is for stabilizing an aqueous pesticidal suspension composition comprising emamectin or salt thereof at about 5% to about 8% by weight, based on the total weight of the composition; optionally additives and optionally a diamide insecticide by the addition of poly(2-methacryloxyethyltrimethylammonium chloride) at about 1% to about 2% by weight, based on the total weight of the composition.

In some embodiments, the method is for stabilizing an aqueous pesticidal suspension composition comprising emamectin or salt thereof at about 7.5% by weight, based on the total weight of the composition; optionally additives and optionally a diamide insecticide by the addition of poly(2-methacryloxyethyltrimethylammonium chloride) at about 1% to about 2% by weight, based on the total weight of the composition.

In some embodiments, the method is for stabilizing an aqueous pesticidal suspension composition comprising emamectin or salt thereof at about 1% to about 20% by weight, based on the total weight of the composition; optionally additives and optionally a diamide insecticide by the addition of poly(2-methacryloxyethyltrimethylammonium chloride) at about 1.1% to about 1.7% by weight, based on the total weight of the composition.

In some embodiments, the method is for stabilizing an aqueous pesticidal suspension composition comprising emamectin or salt thereof at about 3% to about 10% by weight, based on the total weight of the composition; optionally additives and optionally a diamide insecticide by the addition of poly(2-methacryloxyethyltrimethylammonium chloride) at about 1.1% to about 1.7% by weight, based on the total weight of the composition.

In some embodiments, the method is for stabilizing an aqueous pesticidal suspension composition comprising emamectin or salt thereof at about 5% to about 8% by weight, based on the total weight of the composition; optionally additives and optionally a diamide insecticide by the addition of poly(2-methacryloxyethyltrimethylammonium chloride) at about 1.1% to about 1.7% by weight, based on the total weight of the composition.

In some embodiments, the method is for stabilizing an aqueous pesticidal suspension composition comprising emamectin or salt thereof at about 7.5% by weight, based on the total weight of the composition; optionally additives and optionally a diamide insecticide by the addition of poly(2-methacryloxyethyltrimethylammonium chloride) at about 1.1% to about 1.7% by weight, based on the total weight of the composition.

In some embodiments, the method is for stabilizing an aqueous pesticidal suspension composition comprising emamectin or salt thereof at about 1% to about 20% by weight, based on the total weight of the composition; optionally additives and optionally a diamide insecticide by the addition of poly(2-methacryloxyethyltrimethylammonium chloride) at about 1.2% by weight, based on the total weight of the composition.

In some embodiments, the method is for stabilizing an aqueous pesticidal suspension composition comprising emamectin or salt thereof at about 3% to about 10% by weight, based on the total weight of the composition; optionally additives and optionally a diamide insecticide by the addition of poly(2-methacryloxyethyltrimethylammonium chloride) at about 1.2% by weight, based on the total weight of the composition.

In some embodiments, the method is for stabilizing an aqueous pesticidal suspension composition comprising emamectin or salt thereof at about 5% to about 8% by weight, based on the total weight of the composition; optionally additives and optionally a diamide insecticide by the addition of poly(2-methacryloxyethyltrimethylammonium chloride) at about 1.2% by weight, based on the total weight of the composition.

In some embodiments, the method is for stabilizing an aqueous pesticidal suspension composition comprising emamectin or salt thereof at about 7.5% by weight, based on the total weight of the composition; optionally additives and optionally a diamide insecticide by the addition of poly(2-methacryloxyethyltrimethylammonium chloride) at about 1.2% by weight, based on the total weight of the composition.

In some embodiments, the method is for stabilizing an aqueous pesticidal suspension composition comprising emamectin or salt thereof at about 1% to of about 20% by weight, based on the total weight of the composition; optionally additives and optionally chlorantraniliprole at about 1% to of about 60% by weight, based on the total weight of the composition by the addition of at least one polycationic type rheology modifier at about 1.1% to of about 1.7% by weight, based on the total weight of the composition.

In some embodiments, the method is for stabilizing an aqueous pesticidal suspension composition comprising emamectin or salt thereof at about 1% to of about 20% by weight, based on the total weight of the composition; optionally additives and optionally chlorantraniliprole at about 1% to of about 20% by weight, based on the total weight of the composition by the addition of at least one polycationic type rheology modifier at about 1.1% to of about 1.7% by weight, based on the total weight of the composition.

In some embodiments, the method is for stabilizing an aqueous pesticidal suspension composition comprising emamectin or salt thereof at about 7.5% by weight, based on the total weight of the composition; optionally additives and optionally chlorantraniliprole at about 15% by weight, based on the total weight of the composition by the addition of at least one polycationic type rheology modifier at about 1.2% by weight, based on the total weight of the composition.

In some embodiments, the method is for stabilizing an aqueous pesticidal suspension composition comprising emamectin or salt thereof at about 1% to of about 20% by weight, based on the total weight of the composition; optionally additives and optionally chlorantraniliprole at about 1% to of about 60% by weight, based on the total weight of the composition by the addition of at least one polycationic type rheology modifier comprises monomers with ammonium, sulfonium or phosphonium moiety at about 1.1% to of about 1.7% by weight, based on the total weight of the composition.

In some embodiments, the method is for stabilizing an aqueous pesticidal suspension composition comprising emamectin or salt thereof at about 1% to of about 20% by weight, based on the total weight of the composition; optionally additives and optionally chlorantraniliprole at about 1% to of about 20% by weight, based on the total weight of the composition by the addition of at least one polycationic type rheology modifier comprises monomers with ammonium, sulfonium or phosphonium moiety at about 1.1% to of about 1.7% by weight, based on the total weight of the composition.

In some embodiments, the method is for stabilizing an aqueous pesticidal suspension composition comprising emamectin or salt thereof at about 7.5% by weight, based on the total weight of the composition; optionally additives and optionally chlorantraniliprole at about 15% by weight, based on the total weight of the composition by the addition of at least one polycationic type rheology modifier comprises monomers with ammonium, sulfonium or phosphonium moiety at about 1.2% by weight, based on the total weight of the composition.

In some embodiments, the method is for stabilizing an aqueous pesticidal suspension composition comprising emamectin or salt thereof at about 1% to of about 20% by weight, based on the total weight of the composition; optionally additives and optionally chlorantraniliprole at about 1% to of about 60% by weight, based on the total weight of the composition by the addition of at least one polycationic type rheology modifier comprises monomers with ammonium moiety at about 1.1% to of about 1.7% by weight, based on the total weight of the composition.

In some embodiments, the method is for stabilizing an aqueous pesticidal suspension composition comprising emamectin or salt thereof at about 1% to of about 20% by weight, based on the total weight of the composition; optionally additives and optionally chlorantraniliprole at about 1% to of about 20% by weight, based on the total weight of the composition by the addition of at least one polycationic type rheology modifier comprises monomers with ammonium moiety at about 1.1% to of about 1.7% by weight, based on the total weight of the composition.

In some embodiments, the method is for stabilizing an aqueous pesticidal suspension composition comprising emamectin or salt thereof at about 7.5% by weight, based on the total weight of the composition; optionally additives and optionally chlorantraniliprole at about 15% by weight, based on the total weight of the composition by the addition of at least one polycationic type rheology modifier comprises monomers with ammonium moiety at about 1.2% by weight, based on the total weight of the composition.

In some embodiments, the method is for stabilizing an aqueous pesticidal suspension composition comprising emamectin or salt thereof at about 1% to of about 20% by weight, based on the total weight of the composition; optionally additives and optionally chlorantraniliprole at about 1% to of about 60% by weight, based on the total weight of the composition by the addition of at least one polycationic type rheology modifier comprises monomers with ammonium moiety is selected from polyquaterniums or polyquaternium esters polymers and combinations thereof at about 1.1% to of about 1.7% by weight, based on the total weight of the composition.

In some embodiments, the method is for stabilizing an aqueous pesticidal suspension composition comprising emamectin or salt thereof at about 1% to of about 20% by weight, based on the total weight of the composition; optionally additives and optionally chlorantraniliprole at about 1% to of about 20% by weight, based on the total weight of the composition by the addition of at least one polycationic type rheology modifier comprises monomers with ammonium moiety is selected from polyquaterniums or polyquaternium esters polymers and combinations thereof at about 1.1% to of about 1.7% by weight, based on the total weight of the composition.

In some embodiments, the method is for stabilizing an aqueous pesticidal suspension composition comprising emamectin or salt thereof at about 7.5% by weight, based on the total weight of the composition; optionally additives and optionally chlorantraniliprole at about 15% by weight, based on the total weight of the composition by the addition of at least one polycationic type rheology modifier comprises monomers with ammonium moiety is selected from polyquaterniums or polyquaternium esters polymers and combinations thereof at about 1.2% by weight, based on the total weight of the composition.

In some embodiments, the method is for stabilizing an aqueous pesticidal suspension composition comprising emamectin or salt thereof at about 1% to of about 20% by weight, based on the total weight of the composition; optionally additives and optionally chlorantraniliprole at about 1% to of about 60% by weight, based on the total weight of the composition by the addition of poly(2-methacryloxyethyltrimethylammonium chloride) at about 1.1% to of about 1.7% by weight, based on the total weight of the composition.

In some embodiments, the method is for stabilizing an aqueous pesticidal suspension composition comprising emamectin or salt thereof at about 1% to of about 20% by weight, based on the total weight of the composition; optionally additives and optionally chlorantraniliprole at about 1% to of about 20% by weight, based on the total weight of the composition by the addition of poly(2-methacryloxyethyltrimethylammonium chloride) at about 1.1% to of about 1.7% by weight, based on the total weight of the composition.

In some embodiments, the method is for stabilizing an aqueous pesticidal suspension composition comprising emamectin or salt thereof at about 7.5% by weight, based on the total weight of the composition; optionally additives and optionally chlorantraniliprole at about 15% by weight, based on the total weight of the composition by the addition of poly(2-methacryloxyethyltrimethylammonium chloride) at about 1.2% by weight, based on the total weight of the composition.

The invention further relates to a method of controlling or preventing infestation of plants with plant pests by applying an aqueous pesticidal suspension composition to the plants, plant parts or locus thereof, comprising a) a macrolide insecticidal compound or salt thereof; b) at least one polycationic type rheology modifier; c) optionally additives and d) optionally additional active ingredient.

In some embodiments, the macrolide insecticidal compound is selected from emamectin, abamectin, spinosad, spinetoram or salt thereof.

In some embodiments, the macrolide insecticidal compound is emamectin or salt thereof.

In some embodiments, the macrolide insecticidal compound is emamectin benzoate.

In some embodiments, the amount of the macrolide insecticidal compound is of about 1% to of about 20% by weight, based on the total weight of the composition.

In some embodiments, the amount of the macrolide insecticidal compound is of about 3% to of about 10% by weight, based on the total weight of the composition.

In some embodiments, the amount of the macrolide insecticidal compound is of about 5% to of about 8% by weight, based on the total weight of the composition.

In some embodiments, the amount of the macrolide insecticidal compound is of about 7.5% by weight, based on the total weight of the composition.

In some embodiments, the at least one polycationic type rheology modifier comprises monomers with ammonium, sulfonium or phosphonium moiety.

In some embodiments, the at least one polycationic type rheology modifier comprises monomers with ammonium moiety.

In some embodiments, the at least one polycationic type rheology modifier comprises monomers with ammonium moiety is selected from polyquaterniums or polyquaternium esters polymers and combinations thereof.

In some embodiments, the at least one polycationic type rheology modifier is poly(2-methacryloxyethyltrimethylammonium chloride).

In some embodiments, the amount of the at least one polycationic type thickener is of about 1% to of about 3% by weight, based on the total weight of the composition.

In some embodiments, the amount of the at least one polycationic type thickener is of about 1% to of about 2% by weight, based on the total weight of the composition.

In some embodiments, the amount of the at least one polycationic type thickener is of about 1.1% to of about 1.7% by weight, based on the total weight of the composition.

In some embodiments, the amount of the at least one polycationic type thickener is of about 1.2% by weight, based on the total weight of the composition.

In some embodiments, the additive is selected from the group comprising of dispersants, wetting agents, antifreezing agents, antifoaming agents, surfactants, pH modifiers and stabilizers.

In some embodiments, the additional active ingredient is a diamide insecticide.

In some embodiments, the diamide insecticide is selected from chlorantraniliprole, cyantraniliprole, cyclaniliprole, fluchlordiniliprole, tetrachlorantraniliprole and tetraniliprole.

In some embodiments, the diamide insecticide is selected from chlorantraniliprole or cyantraniliprole.

In some embodiments, the diamide insecticide is chlorantraniliprole.

In some embodiments, the diamide insecticide is cyantraniliprole.

In some embodiments, the additional active ingredient is of about 1% to of about 60% by weight, based on the total weight of the composition.

In some embodiments, the additional active ingredient is of about 1% to of about 40% by weight, based on the total weight of the composition.

In some embodiments, the additional active ingredient is of about 1% to of about 30% by weight, based on the total weight of the composition.

In some embodiments, the additional active ingredient is of about 1% to of about 20% by weight, based on the total weight of the composition.

In some embodiments, the additional active ingredient is of about 15% by weight, based on the total weight of the composition.

In some embodiments, the composition is applied in an amount from about 0.06 L/ha to about 0.62 L/ha.

In some embodiments, the composition is applied in an amount from about 5 g/ha of macrolide insecticidal compound or salt thereof to about 15 g/ha of macrolide insecticidal compound or salt thereof.

In some embodiments, the composition is applied in an amount from about 10 g/ha of diamide insecticide to about 100 g/ha of diamide insecticide.

The compositions and methods of this invention display activity against plant pests, non-limiting examples are Lepidoptera (e.g., Alabama argillacea Húbner (cotton leaf worm), Archips argyrospda Walker (fruit tree leaf roller), A. rosana Linnaeus (European leaf roller) and other Archips species, Chilo suppressalis Walker (rice stem borer), Cnaphalocrosis medinalis Guenee (rice leaf roller), Crambus caliginosellus Clemens (corn root webworm), Crambus teterrellus Zincken (bluegrass webworm), Cydia pomonella Linnaeus (codling moth), Earias insulana Boisduval (spiny bollworm), Earias vittella Fabricius (spotted bollworm), Helicoverpa armigera Húbner (American bollworm), Helicoverpa zea Boddie (corn earworm), Heliothis virescens Fabricius (tobacco budworm), Herpetogramma licarsisalis Walker (sod webworm), Lobesia botrana Denis & Schiffermúller (grape berry moth), Pectinophora gossypiella Saunders (pink bollworm), Phyllocnistis citrella Stainton (citrus leafininer), Pieris brassicae Linnaeus (large white butterfly), Pieris rapae Linnaeus (small white butterfly), Plutella xylostella Linnaeus (diamondback moth), Spodoptera exigua Húbner (beet armyworm), Spodoptera litura Fabricius (tobacco cutworm, cluster caterpillar), Spodoptera frugiperda J. E. Smith (fall armyworm), Trichoplusia ni Húbner (cabbage looper) and Tuta absoluta Meyrick (tomato leafininer)). Compounds of the invention also have commercially significant activity on members from the order Homoptera including: Acyrthisiphon pisum Harris (pea aphid), Aphis craccivora Koch (cowpea aphid), Aphis fabae Scopoli (black bean aphid), Aphis gossypii Glover (cotton aphid, melon aphid), Aphis pomi De Geer (apple aphid), Aphis spiraecola Patch (spirea aphid), Aulacorthum solani Kaltenbach (foxglove aphid), Chaetosiphon fragaefolii Cockerell (strawberry aphid), Diuraphis noxia Kurdjumov/Mordvilko (Russian wheat aphid), Dysaphis plantaginea Paaserini (rosy apple aphid), Eriosoma lanigerum Hausmann (woolly apple aphid), Hyalopterus pruni Geoffrey (mealy plum aphid), Lipaphis erysimi Kaltenbach (turnip aphid), Metopolophium dirrhodum Walker (cereal aphid), Macrosipum euphorbiae Thomas (potato aphid), Myzus persicae Sulzer (peach-potato aphid, green peach aphid), Nasonovia ribisnigri Mosley (lettuce aphid), Pemphigus spp. (root aphids and gall aphids), Rhopalosiphum maidis Fitch (corn leaf aphid), Rhopalosiphum padi Linnaeus (bird cherry—oat aphid), Schizaphis graminum Rondani (greenbug), Sitobion avenae Fabricius (English grain aphid), Therioaphis maculata Buckton (spotted alfalfa aphid), Toxoptera aurantii Boyer de Fonscolombe (black citrus aphid), and Toxoptera citricida Kirkaldy (brown citrus aphid); Adelges spp. (adelgids); Phylloxera devastatrix Pergande (pecan phylloxera); Bemisia tabaci Gennadius (tobacco whitefly, sweetpotato whitefly), Bemisia argentifolii Bellows & Perring (silverleaf whitefly), Dialeurodes citri Ashmead (citrus whitefly) and Trialeurodes vaporariorum Westwood (greenhouse whitefly); Empoasca fabae Harris (potato leafhopper), Laodelphax striatellus Fallen (smaller brown planthopper), Macrolestes quadrilineatus Forbes (aster leafhopper), Nephotettix cinticeps Uhler (green leafhopper), Nephotettix nigropictus Stal (rice leafhopper), Nilaparvata lugens Stal (brown planthopper), Peregrinus maidis Ashmead (corn planthopper), Sogatella furcifera Horvath (white-backed planthopper), Sogatodes orizicola Muir (rice delphacid), Typhlocyba pomaria McAtee white apple leafhopper, Erythroneoura spp. (grape leafhoppers); Magicidada septendecim Linnaeus (periodical cicada); Icerya purchasi Maskell (cottony cushion scale), Quadraspidiotus perniciosus Comstock (San Jose scale); Planococcus citri Risso (citrus mealybug); Pseudococcus spp. (other mealybug complex); Cacopsylla pyricola Foerster (pear psylla), Trioza diospyri Ashmead (persimmon psylla). These compounds also have activity on members from the order Hemiptera including: Acrosternum Mare Say (green stink bug), Anasa tristis De Geer (squash bug), Blissus leucopterus leucopterus Say (chinch bug), Corythuca gossypii Fabricius (cotton lace bug), Cyrtopeltis modesta Distant (tomato bug), Dysdercus suturellus Herrich-Schaffer (cotton stainer), Euchistus servus Say (brown stink bug), Euchistus variolarius Palisot de Beauvois (one-spotted stink bug), Graptosthetus spp. (complex of seed bugs), Leptoglossus corculus Say (leaf-footed pine seed bug), Lygus lineolaris Palisot de Beauvois (tarnished plant bug), Nezara viridula Linnaeus (southern green stink bug), Oebalus pugnax Fabricius (rice stink bug), Oncopeltus fasciatus Dallas (large milkweed bug), Pseudatomoscelis seriatus Reuter (cotton fleahopper). Other insect orders controlled by compounds of the invention include Thysanoptera (e.g., Frankliniella occidentalis Pergande (western flower thrip), Scirthothrips citri Moulton (citrus thrip), Sericothrips variabilis Beach (soybean thrip), and Thrips tabaci Lindeman (onion thrip); and the order Coleoptera (e.g., Leptinotarsa decemlineata Say (Colorado potato beetle), Epilachna varivestis Mulsant (Mexican bean beetle) and wireworms of the genera Agriotes, Athous or Limonius).

Non limiting examples of crops or plants which the compositions and methods of the invention can be used on are cereal crops (e.g., wheat, oats, barley, rye, rice, maize), soybeans, vegetable crops (e.g., lettuce, cabbage, tomatoes, beans), potatoes, sweet potatoes, grapes, cotton, and tree fruits (e.g., pome fruits, stone fruits and citrus fruits).

In some embodiments, the method of controlling or preventing infestation of plants with plant pests is by applying an aqueous pesticidal suspension composition to the plants, plant parts or locus thereof, comprising a) a macrolide insecticidal compound or salt thereof; b) at least one polycationic type rheology modifier; c) optionally additives and d) optionally additional active ingredient.

In some embodiments, the method of controlling or preventing infestation of plants with plant pests is by applying an aqueous pesticidal suspension composition to the plants, plant parts or locus thereof, comprising a) a macrolide insecticidal compound or salt thereof; b) at least one polycationic type rheology modifier comprises monomers with ammonium, sulfonium or phosphonium moiety; c) optionally additives and d) optionally additional active ingredient.

In some embodiments, the method of controlling or preventing infestation of plants with plant pests is by applying an aqueous pesticidal suspension composition to the plants, plant parts or locus thereof, comprising a) a macrolide insecticidal compound or salt thereof; b) at least one polycationic type rheology modifier comprises monomers with ammonium moiety; c) optionally additives and d) optionally additional active ingredient.

In some embodiments, the method of controlling or preventing infestation of plants with plant pests is by applying an aqueous pesticidal suspension composition to the plants, plant parts or locus thereof, comprising a) a macrolide insecticidal compound or salt thereof; b) at least one polycationic type rheology modifier comprises monomers with ammonium moiety is selected from polyquaterniums or polyquaternium esters polymers and combinations thereof; c) optionally additives and d) optionally additional active ingredient.

In some embodiments, the method of controlling or preventing infestation of plants with plant pests is by applying an aqueous pesticidal suspension composition to the plants, plant parts or locus thereof, comprising a) a macrolide insecticidal compound or salt thereof; b) poly(2-methacryloxyethyltrimethylammonium chloride); c) optionally additives and d) optionally additional active ingredient.

In some embodiments, the method of controlling or preventing infestation of plants with plant pests is by applying an aqueous pesticidal suspension composition to the plants, plant parts or locus thereof, comprising a) a macrolide insecticidal compound or salt thereof; b) at least one polycationic type rheology modifier at about 1% to of about 3% by weight, based on the total weight of the composition; c) optionally additives and d) optionally additional active ingredient.

In some embodiments, the method of controlling or preventing infestation of plants with plant pests is by applying an aqueous pesticidal suspension composition to the plants, plant parts or locus thereof, comprising a) a macrolide insecticidal compound or salt thereof; b) at least one polycationic type rheology modifier at about 1% to of about 2% by weight, based on the total weight of the composition; c) optionally additives and d) optionally additional active ingredient.

In some embodiments, the method of controlling or preventing infestation of plants with plant pests is by applying an aqueous pesticidal suspension composition to the plants, plant parts or locus thereof, comprising a) a macrolide insecticidal compound or salt thereof; b) at least one polycationic type rheology modifier at about 1.1% to of about 1.7% by weight, based on the total weight of the composition; c) optionally additives and d) optionally additional active ingredient.

In some embodiments, the method of controlling or preventing infestation of plants with plant pests is by applying an aqueous pesticidal suspension composition to the plants, plant parts or locus thereof, comprising a) a macrolide insecticidal compound or salt thereof; b) at least one polycationic type rheology modifier at about 1.2% by weight, based on the total weight of the composition; c) optionally additives and d) optionally additional active ingredient.

In some embodiments, the method of controlling or preventing infestation of plants with plant pests is by applying an aqueous pesticidal suspension composition to the plants, plant parts or locus thereof, comprising a) a macrolide insecticidal compound or salt thereof; b) at least one polycationic type rheology modifier comprises monomers with ammonium, sulfonium or phosphonium moiety at about 1% to of about 3% by weight, based on the total weight of the composition; c) optionally additives and d) optionally additional active ingredient.

In some embodiments, the method of controlling or preventing infestation of plants with plant pests is by applying an aqueous pesticidal suspension composition to the plants, plant parts or locus thereof, comprising a) a macrolide insecticidal compound or salt thereof; b) at least one polycationic type rheology modifier comprises monomers with ammonium, sulfonium or phosphonium moiety at about 1% to of about 2% by weight, based on the total weight of the composition; c) optionally additives and d) optionally additional active ingredient.

In some embodiments, the method of controlling or preventing infestation of plants with plant pests is by applying an aqueous pesticidal suspension composition to the plants, plant parts or locus thereof, comprising a) a macrolide insecticidal compound or salt thereof; b) at least one polycationic type rheology modifier comprises monomers with ammonium, sulfonium or phosphonium moiety at about 1.1% to of about 1.7% by weight, based on the total weight of the composition; c) optionally additives and d) optionally additional active ingredient.

In some embodiments, the method of controlling or preventing infestation of plants with plant pests is by applying an aqueous pesticidal suspension composition to the plants, plant parts or locus thereof, comprising a) a macrolide insecticidal compound or salt thereof; b) at least one polycationic type rheology modifier comprises monomers with ammonium, sulfonium or phosphonium moiety at about 1.2% by weight, based on the total weight of the composition; c) optionally additives and d) optionally additional active ingredient.

In some embodiments, the method of controlling or preventing infestation of plants with plant pests is by applying an aqueous pesticidal suspension composition to the plants, plant parts or locus thereof, comprising a) a macrolide insecticidal compound or salt thereof; b) at least one polycationic type rheology modifier comprises monomers with ammonium moiety at about 1% to of about 3% by weight, based on the total weight of the composition; c) optionally additives and d) optionally additional active ingredient.

In some embodiments, the method of controlling or preventing infestation of plants with plant pests is by applying an aqueous pesticidal suspension composition to the plants, plant parts or locus thereof, comprising a) a macrolide insecticidal compound or salt thereof; b) at least one polycationic type rheology modifier comprises monomers with ammonium moiety at about 1% to of about 2% by weight, based on the total weight of the composition; c) optionally additives and d) optionally additional active ingredient.

In some embodiments, the method of controlling or preventing infestation of plants with plant pests is by applying an aqueous pesticidal suspension composition to the plants, plant parts or locus thereof, comprising a) a macrolide insecticidal compound or salt thereof; b) at least one polycationic type rheology modifier comprises monomers with ammonium moiety at about 1.1% to of about 1.7% by weight, based on the total weight of the composition; c) optionally additives and d) optionally additional active ingredient.

In some embodiments, the method of controlling or preventing infestation of plants with plant pests is by applying an aqueous pesticidal suspension composition to the plants, plant parts or locus thereof, comprising a) a macrolide insecticidal compound or salt thereof; b) at least one polycationic type rheology modifier comprises monomers with ammonium moiety at about 1.2% by weight, based on the total weight of the composition; c) optionally additives and d) optionally additional active ingredient.

In some embodiments, the method of controlling or preventing infestation of plants with plant pests is by applying an aqueous pesticidal suspension composition to the plants, plant parts or locus thereof, comprising a) a macrolide insecticidal compound or salt thereof; b) at least one polycationic type rheology modifier comprises monomers with ammonium moiety is selected from polyquaterniums or polyquaternium esters polymers and combinations thereof at about 1% to of about 3% by weight, based on the total weight of the composition; c) optionally additives and d) optionally additional active ingredient.

In some embodiments, the method of controlling or preventing infestation of plants with plant pests is by applying an aqueous pesticidal suspension composition to the plants, plant parts or locus thereof, comprising a) a macrolide insecticidal compound or salt thereof; b) at least one polycationic type rheology modifier comprises monomers with ammonium moiety is selected from polyquaterniums or polyquaternium esters polymers and combinations thereof at about 1% to of about 2% by weight, based on the total weight of the composition; c) optionally additives and d) optionally additional active ingredient.

In some embodiments, the method of controlling or preventing infestation of plants with plant pests is by applying an aqueous pesticidal suspension composition to the plants, plant parts or locus thereof, comprising a) a macrolide insecticidal compound or salt thereof; b) at least one polycationic type rheology modifier comprises monomers with ammonium moiety is selected from polyquaterniums or polyquaternium esters polymers and combinations thereof at about 1.1% to of about 1.7% by weight, based on the total weight of the composition; c) optionally additives and d) optionally additional active ingredient.

In some embodiments, the method of controlling or preventing infestation of plants with plant pests is by applying an aqueous pesticidal suspension composition to the plants, plant parts or locus thereof, comprising a) a macrolide insecticidal compound or salt thereof; b) at least one polycationic type rheology modifier comprises monomers with ammonium moiety is selected from polyquaterniums or polyquaternium esters polymers and combinations thereof at about 1.2% by weight, based on the total weight of the composition; c) optionally additives and d) optionally additional active ingredient.

In some embodiments, the method of controlling or preventing infestation of plants with plant pests is by applying an aqueous pesticidal suspension composition to the plants, plant parts or locus thereof, comprising a) a macrolide insecticidal compound or salt thereof; b) poly(2-methacryloxyethyltrimethylammonium chloride) at about 1% to of about 3% by weight, based on the total weight of the composition; c) optionally additives and d) optionally additional active ingredient.

In some embodiments, the method of controlling or preventing infestation of plants with plant pests is by applying an aqueous pesticidal suspension composition to the plants, plant parts or locus thereof, comprising a) a macrolide insecticidal compound or salt thereof; b) poly(2-methacryloxyethyltrimethylammonium chloride) at about 1% to of about 2% by weight, based on the total weight of the composition; c) optionally additives and d) optionally additional active ingredient.

In some embodiments, the method of controlling or preventing infestation of plants with plant pests is by applying an aqueous pesticidal suspension composition to the plants, plant parts or locus thereof, comprising a) a macrolide insecticidal compound or salt thereof; b) poly(2-methacryloxyethyltrimethylammonium chloride) at about 1.1% to of about 1.7% by weight, based on the total weight of the composition; c) optionally additives and d) optionally additional active ingredient.

In some embodiments, the method of controlling or preventing infestation of plants with plant pests is by applying an aqueous pesticidal suspension composition to the plants, plant parts or locus thereof, comprising a) a macrolide insecticidal compound or salt thereof; b) poly(2-methacryloxyethyltrimethylammonium chloride) at about 1.2% by weight, based on the total weight of the composition; c) optionally additives and d) optionally additional active ingredient.

In some embodiments, the method of controlling or preventing infestation of plants with plant pests is by applying an aqueous pesticidal suspension composition to the plants, plant parts or locus thereof, comprising a) emamectin or salt thereof at about 1% to of about 10% by weight, based on the total weight of the composition; b) at least one polycationic type rheology modifier at about 1% to of about 3% by weight, based on the total weight of the composition; c) optionally additives and d) optionally additional active ingredient.

In some embodiments, the method of controlling or preventing infestation of plants with plant pests is by applying an aqueous pesticidal suspension composition to the plants, plant parts or locus thereof, comprising a) emamectin or salt thereof at about 3% to of about 10% by weight, based on the total weight of the composition; b) at least one polycationic type rheology modifier at about 1% to of about 3% by weight, based on the total weight of the composition; c) optionally additives and d) optionally additional active ingredient.

In some embodiments, the method of controlling or preventing infestation of plants with plant pests is by applying an aqueous pesticidal suspension composition to the plants, plant parts or locus thereof, comprising a) emamectin or salt thereof at about 5% to of about 8% by weight, based on the total weight of the composition; b) at least one polycationic type rheology modifier at about 1% to of about 3% by weight, based on the total weight of the composition; c) optionally additives and d) optionally additional active ingredient.

In some embodiments, the method of controlling or preventing infestation of plants with plant pests is by applying an aqueous pesticidal suspension composition to the plants, plant parts or locus thereof, comprising a) emamectin or salt thereof at about 7.5% by weight, based on the total weight of the composition; b) at least one polycationic type rheology modifier at about 1% to of about 3% by weight, based on the total weight of the composition; c) optionally additives and d) optionally additional active ingredient.

In some embodiments, the method of controlling or preventing infestation of plants with plant pests is by applying an aqueous pesticidal suspension composition to the plants, plant parts or locus thereof, comprising a) emamectin or salt thereof at about 1% to of about 20% by weight, based on the total weight of the composition; b) at least one polycationic type rheology modifier at about 1% to of about 2% by weight, based on the total weight of the composition; c) optionally additives and d) optionally additional active ingredient.

In some embodiments, the method of controlling or preventing infestation of plants with plant pests is by applying an aqueous pesticidal suspension composition to the plants, plant parts or locus thereof, comprising a) emamectin or salt thereof at about 3% to of about 10% by weight, based on the total weight of the composition; b) at least one polycationic type rheology modifier at about 1% to of about 2% by weight, based on the total weight of the composition; c) optionally additives and d) optionally additional active ingredient.

In some embodiments, the method of controlling or preventing infestation of plants with plant pests is by applying an aqueous pesticidal suspension composition to the plants, plant parts or locus thereof, comprising a) emamectin or salt thereof at about 5% to of about 8% by weight, based on the total weight of the composition; b) at least one polycationic type rheology modifier at about 1% to of about 2% by weight, based on the total weight of the composition; c) optionally additives and d) optionally additional active ingredient.

In some embodiments, the method of controlling or preventing infestation of plants with plant pests is by applying an aqueous pesticidal suspension composition to the plants, plant parts or locus thereof, comprising a) emamectin or salt thereof at about 7.5% by weight, based on the total weight of the composition; b) at least one polycationic type rheology modifier at about 1% to of about 2% by weight, based on the total weight of the composition; c) optionally additives and d) optionally additional active ingredient.

In some embodiments, the method of controlling or preventing infestation of plants with plant pests is by applying an aqueous pesticidal suspension composition to the plants, plant parts or locus thereof, comprising a) emamectin or salt thereof at about 1% to of about 20% by weight, based on the total weight of the composition; b) at least one polycationic type rheology modifier at about 1.1% to of about 1.7% by weight, based on the total weight of the composition; c) optionally additives and d) optionally additional active ingredient.

In some embodiments, the method of controlling or preventing infestation of plants with plant pests is by applying an aqueous pesticidal suspension composition to the plants, plant parts or locus thereof, comprising a) emamectin or salt thereof at about 3% to of about 10% by weight, based on the total weight of the composition; b) at least one polycationic type rheology modifier at about 1.1% to of about 1.7% by weight, based on the total weight of the composition; c) optionally additives and d) optionally additional active ingredient.

In some embodiments, the method of controlling or preventing infestation of plants with plant pests is by applying an aqueous pesticidal suspension composition to the plants, plant parts or locus thereof, comprising a) emamectin or salt thereof at about 5% to of about 8% by weight, based on the total weight of the composition; b) at least one polycationic type rheology modifier at about 1.1% to of about 1.7% by weight, based on the total weight of the composition; c) optionally additives and d) optionally additional active ingredient.

In some embodiments, the method of controlling or preventing infestation of plants with plant pests is by applying an aqueous pesticidal suspension composition to the plants, plant parts or locus thereof, comprising a) emamectin or salt thereof at about 7.5% by weight, based on the total weight of the composition; b) at least one polycationic type rheology modifier at about 1.1% to of about 1.7% by weight, based on the total weight of the composition; c) optionally additives and d) optionally additional active ingredient.

In some embodiments, the method of controlling or preventing infestation of plants with plant pests is by applying an aqueous pesticidal suspension composition to the plants, plant parts or locus thereof, comprising a) emamectin or salt thereof at about 1% to of about 20% by weight, based on the total weight of the composition; b) at least one polycationic type rheology modifier at about 1.2% by weight, based on the total weight of the composition; c) optionally additives and d) optionally additional active ingredient.

In some embodiments, the method of controlling or preventing infestation of plants with plant pests is by applying an aqueous pesticidal suspension composition to the plants, plant parts or locus thereof, comprising a) emamectin or salt thereof at about 3% to of about 10% by weight, based on the total weight of the composition; b) at least one polycationic type rheology modifier at about 1.2% by weight, based on the total weight of the composition; c) optionally additives and d) optionally additional active ingredient.

In some embodiments, the method of controlling or preventing infestation of plants with plant pests is by applying an aqueous pesticidal suspension composition to the plants, plant parts or locus thereof, comprising a) emamectin or salt thereof at about 5% to of about 8% by weight, based on the total weight of the composition; b) at least one polycationic type rheology modifier at about 1.2% by weight, based on the total weight of the composition; c) optionally additives and d) optionally additional active ingredient.

In some embodiments, the method of controlling or preventing infestation of plants with plant pests is by applying an aqueous pesticidal suspension composition to the plants, plant parts or locus thereof, comprising a) emamectin or salt thereof at about 7.5% by weight, based on the total weight of the composition; b) at least one polycationic type rheology modifier at about 1.2% by weight, based on the total weight of the composition; c) optionally additives and d) optionally additional active ingredient.

In some embodiments, the method of controlling or preventing infestation of plants with plant pests is by applying an aqueous pesticidal suspension composition to the plants, plant parts or locus thereof, comprising a) emamectin or salt thereof at about 1% to of about 20% by weight, based on the total weight of the composition; b) at least one polycationic type rheology modifier comprises monomers with ammonium, sulfonium or phosphonium moiety at about 1% to of about 3% by weight, based on the total weight of the composition; c) optionally additives and d) optionally additional active ingredient.

In some embodiments, the method of controlling or preventing infestation of plants with plant pests is by applying an aqueous pesticidal suspension composition to the plants, plant parts or locus thereof, comprising a) emamectin or salt thereof at about 3% to of about 10% by weight, based on the total weight of the composition; b) at least one polycationic type rheology modifier comprises monomers with ammonium, sulfonium or phosphonium moiety at about 1% to of about 3% by weight, based on the total weight of the composition; c) optionally additives and d) optionally additional active ingredient.

In some embodiments, the method of controlling or preventing infestation of plants with plant pests is by applying an aqueous pesticidal suspension composition to the plants, plant parts or locus thereof, comprising a) emamectin or salt thereof at about 5% to of about 8% by weight, based on the total weight of the composition; b) at least one polycationic type rheology modifier comprises monomers with ammonium, sulfonium or phosphonium moiety at about 1% to of about 3% by weight, based on the total weight of the composition; c) optionally additives and d) optionally additional active ingredient.

In some embodiments, the method of controlling or preventing infestation of plants with plant pests is by applying an aqueous pesticidal suspension composition to the plants, plant parts or locus thereof, comprising a) emamectin or salt thereof at about 7.5% by weight, based on the total weight of the composition; b) at least one polycationic type rheology modifier comprises monomers with ammonium, sulfonium or phosphonium moiety at about 1% to of about 3% by weight, based on the total weight of the composition; c) optionally additives and d) optionally additional active ingredient.

In some embodiments, the method of controlling or preventing infestation of plants with plant pests is by applying an aqueous pesticidal suspension composition to the plants, plant parts or locus thereof, comprising a) emamectin or salt thereof at about 1% to of about 20% by weight, based on the total weight of the composition; b) at least one polycationic type rheology modifier comprises monomers with ammonium, sulfonium or phosphonium moiety at about 1% to of about 2% by weight, based on the total weight of the composition; c) optionally additives and d) optionally additional active ingredient.

In some embodiments, the method of controlling or preventing infestation of plants with plant pests is by applying an aqueous pesticidal suspension composition to the plants, plant parts or locus thereof, comprising a) emamectin or salt thereof at about 3% to of about 10% by weight, based on the total weight of the composition; b) at least one polycationic type rheology modifier comprises monomers with ammonium, sulfonium or phosphonium moiety at about 1% to of about 2% by weight, based on the total weight of the composition; c) optionally additives and d) optionally additional active ingredient.

In some embodiments, the method of controlling or preventing infestation of plants with plant pests is by applying an aqueous pesticidal suspension composition to the plants, plant parts or locus thereof, comprising a) emamectin or salt thereof at about 5% to of about 8% by weight, based on the total weight of the composition; b) at least one polycationic type rheology modifier comprises monomers with ammonium, sulfonium or phosphonium moiety at about 1% to of about 2% by weight, based on the total weight of the composition; c) optionally additives and d) optionally additional active ingredient.

In some embodiments, the method of controlling or preventing infestation of plants with plant pests is by applying an aqueous pesticidal suspension composition to the plants, plant parts or locus thereof, comprising a) emamectin or salt thereof at about 7.5% by weight, based on the total weight of the composition; b) at least one polycationic type rheology modifier comprises monomers with ammonium, sulfonium or phosphonium moiety at about 1% to of about 2% by weight, based on the total weight of the composition; c) optionally additives and d) optionally additional active ingredient.

In some embodiments, the method of controlling or preventing infestation of plants with plant pests is by applying an aqueous pesticidal suspension composition to the plants, plant parts or locus thereof, comprising a) emamectin or salt thereof at about 1% to of about 20% by weight, based on the total weight of the composition; b) at least one polycationic type rheology modifier comprises monomers with ammonium, sulfonium or phosphonium moiety at about 1.1% to of about 1.7% by weight, based on the total weight of the composition; c) optionally additives and d) optionally additional active ingredient.

In some embodiments, the method of controlling or preventing infestation of plants with plant pests is by applying an aqueous pesticidal suspension composition to the plants, plant parts or locus thereof, comprising a) emamectin or salt thereof at about 3% to of about 10% by weight, based on the total weight of the composition; b) at least one polycationic type rheology modifier comprises monomers with ammonium, sulfonium or phosphonium moiety at about 1.1% to of about 1.7% by weight, based on the total weight of the composition; c) optionally additives and d) optionally additional active ingredient.

In some embodiments, the method of controlling or preventing infestation of plants with plant pests is by applying an aqueous pesticidal suspension composition to the plants, plant parts or locus thereof, comprising a) emamectin or salt thereof at about 5% to of about 8% by weight, based on the total weight of the composition; b) at least one polycationic type rheology modifier comprises monomers with ammonium, sulfonium or phosphonium moiety at about 1.1% to of about 1.7% by weight, based on the total weight of the composition; c) optionally additives and d) optionally additional active ingredient.

In some embodiments, the method of controlling or preventing infestation of plants with plant pests is by applying an aqueous pesticidal suspension composition to the plants, plant parts or locus thereof, comprising a) emamectin or salt thereof at about 7.5% by weight, based on the total weight of the composition; b) at least one polycationic type rheology modifier comprises monomers with ammonium, sulfonium or phosphonium moiety at about 1.1% to of about 1.7% by weight, based on the total weight of the composition; c) optionally additives and d) optionally additional active ingredient.

In some embodiments, the method of controlling or preventing infestation of plants with plant pests is by applying an aqueous pesticidal suspension composition to the plants, plant parts or locus thereof, comprising a) emamectin or salt thereof at about 1% to of about 20% by weight, based on the total weight of the composition; b) at least one polycationic type rheology modifier comprises monomers with ammonium, sulfonium or phosphonium moiety at about 1.2% by weight, based on the total weight of the composition; c) optionally additives and d) optionally additional active ingredient.

In some embodiments, the method of controlling or preventing infestation of plants with plant pests is by applying an aqueous pesticidal suspension composition to the plants, plant parts or locus thereof, comprising a) emamectin or salt thereof at about 3% to of about 10% by weight, based on the total weight of the composition; b) at least one polycationic type rheology modifier comprises monomers with ammonium, sulfonium or phosphonium moiety at about 1.2% by weight, based on the total weight of the composition; c) optionally additives and d) optionally additional active ingredient.

In some embodiments, the method of controlling or preventing infestation of plants with plant pests is by applying an aqueous pesticidal suspension composition to the plants, plant parts or locus thereof, comprising a) emamectin or salt thereof at about 5% to of about 8% by weight, based on the total weight of the composition; b) at least one polycationic type rheology modifier comprises monomers with ammonium, sulfonium or phosphonium moiety at about 1.2% by weight, based on the total weight of the composition; c) optionally additives and d) optionally additional active ingredient.

In some embodiments, the method of controlling or preventing infestation of plants with plant pests is by applying an aqueous pesticidal suspension composition to the plants, plant parts or locus thereof, comprising a) emamectin or salt thereof at about 7.5% by weight, based on the total weight of the composition; b) at least one polycationic type rheology modifier comprises monomers with ammonium, sulfonium or phosphonium moiety at about 1.2% by weight, based on the total weight of the composition; c) optionally additives and d) optionally additional active ingredient.

In some embodiments, the method of controlling or preventing infestation of plants with plant pests is by applying an aqueous pesticidal suspension composition to the plants, plant parts or locus thereof, comprising a) emamectin or salt thereof at about 1% to of about 20% by weight, based on the total weight of the composition; b) at least one polycationic type rheology modifier comprises monomers with ammonium moiety at about 1% to of about 3% by weight, based on the total weight of the composition; c) optionally additives and d) optionally additional active ingredient.

In some embodiments, the method of controlling or preventing infestation of plants with plant pests is by applying an aqueous pesticidal suspension composition to the plants, plant parts or locus thereof, comprising a) emamectin or salt thereof at about 3% to of about 10% by weight, based on the total weight of the composition; b) at least one polycationic type rheology modifier comprises monomers with ammonium moiety at about 1% to of about 3% by weight, based on the total weight of the composition; c) optionally additives and d) optionally additional active ingredient.

In some embodiments, the method of controlling or preventing infestation of plants with plant pests is by applying an aqueous pesticidal suspension composition to the plants, plant parts or locus thereof, comprising a) emamectin or salt thereof at about 5% to of about 8% by weight, based on the total weight of the composition; b) at least one polycationic type rheology modifier comprises monomers with ammonium moiety at about 1% to of about 3% by weight, based on the total weight of the composition; c) optionally additives and d) optionally additional active ingredient.

In some embodiments, the method of controlling or preventing infestation of plants with plant pests is by applying an aqueous pesticidal suspension composition to the plants, plant parts or locus thereof, comprising a) emamectin or salt thereof at about 7.5% by weight, based on the total weight of the composition; b) at least one polycationic type rheology modifier comprises monomers with ammonium moiety at about 1% to of about 3% by weight, based on the total weight of the composition; c) optionally additives and d) optionally additional active ingredient.

In some embodiments, the method of controlling or preventing infestation of plants with plant pests is by applying an aqueous pesticidal suspension composition to the plants, plant parts or locus thereof, comprising a) emamectin or salt thereof at about 1% to of about 20% by weight, based on the total weight of the composition; b) at least one polycationic type rheology modifier comprises monomers with ammonium moiety at about 1% to of about 2% by weight, based on the total weight of the composition; c) optionally additives and d) optionally additional active ingredient.

In some embodiments, the method of controlling or preventing infestation of plants with plant pests is by applying an aqueous pesticidal suspension composition to the plants, plant parts or locus thereof, comprising a) emamectin or salt thereof at about 3% to of about 10% by weight, based on the total weight of the composition; b) at least one polycationic type rheology modifier comprises monomers with ammonium moiety at about 1% to of about 2% by weight, based on the total weight of the composition; c) optionally additives and d) optionally additional active ingredient.

In some embodiments, the method of controlling or preventing infestation of plants with plant pests is by applying an aqueous pesticidal suspension composition to the plants, plant parts or locus thereof, comprising a) emamectin or salt thereof at about 5% to of about 8% by weight, based on the total weight of the composition; b) at least one polycationic type rheology modifier comprises monomers with ammonium moiety at about 1% to of about 2% by weight, based on the total weight of the composition; c) optionally additives and d) optionally additional active ingredient.

In some embodiments, the method of controlling or preventing infestation of plants with plant pests is by applying an aqueous pesticidal suspension composition to the plants, plant parts or locus thereof, comprising a) emamectin or salt thereof at about 7.5% by weight, based on the total weight of the composition; b) at least one polycationic type rheology modifier comprises monomers with ammonium moiety at about 1% to of about 2% by weight, based on the total weight of the composition; c) optionally additives and d) optionally additional active ingredient.

In some embodiments, the method of controlling or preventing infestation of plants with plant pests is by applying an aqueous pesticidal suspension composition to the plants, plant parts or locus thereof, comprising a) emamectin or salt thereof at about 1% to of about 20% by weight, based on the total weight of the composition; b) at least one polycationic type rheology modifier comprises monomers with ammonium moiety at about 1.1% to of about 1.7% by weight, based on the total weight of the composition; c) optionally additives and d) optionally additional active ingredient.

In some embodiments, the method of controlling or preventing infestation of plants with plant pests is by applying an aqueous pesticidal suspension composition to the plants, plant parts or locus thereof, comprising a) emamectin or salt thereof at about 3% to of about 10% by weight, based on the total weight of the composition; b) at least one polycationic type rheology modifier comprises monomers with ammonium moiety at about 1.1% to of about 1.7% by weight, based on the total weight of the composition; c) optionally additives and d) optionally additional active ingredient.

In some embodiments, the method of controlling or preventing infestation of plants with plant pests is by applying an aqueous pesticidal suspension composition to the plants, plant parts or locus thereof, comprising a) emamectin or salt thereof at about 5% to of about 8% by weight, based on the total weight of the composition; b) at least one polycationic type rheology modifier comprises monomers with ammonium moiety at about 1.1% to of about 1.7% by weight, based on the total weight of the composition; c) optionally additives and d) optionally additional active ingredient.

In some embodiments, the method of controlling or preventing infestation of plants with plant pests is by applying an aqueous pesticidal suspension composition to the plants, plant parts or locus thereof, comprising a) emamectin or salt thereof at about 7.5% by weight, based on the total weight of the composition; b) at least one polycationic type rheology modifier comprises monomers with ammonium moiety at about 1.1% to of about 1.7% by weight, based on the total weight of the composition; c) optionally additives and d) optionally additional active ingredient.

In some embodiments, the method of controlling or preventing infestation of plants with plant pests is by applying an aqueous pesticidal suspension composition to the plants, plant parts or locus thereof, comprising a) emamectin or salt thereof at about 1% to of about 20% by weight, based on the total weight of the composition; b) at least one polycationic type rheology modifier comprises monomers with ammonium moiety at about 1.2% by weight, based on the total weight of the composition; c) optionally additives and d) optionally additional active ingredient.

In some embodiments, the method of controlling or preventing infestation of plants with plant pests is by applying an aqueous pesticidal suspension composition to the plants, plant parts or locus thereof, comprising a) emamectin or salt thereof at about 3% to of about 10% by weight, based on the total weight of the composition; b) at least one polycationic type rheology modifier comprises monomers with ammonium moiety at about 1.2% by weight, based on the total weight of the composition; c) optionally additives and d) optionally additional active ingredient.

In some embodiments, the method of controlling or preventing infestation of plants with plant pests is by applying an aqueous pesticidal suspension composition to the plants, plant parts or locus thereof, comprising a) emamectin or salt thereof at about 5% to of about 8% by weight, based on the total weight of the composition; b) at least one polycationic type rheology modifier comprises monomers with ammonium moiety at about 1.2% by weight, based on the total weight of the composition; c) optionally additives and d) optionally additional active ingredient.

In some embodiments, the method of controlling or preventing infestation of plants with plant pests is by applying an aqueous pesticidal suspension composition to the plants, plant parts or locus thereof, comprising a) emamectin or salt thereof at about 7.5% by weight, based on the total weight of the composition; b) at least one polycationic type rheology modifier comprises monomers with ammonium moiety at about 1.2% by weight, based on the total weight of the composition; c) optionally additives and d) optionally additional active ingredient.

In some embodiments, the method of controlling or preventing infestation of plants with plant pests is by applying an aqueous pesticidal suspension composition to the plants, plant parts or locus thereof, comprising a) emamectin or salt thereof at about 1% to of about 20% by weight, based on the total weight of the composition; b) at least one polycationic type rheology modifier comprises monomers with ammonium moiety is selected from polyquaterniums or polyquaternium esters polymers and combinations thereof at about 1% to of about 3% by weight, based on the total weight of the composition; c) optionally additives and d) optionally additional active ingredient.

In some embodiments, the method of controlling or preventing infestation of plants with plant pests is by applying an aqueous pesticidal suspension composition to the plants, plant parts or locus thereof, comprising a) emamectin or salt thereof at about 3% to of about 10% by weight, based on the total weight of the composition; b) at least one polycationic type rheology modifier comprises monomers with ammonium moiety is selected from polyquaterniums or polyquaternium esters polymers and combinations thereof at about 1% to of about 3% by weight, based on the total weight of the composition; c) optionally additives and d) optionally additional active ingredient.

In some embodiments, the method of controlling or preventing infestation of plants with plant pests is by applying an aqueous pesticidal suspension composition to the plants, plant parts or locus thereof, comprising a) emamectin or salt thereof at about 5% to of about 8% by weight, based on the total weight of the composition; b) at least one polycationic type rheology modifier comprises monomers with ammonium moiety is selected from polyquaterniums or polyquaternium esters polymers and combinations thereof at about 1% to of about 3% by weight, based on the total weight of the composition; c) optionally additives and d) optionally additional active ingredient.

In some embodiments, the method of controlling or preventing infestation of plants with plant pests is by applying an aqueous pesticidal suspension composition to the plants, plant parts or locus thereof, comprising a) emamectin compound or salt thereof at about 7.5% by weight, based on the total weight of the composition; b) at least one polycationic type rheology modifier comprises monomers with ammonium moiety is selected from polyquaterniums or polyquaternium esters polymers and combinations thereof at about 1% to of about 3% by weight, based on the total weight of the composition; c) optionally additives and d) optionally additional active ingredient.

In some embodiments, the method of controlling or preventing infestation of plants with plant pests is by applying an aqueous pesticidal suspension composition to the plants, plant parts or locus thereof, comprising a) emamectin or salt thereof at about 1% to of about 20% by weight, based on the total weight of the composition; b) at least one polycationic type rheology modifier comprises monomers with ammonium moiety is selected from polyquaterniums or polyquaternium esters polymers and combinations thereof at about 1% to of about 2% by weight, based on the total weight of the composition; c) optionally additives and d) optionally additional active ingredient.

In some embodiments, the method of controlling or preventing infestation of plants with plant pests is by applying an aqueous pesticidal suspension composition to the plants, plant parts or locus thereof, comprising a) emamectin or salt thereof at about 3% to of about 10% by weight, based on the total weight of the composition; b) at least one polycationic type rheology modifier comprises monomers with ammonium moiety is selected from polyquaterniums or polyquaternium esters polymers and combinations thereof at about 1% to of about 2% by weight, based on the total weight of the composition; c) optionally additives and d) optionally additional active ingredient.

In some embodiments, the method of controlling or preventing infestation of plants with plant pests is by applying an aqueous pesticidal suspension composition to the plants, plant parts or locus thereof, comprising a) emamectin or salt thereof at about 5% to of about 8% by weight, based on the total weight of the composition; b) at least one polycationic type rheology modifier comprises monomers with ammonium moiety is selected from polyquaterniums or polyquaternium esters polymers and combinations thereof at about 1% to of about 2% by weight, based on the total weight of the composition; c) optionally additives and d) optionally additional active ingredient.

In some embodiments, the method of controlling or preventing infestation of plants with plant pests is by applying an aqueous pesticidal suspension composition to the plants, plant parts or locus thereof, comprising a) emamectin or salt thereof at about 7.5% by weight, based on the total weight of the composition; b) at least one polycationic type rheology modifier comprises monomers with ammonium moiety is selected from polyquaterniums or polyquaternium esters polymers and combinations thereof at about 1% to of about 2% by weight, based on the total weight of the composition; c) optionally additives and d) optionally additional active ingredient.

In some embodiments, the method of controlling or preventing infestation of plants with plant pests is by applying an aqueous pesticidal suspension composition to the plants, plant parts or locus thereof, comprising a) emamectin or salt thereof at about 1% to of about 20% by weight, based on the total weight of the composition; b) at least one polycationic type rheology modifier comprises monomers with ammonium moiety is selected from polyquaterniums or polyquaternium esters polymers and combinations thereof at about 1.1% to of about 1.7% by weight, based on the total weight of the composition; c) optionally additives and d) optionally additional active ingredient.

In some embodiments, the method of controlling or preventing infestation of plants with plant pests is by applying an aqueous pesticidal suspension composition to the plants, plant parts or locus thereof, comprising a) emamectin or salt thereof at about 3% to of about 10% by weight, based on the total weight of the composition; b) at least one polycationic type rheology modifier comprises monomers with ammonium moiety is selected from polyquaterniums or polyquaternium esters polymers and combinations thereof at about 1.1% to of about 1.7% by weight, based on the total weight of the composition; c) optionally additives and d) optionally additional active ingredient.

In some embodiments, the method of controlling or preventing infestation of plants with plant pests is by applying an aqueous pesticidal suspension composition to the plants, plant parts or locus thereof, comprising a) emamectin or salt thereof at about 5% to of about 8% by weight, based on the total weight of the composition; b) at least one polycationic type rheology modifier comprises monomers with ammonium moiety is selected from polyquaterniums or polyquaternium esters polymers and combinations thereof at about 1.1% to of about 1.7% by weight, based on the total weight of the composition; c) optionally additives and d) optionally additional active ingredient.

In some embodiments, the method of controlling or preventing infestation of plants with plant pests is by applying an aqueous pesticidal suspension composition to the plants, plant parts or locus thereof, comprising a) emamectin or salt thereof at about 7.5% by weight, based on the total weight of the composition; b) at least one polycationic type rheology modifier comprises monomers with ammonium moiety is selected from polyquaterniums or polyquaternium esters polymers and combinations thereof at about 1.1% to of about 1.7% by weight, based on the total weight of the composition; c) optionally additives and d) optionally additional active ingredient.

In some embodiments, the method of controlling or preventing infestation of plants with plant pests is by applying an aqueous pesticidal suspension composition to the plants, plant parts or locus thereof, comprising a) emamectin or salt thereof at about 1% to of about 20% by weight, based on the total weight of the composition; b) at least one polycationic type rheology modifier comprises monomers with ammonium moiety is selected from polyquaterniums or polyquaternium esters polymers and combinations thereof at about 1.2% by weight, based on the total weight of the composition; c) optionally additives and d) optionally additional active ingredient.

In some embodiments, the method of controlling or preventing infestation of plants with plant pests is by applying an aqueous pesticidal suspension composition to the plants, plant parts or locus thereof, comprising a) emamectin or salt thereof at about 3% to of about 10% by weight, based on the total weight of the composition; b) at least one polycationic type rheology modifier comprises monomers with ammonium moiety is selected from polyquaterniums or polyquaternium esters polymers and combinations thereof at about 1.2% by weight, based on the total weight of the composition; c) optionally additives and d) optionally additional active ingredient.

In some embodiments, the method of controlling or preventing infestation of plants with plant pests is by applying an aqueous pesticidal suspension composition to the plants, plant parts or locus thereof, comprising a) emamectin or salt thereof at about 5% to of about 8% by weight, based on the total weight of the composition; b) at least one polycationic type rheology modifier comprises monomers with ammonium moiety is selected from polyquaterniums or polyquaternium esters polymers and combinations thereof at about 1.2% by weight, based on the total weight of the composition; c) optionally additives and d) optionally additional active ingredient.

In some embodiments, the method of controlling or preventing infestation of plants with plant pests is by applying an aqueous pesticidal suspension composition to the plants, plant parts or locus thereof, comprising a) emamectin or salt thereof at about 7.5% by weight, based on the total weight of the composition; b) at least one polycationic type rheology modifier comprises monomers with ammonium moiety is selected from polyquaterniums or polyquaternium esters polymers and combinations thereof at about 1.2% by weight, based on the total weight of the composition; c) optionally additives and d) optionally additional active ingredient.

In some embodiments, the method of controlling or preventing infestation of plants with plant pests is by applying an aqueous pesticidal suspension composition to the plants, plant parts or locus thereof, comprising a) emamectin or salt thereof at about 1% to of about 20% by weight, based on the total weight of the composition; b) poly(2-methacryloxyethyltrimethylammonium chloride) at about 1% to of about 3% by weight, based on the total weight of the composition; c) optionally additives and d) optionally additional active ingredient.

In some embodiments, the method of controlling or preventing infestation of plants with plant pests is by applying an aqueous pesticidal suspension composition to the plants, plant parts or locus thereof, comprising a) emamectin or salt thereof at about 3% to of about 10% by weight, based on the total weight of the composition; b) poly(2-methacryloxyethyltrimethylammonium chloride) at about 1% to of about 3% by weight, based on the total weight of the composition; c) optionally additives and d) optionally additional active ingredient.

In some embodiments, the method of controlling or preventing infestation of plants with plant pests is by applying an aqueous pesticidal suspension composition to the plants, plant parts or locus thereof, comprising a) emamectin or salt thereof at about 5% to of about 8% by weight, based on the total weight of the composition; b) poly(2-methacryloxyethyltrimethylammonium chloride) at about 1% to of about 3% by weight, based on the total weight of the composition; c) optionally additives and d) optionally additional active ingredient.

In some embodiments, the method of controlling or preventing infestation of plants with plant pests is by applying an aqueous pesticidal suspension composition to the plants, plant parts or locus thereof, comprising a) emamectin or salt thereof at about 7.5% by weight, based on the total weight of the composition; b) poly(2-methacryloxyethyltrimethylammonium chloride) at about 1% to of about 3% by weight, based on the total weight of the composition; c) optionally additives and d) optionally additional active ingredient.

In some embodiments, the method of controlling or preventing infestation of plants with plant pests is by applying an aqueous pesticidal suspension composition to the plants, plant parts or locus thereof, comprising a) emamectin or salt thereof at about 1% to of about 20% by weight, based on the total weight of the composition; b) poly(2-methacryloxyethyltrimethylammonium chloride) at about 1% to of about 2% by weight, based on the total weight of the composition; c) optionally additives and d) optionally additional active ingredient.

In some embodiments, the method of controlling or preventing infestation of plants with plant pests is by applying an aqueous pesticidal suspension composition to the plants, plant parts or locus thereof, comprising a) emamectin or salt thereof at about 3% to of about 10% by weight, based on the total weight of the composition; b) poly(2-methacryloxyethyltrimethylammonium chloride) at about 1% to of about 2% by weight, based on the total weight of the composition; c) optionally additives and d) optionally additional active ingredient.

In some embodiments, the method of controlling or preventing infestation of plants with plant pests is by applying an aqueous pesticidal suspension composition to the plants, plant parts or locus thereof, comprising a) emamectin or salt thereof at about 5% to of about 8% by weight, based on the total weight of the composition; b) poly(2-methacryloxyethyltrimethylammonium chloride) at about 1% to of about 2% by weight, based on the total weight of the composition; c) optionally additives and d) optionally additional active ingredient.

In some embodiments, the method of controlling or preventing infestation of plants with plant pests is by applying an aqueous pesticidal suspension composition to the plants, plant parts or locus thereof, comprising a) emamectin or salt thereof at about 7.5% by weight, based on the total weight of the composition; b) poly(2-methacryloxyethyltrimethylammonium chloride) at about 1% to of about 2% by weight, based on the total weight of the composition; c) optionally additives and d) optionally additional active ingredient.

In some embodiments, the method of controlling or preventing infestation of plants with plant pests is by applying an aqueous pesticidal suspension composition to the plants, plant parts or locus thereof, comprising a) emamectin or salt thereof at about 1% to of about 20% by weight, based on the total weight of the composition; b) poly(2-methacryloxyethyltrimethylammonium chloride) at about 1.1% to of about 1.7% by weight, based on the total weight of the composition; c) optionally additives and d) optionally additional active ingredient.

In some embodiments, the method of controlling or preventing infestation of plants with plant pests is by applying an aqueous pesticidal suspension composition to the plants, plant parts or locus thereof, comprising a) emamectin or salt thereof at about 3% to of about 10% by weight, based on the total weight of the composition; b) poly(2-methacryloxyethyltrimethylammonium chloride) at about 1.1% to of about 1.7% by weight, based on the total weight of the composition; c) optionally additives and d) optionally additional active ingredient.

In some embodiments, the method of controlling or preventing infestation of plants with plant pests is by applying an aqueous pesticidal suspension composition to the plants, plant parts or locus thereof, comprising a) emamectin or salt thereof at about 5% to of about 8% by weight, based on the total weight of the composition; b) poly(2-methacryloxyethyltrimethylammonium chloride) at about 1.1% to of about 1.7% by weight, based on the total weight of the composition; c) optionally additives and d) optionally additional active ingredient.

In some embodiments, the method of controlling or preventing infestation of plants with plant pests is by applying an aqueous pesticidal suspension composition to the plants, plant parts or locus thereof, comprising a) emamectin or salt thereof at about 7.5% by weight, based on the total weight of the composition; b) poly(2-methacryloxyethyltrimethylammonium chloride) at about 1.1% to of about 1.7% by weight, based on the total weight of the composition; c) optionally additives and d) optionally additional active ingredient.

In some embodiments, the method of controlling or preventing infestation of plants with plant pests is by applying an aqueous pesticidal suspension composition to the plants, plant parts or locus thereof, comprising a) emamectin or salt thereof at about 1% to of about 20% by weight, based on the total weight of the composition; b) poly(2-methacryloxyethyltrimethylammonium chloride) at about 1.2% by weight, based on the total weight of the composition; c) optionally additives and d) optionally additional active ingredient.

In some embodiments, the method of controlling or preventing infestation of plants with plant pests is by applying an aqueous pesticidal suspension composition to the plants, plant parts or locus thereof, comprising a) emamectin or salt thereof at about 3% to of about 10% by weight, based on the total weight of the composition; b) poly(2-methacryloxyethyltrimethylammonium chloride) at about 1.2% by weight, based on the total weight of the composition; c) optionally additives and d) optionally additional active ingredient.

In some embodiments, the method of controlling or preventing infestation of plants with plant pests is by applying an aqueous pesticidal suspension composition to the plants, plant parts or locus thereof, comprising a) emamectin or salt thereof at about 5% to of about 8% by weight, based on the total weight of the composition; b) poly(2-methacryloxyethyltrimethylammonium chloride) at about 1.2% by weight, based on the total weight of the composition; c) optionally additives and d) optionally additional active ingredient.

In some embodiments, the method of controlling or preventing infestation of plants with plant pests is by applying an aqueous pesticidal suspension composition to the plants, plant parts or locus thereof, comprising a) emamectin or salt thereof at about 7.5% by weight, based on the total weight of the composition; b) poly(2-methacryloxyethyltrimethylammonium chloride) at about 1.2% by weight, based on the total weight of the composition; c) optionally additives and d) optionally additional active ingredient.

Without further elaboration, it is believed that one skilled in the art using the preceding description can utilize the present invention to its fullest extent. The following examples are, therefore, to be construed as merely illustrative and not limiting of the disclosure in any way whatsoever.

### EXAMPLES

### Example 1—SC Formulations Using Cationic Polycarboxylate Thickener

TABLE 1
Formulations A-C

| | Formulation A | Formulation B | Formulation C |
|---|---|---|---|
| Material | W/W [%] | W/W [%] | W/W [%] |
| Chlorantraniliprole | 15 | 15 | 15 |
| tech. 100% | | | |
| Emamectin 95% | 8.0 | 8.0 | 8.0 |
| Atlox 4913 (methyl | 3.0 | 3.0 | 3.0 |
| methacrylate graft | | | |
| Copolymer) | | | |
| Ethylan NS 500LQ | 1.0 | 1.0 | 1.0 |
| (alcohol | | | |
| ethoxylate/propoxylate) | | | |
| Tergitol 15-S-7 | 1.0 | 1.0 | 1.0 |
| Atlox RHEOSTRUX | 1.1 | 1.5 | 1.7 |
| 300A-LQ | | | |
| Silcolapse 432 | 0.5 | 0.5 | 0.5 |
| Proxel GXL | 0.1 | 0.1 | 0.1 |
| Propylene glycol | 6.9 | 6.9 | 6.9 |
| water | Qs. To 100% | Qs. To 100% | Qs. To 100% |

### Production Procedure:

### Pre Milling:

Addition of water to the mixer.
Addition of Atlox 4913, Tergitol 15-S-7 and Ethylan NS and continue to mix.
Addition of Chlorantraniliprole during mixing.
Gradually addition of Emamectin benzoate to the mixer during high velocity mixing to avoid lumps creation.
Applying High Shear to have homogenous suspension.

### Milling:

Milling the suspension until receiving PSD less than 5 microns

### Final Stage:

Addition of the Rheology Modifier (Rheostrux 300) to the vessel during mixing.
Applying high shear until achieving the desired viscosity.

TABLE 2
Physical properties of formulations A-C

| | Formulation A | | Formulation B | | Formulation C | |
|---|---|---|---|---|---|---|
| Stability conditions | *RT | 54° C. | RT | 54° C. | RT | 54° C. |
| | (2 weeks) | (2 weeks) | (2 weeks) | (2 weeks) | (2 weeks) | (2 weeks) |
| Appearance | No | No | No | No | No | No |
| | separation | separation | separation | separation | separation | separation |
| Spontaneity of dispersion | | | | | | |
| Emamectin-benzoate (%) | 92% | 100% | 99% | 97% | 90% | 95% |
| Chlorantraniliprole (%) | 90% | 100% | 100% | 99% | 90% | 97% |
| Suspensibility 1% | 100 | 100 | | | | |
| (1000 ppm) | | | | | | |
| Persistent Foaming | 10 ml | 10 ml | 9 ml | 10 ml | 10 ml | 10 ml |
| Viscosity (cp) | 1335 | 1345 | 1537 | 1542 | 1875 | 1892 |

*RT = room temperature

It is clearly demonstrated that formulations A-C are stable at different concentrations of the polycationic rheology modifier. Additional indication of the formulation's stability is that the viscosity has not changed after storage stability test at 54° C. for two weeks.

The suspensibility test was done in the presence of hard water which contain relatively high amount of ions. These ions may react with the active ingredient and with some of the formulation additives such as surfactants, adjuvants, and rheology modifiers, eventually causing distribution problems in water. However, in the case of formulations A-C excellent suspensibility was achieved.

### Example 2—SC Formulations Using Cationic Polycarboxylate Thickener

TABLE 3
Formulations D-E

| | Formulation D | Formulation E |
|---|---|---|
| Materials | W/W [%] | W/W [%] |
| Chlorantraniliprole tech. 100% | 15.0 | 15.0 |
| Emamectin 95% | 7.5 | 7.5 |
| Atlox 4913 (methyl | 3.0 | 3.0 |
| methacrylate graft Copolymer) | | |
| Ethylan NS 500LQ (alcohol | 1.0 | 1.0 |
| ethoxylate/propoxylate) | | |
| tergitol 15-S-7 | 1.0 | 1.0 |
| Atlox RHEOSTRUX 300A-LQ | 1.2 | 2.4 |
| Silcolapse 432 | 0.5 | 0.5 |
| Proxel GXL | 0.1 | 0.1 |
| Propylene glycol | 6.8 | 6.8 |
| water | Qs. To 100% | Qs. To 100% |

### Production Procedure:

### Pre Milling:

Addition of water to the mixer.
Addition of Atlox 4913, Tergitol 15-5-7 and Ethylan NS and continue to mix.
Addition of Chlorantraniliprole during mixing.
Gradually addition of Emamectin benzoate to the mixer during high velocity mixing to avoid lumps creation.
Applying high shear to obtain homogenous suspension.

### Milling:

Milling the suspension until receiving PSD less than 5 microns

### Final Stage:

Addition of the Rheology Modifier (Rheostrux 300) to the vessel during mixing.
Applying high shear until achieving the desired viscosity.

TABLE 4
Physical properties of formulations D-E

| | | Formulation D | | | Formulation E | | |
|---|---|---|---|---|---|---|---|
| Stability conditions | | Start | *RT | 54° C. | Start | RT | 54° C. |
| | | | (14 Days) | (2 Week) | | (14 Days) | (2 Week) |
| Appearance | | White to | No | No | White to | No | No |
| | | off white | Separation | Separation | off white | Separation | Separation |
| Suspensibility [%] | Chlorantraniliprole | — | 99.93 | 99.53 | 98.89 | 99.35 | 99.25 |
| | Emamectin | — | 100.1 | 99.72 | 98.87 | 99.26 | 99 |
| | benzoate | | | | | | |
| Spontaneity of dispersion | Chlorantraniliprole | — | 98.65 | 99.26 | 97.88 | 98.38 | 96.77 |
| [%] | Emamectin | — | 99.26 | 99.26 | 97.88 | 98.5 | 96.88 |
| | benzoate | | | | | | |
| Persistent foam (in ml) | | 40 | 40 | 40 | 40 | 40 | 40 |
| after 1 minute | | | | | | | |
| Particle size(D90) | | 4.77 | 3.68 | 4.28 | 3.18 | 3.28 | 3.08 |
| Viscosity 62 spindle, 12 rpm, cP | | 480 | 471 | 445 | 1980 | 2010 | 1885 |
| Cold stability at 0° C., 7 days | | Flowable | Flowable | Flowable | Flowable | Flowable | Flowable |

*RT = room temperature

Similarly, to formulations A-C, formulations D-E showed no changes in viscosity from start to storage stability test and no growth in particles size during time and elevated temperatures.

All the above indicate that formulations D-E are physically stable.

### Comparative Example 3—SC Formulations 1-9 Using Different Kind of Thickeners

TABLE 5
Formulations 1-9

| Materials | W/W [%] |
|---|---|
| Chlorantraniliprole tech. | 15.0 |
| Emamectin | 7.5 |
| Atlox 4913 (methyl | 3.0 |
| methacrylate graft | |
| Copolymer) | |
| Ethylan NS 500LQ | 1.0 |
| (alcohol | |
| ethoxylate/propoxylate) | |
| Tergitol 15-S-7 | 1.0 |
| Silcolapse 432 | 0.5 |
| Proxel GXL | 0.1 |
| Propylene glycol | 6.8 |
| water | Qs. To 100% |
| Thickener** | *** |

### Production Procedure:

### Pre Milling:

Addition of water to the mixer.
Addition of Atlox 4913, Tergitol 15-S-7 and Ethylan NS and continue to mix.
Addition of Chlorantraniliprole During mixing.
Gradually adding Emamectin benzoate to the mixer during high velocity mixing to avoid lumps creation.
Applying high shear to have homogenous suspension.

### Milling:

Milling the suspension until receiving PSD less than 5 microns

### Final Stage

Addition of the Rheology Modifier to the vessel during mixing.
If necessary, applying high shear.

TABLE 6
Results of formulations 1-9

| Formulation | | Amount*** | |
|---|---|---|---|
| No. | Thickener ** | [%] | Result |
| 1 | Carboxymethyl Guar | 1.9 | Lumps |
| | Gum | | |
| 2 | Xanthan Gum | 0.1 | Lumps |
| 3 | Bentone MA % (clay | 1.9 | Lumps |
| | mineral) | | |
| 5 | Bentone IT (clay | 1.9 | 50% separation at |
| | mineral) | | elevated temp |
| 6 | Agrimer VA6 (linear, | 4.75 | 50% separation at |
| | random copolymers | | elevated temp |
| | of vinyl pyrrolidone | | |
| | and vinyl acetate) | | |
| 7 | Mowiol 688 | 4.75 | 50% separation at |
| | (Polyvinyl Alcohol) | | elevated temp |
| 8 | Carboxy methyl | 9.5 | Lumps |
| | cellulose | | |
| 9 | Amorphous silicon | 3.8 | 20% separation at |
| | dioxide, Chemically | | elevated temp |
| | prepared | | |

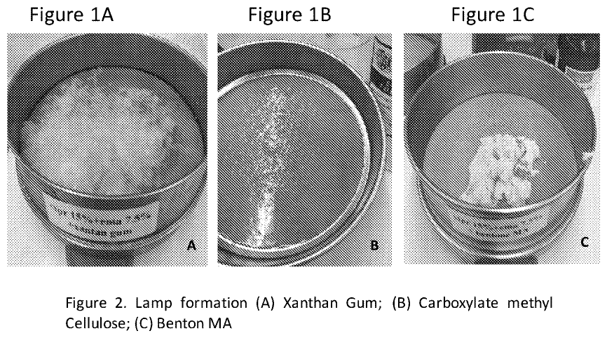

Formulations 1-3, 8 resulted in lumps during thickener addition while formulations 4-7 and 9 resulted in phase separation at elevated temperatures.
No additional agitation or applying high shear helped.
The amounts of the thickeners (***) were adjusted in formulations 1-9 to obtain the same viscosity for comparison.
FIG. 1 shows lamp formation (A) Xanthan Gum; (B) Carboxylate methyl Cellulose; (C) Benton MA

### CONCLUSIONS

It is clearly shown that formulations A-E are stable and possess excellent physical properties while formulations from comparative example 3 formulations 1-9 resulted in high percentage of separation and in the formation of lumps.

1. An aqueous pesticidal suspension composition comprising a macrolide insecticidal compound or salt thereof; at least one polycationic rheology modifier; optionally additives and optionally additional active ingredient.

2. The composition according to claim 1, wherein the macrolide insecticidal compound is selected from a group comprising emamectin, abamectin, spinosad, spinetoram or salt thereof.

3. The composition according to any one of claims 1-2, wherein the macrolide insecticidal compound is emamectin or salt thereof.

4. The composition according to any one of claims 1-3, wherein the amount of the macrolide insecticidal compound is of about 1% to of about 20% by weight, based on the total weight of the composition.

5. The composition according to any one of claims 1-4, wherein the at least one polycationic type rheology modifier comprises monomers with ammonium, sulfonium or phosphonium moiety.

6. The composition according to claim 5, wherein the at least one polycationic type rheology modifier comprises monomers with ammonium moiety.

7. The composition according to claim 5 or 6, wherein the at least one polycationic type rheology modifier comprises monomers with ammonium moiety is selected from polyquaterniums or polyquaternium esters polymers and combinations thereof.

8. The composition according to any one of claims 1-7, wherein the amount of the at least one polycationic type rheology modifier is of about 1% to of about 3% by weight, based on the total weight of the composition.

9. The composition according to any one of claims 1-8, wherein the additive is selected from the group comprising of dispersants, wetting agents, antifreezing agents, antifoaming agents, surfactants, pH modifiers and stabilizers.

10. The composition according to any one of claims 1-9, wherein the additional active ingredient is a diamide insecticide.

11. The composition according to claim 10, wherein the diamide insecticide is selected from a group comprising chlorantraniliprole, cyantraniliprole, cyclaniliprole, fluchlordiniliprole, tetrachlorantraniliprole and tetraniliprole.

12. The composition according to claim 11, wherein the diamide insecticide is selected from chlorantraniliprole or cyantraniliprole.

13. The composition according to claim 12, wherein the diamide insecticide is chlorantraniliprole.

14. The composition according to claim 12, wherein the diamide insecticide is cyantraniliprole.

15. The composition according to any one of claims 10-14, wherein the additional active ingredient is of about 1% to of about 60% by weight, based on the total weight of the composition.

16. A method for stabilizing an aqueous pesticidal suspension composition comprising a macrolide insecticidal compound or salt thereof; optionally additives and optionally additional active ingredient by the addition of at least one polycationic type rheology modifier.

17. The method according to claim 16, wherein the macrolide insecticidal compound is selected from a group comprising emamectin, abamectin, spinosad, spinetoram or salt thereof.

18. The method according to claim 16 or 17, wherein the macrolide insecticidal compound is emamectin or salt thereof.

19. The method according to any one of claims 16-18, wherein the amount of the macrolide insecticidal compound is of about 1% to of about 20% by weight, based on the total weight of the composition.

20. The method according to any one of claims 16-19, wherein the additive is selected from the group comprising of dispersants, wetting agents, antifreezing agents, antifoaming agents, surfactants, pH modifiers and stabilizers.

21. The method according to any one of claims 16-20, wherein the additional active ingredient is a diamide insecticide.

22. The method according to claim 21, wherein the diamide insecticide is selected from a group comprising chlorantraniliprole, cyantraniliprole, cyclaniliprole, fluchlordiniliprole, tetrachlorantraniliprole and tetraniliprole.

23. The method according to claim 22, wherein the diamide insecticide is selected from chlorantraniliprole or cyantraniliprole.

24. The method according to claim 23, wherein the diamide insecticide is chlorantraniliprole.

25. The method according to claim 23, wherein the diamide insecticide is cyantraniliprole.

26. The method according to any one of claims 16-25, wherein the additional active ingredient is of about 1% to of about 60% by weight, based on the total weight of the composition.

27. The method according to any one of claims 16-26, wherein the at least one polycationic type rheology modifier comprises monomers with ammonium, sulfonium or phosphonium moiety.

28. The method according to claim 27, wherein the at least one polycationic type rheology modifier comprises monomers with ammonium moiety.

29. The method according to claim 27 or 28, wherein the at least one polycationic type rheology modifier comprises monomers with ammonium moiety is selected from polyquaterniums or polyquaternium esters polymers and combinations thereof.

30. The method according to any one of claims 16-29, wherein the amount of the at least one polycationic type thickener is of about 1% to of about 3% by weight, based on the total weight of the composition.

31. The method according to claims 16-30, wherein the composition is applied in an amount from about 0.06 L/ha to about 0.62 L/ha.

32. The method according to claims 16-31, wherein the composition is applied in an amount from about 5 g/ha of macrolide insecticidal compound or salt thereof to about 15 g/ha of macrolide insecticidal compound or salt thereof.

33. The method according to claims 16-32, wherein the composition is applied in an amount from about 10 g/ha of diamide insecticide to about 100 g/ha of diamide insecticide.

34. The method according to claim 33, wherein the diamide insecticide is selected from a group comprising chlorantraniliprole, cyantraniliprole, cyclaniliprole, fluchlordiniliprole, tetrachlorantraniliprole and tetraniliprole.

35. The method according to claim 34, wherein the diamide insecticide is selected from chlorantraniliprole or cyantraniliprole.

36. The method according to claim 35, wherein the diamide insecticide is chlorantraniliprole.

37. The method according to claim 35, wherein the diamide insecticide is cyantraniliprole.

38. Use of the composition according to any one of claims 1-15 for controlling or preventing infestation of plants with plant pest.

39. A method of controlling or preventing infestation of plants with plant pests by applying an aqueous pesticidal suspension composition to the plants, plant parts or locus thereof, comprising a macrolide insecticidal compound or salt thereof; at least one polycationic type rheology modifier; optionally additives and optionally additional active ingredient.

40. The method according to claim 39, wherein the macrolide insecticidal compound is selected from a group comprising emamectin, abamectin, spinosad, spinetoram or salt thereof.

41. The method according to any one of claims 39-40, wherein the macrolide insecticidal compound is emamectin or salt thereof.

42. The method according to any one of claims 39-41, wherein the amount of the macrolide insecticidal compound is of about 1% to of about 20% by weight, based on the total weight of the composition.

43. The method according to any one of claims 39-42, wherein the at least one polycationic type rheology modifier comprises monomers with ammonium, sulfonium or phosphonium moiety.

44. The method according to claim 43, wherein the at least one polycationic type rheology modifier comprises monomers with ammonium moiety.

45. The method according to claim 43 or 44, wherein the at least one polycationic type rheology modifier comprises monomers with ammonium moiety is selected from polyquaterniums or polyquaternium esters polymers and combinations thereof.

46. The method according to any one of claims 39-45, wherein the amount of the at least one polycationic type thickener is of about 1% to of about 3% by weight, based on the total weight of the composition.

47. The method according to any one of claims 39-46, wherein the additive is selected from the group comprising dispersants, wetting agents, antifreezing agents, antifoaming agents, surfactants, pH modifiers and stabilizers.

48. The method according to any one of claims 39-47, wherein the additional active ingredient is a diamide insecticide.

49. The method according to any one of claims 39-48, wherein the diamide insecticide is selected from a group comprising chlorantraniliprole, cyantraniliprole, cyclaniliprole, fluchlordiniliprole, tetrachlorantraniliprole and tetraniliprole.

50. The method according to claim 49, wherein the diamide insecticide is selected from chlorantraniliprole or cyantraniliprole.

51. The method according to claim 50, wherein the diamide insecticide is chlorantraniliprole.

52. The method according to claim 50, wherein the diamide insecticide is cyantraniliprole.

53. The method according to any one of claims 39-52, wherein the additional active ingredient is of about 1% to of about 60% by weight, based on the total weight of the composition.

54. The method according to any one of claims 39-53, wherein the additional active ingredient is of about 1% to of about 20% by weight, based on the total weight of the composition.

55. The method according to any one of claims 39-54, wherein the composition is applied in an amount from about 0.06 L/ha to about 0.62 L/ha.

56. The method according to any one of claims 39-55, wherein the composition is applied in an amount from about 5 g/ha of macrolide insecticidal compound or salt thereof to about 15 g/ha of macrolide insecticidal compound or salt thereof.

57. The method according to any one of claims 39-56, wherein the composition is applied in an amount from about 10 g/ha of diamide insecticide to about 100 g/ha of diamide insecticide.
